(19) United States
(12) Patent Application Publication
(10) Pub. No.: US 2017/0200346 A1
(43) Pub. Date: Jul. 13, 2017

(54) GAMING MACHINE

(71) Applicants: Universal Entertainment Corporation, Tokyo (JP); Aruze Gaming (Hong Kong) Limited, Hung Hom (HK)

(72) Inventors: Masumi FUJISAWA, Tokyo (JP); Yukinori INAMURA, Tokyo (JP); Kenta KITAMURA, Tokyo (JP)

(73) Assignees: Universal Entertainment Corporation; Aruze Gaming (Hong Kong) Limited

(21) Appl. No.: 15/394,284

(22) Filed: Dec. 29, 2016

(30) Foreign Application Priority Data
Jan. 13, 2016 (JP) 2016-004588

(51) Int. Cl. G07F 17/32; G07F 17/34

(52) U.S. Cl. CPC G07F 17/3213; G07F 17/3225; G07F 17/3244; G07F 17/34

(57) ABSTRACT

A gaming machine which relieves the monotony of the game is provided. The game machine executes the processes of: (1A) randomly determining symbols for a normal mode, which will be rearranged on the display device based on a predetermined symbol random determination table; (1B) rearranging and displaying the symbols determined in the process (1A) on the display device; (1C) in cases where the symbols rearranged on the display device form a specific symbol combination, randomly determining symbols for a high-probability mode, which will be rearranged on the display device based on a symbol random determination table which specifies a higher probability of rearrangement for a predetermined symbol than that specified in the symbol random determination table used in a previous game; (1D) rearranging and displaying the symbols determined in the process (1C) on the display device; (1E) repeating the processes of (1C) and (1D).

### CROSS-REFERENCE TO RELATED APPLICATION

This application claims the benefit of Japanese Pat. App. No. 2016-004588, filed on Jan. 13, 2016, Japanese Pat. App. No. 2016-004684, filed on Jan. 13, 2016, Japanese Pat. App. No. 2016-004687, filed on Jan. 13, 2016, and Japanese Pat. App. No. 2016-004644, filed on Jan. 13, 2016 which applications are each incorporated herein by reference in its entirety.

### TECHNICAL FIELD

As a typical gaming machine, a slot machine is arranged such that, as a player presses a button on a control panel, reels on which symbols are provided are scrolled and then stopped, with the result that the symbols are rearranged. In such a slot machine, a benefit such as a payout is awarded to a player based on a combination of rearranged symbols.

A type of the slot machines is arranged such that, after each reel is scrolled and stopped, symbols are rearranged at equal probabilities. For example, when 22 symbols are arranged on a reel, a probability of rearrangement of each of 22 symbols is 1/22. In the meanwhile, another type of the slot machines is arranged such that, after each reel is scrolled and stopped, symbols are rearranged at not equal but different probabilities. In such a slot machine, for example, when 22 symbols are arranged on a reel, a probability of rearrangement of each symbol is different between the symbols, e.g., a probability of rearrangement of a symbol A is 1/10 whereas a probability of rearrangement of a symbol B is 1/50, and a random determination table in which a probability of rearrangement is associated with each symbol is provided (see Patent Literature 1).

### CITATION LIST

### Patent Literatures

[PTL 1] Japanese Unexamined Patent Publication No. 2013-153875

### SUMMARY OF THE INVENTION

### Technical Problem

In the slot machine above, the random determination table in which a probability of rearrangement is associated with each symbol is typically identical between games, with the result that game play may be monotonous.

An object of the present invention is to provide a gaming machine which makes it possible to avoid monotonous game play.

### Technical Solution

The present invention relates to a gaming machine including: a display device configured to display a game result by rearranging reels on which symbols are arranged; a storage device including symbol random determination tables each of which specifies a probability of rearrangement for each of the symbols arrayed on the reels, in such a manner that the probability of rearrangement for a predetermined symbol is different amongst the symbol random determination tables; and

a controller configured to execute the processes of:

(1A) at start of game play, randomly determining symbols for an normal mode, which will be rearranged on the display device based on a predetermined symbol random determination table;
(1B) displaying the symbols determined in the process (1A) on the display device by rearranging the reels;
(1C) in cases where the symbols rearranged on the display device form a specific symbol combination, randomly determining symbols for a high-probability mode, which will be rearranged on the display device based on a symbol random determination table which specifies a higher probability of rearrangement for the predetermined symbol than that specified in the symbol random determination table used in a previous game;
(1D) displaying the symbols determined in the process (1C) on the display device by rearranging the reels; and
(1E) repeating the processes of (1C) and (1D).

The above structure allows stepping up to a game with a higher probability of having the predetermined symbol rearranged on the display device, every time a specific combination of symbols are rearranged. Thus, the probability of the predetermined symbol being rearranged on the display device increases as the game progresses, which relieves the monotony of the game.

In the present invention, the above-described gaming machine is arranged such that the controller is configured to further execute the process of:

returning to the process of (1A) in cases where the symbols rearranged on the display device do not form a specific symbol combination in the processes of (1B) and (1D).

With the above structure, the game returns to a mode which does not use the symbol random determination table with a high probability of having the predetermined symbol rearranged. Therefore, stepping up to a game with a higher probability of having the predetermined symbol rearranged on the display device occurs while a specific combination of symbols continues to be rearranged. This relieves the monotony of the game by drawing the players' attention to see if a combination of rearranged symbols forms the specific combination.

In the present invention, the above-described gaming machine is arranged such that in the process of (1E), the symbol random determination table used, when the processes of (1C) and (1D) are repeated a predetermined number of times, is a symbol random determination table which defines a highest probability of having the predetermined symbol combination rearranged.

In the above structure, in high-probability mode symbol random determination process, which is executed after repeating the high-probability mode symbol random determination process a predetermined number of times, the probability of a combination of the predetermined symbol being rearranged is the highest. Therefore, a combination of the predetermined symbol is most easily established, and the monotony of the game is relieved by repeating, a predetermined number of times, the high-probability mode symbol random determination process which is executed when the symbols rearranged form the specific combination.

Further, another aspect of the present invention a gaming machine, comprising: a display device configured to display a game result by rearranging reels on which symbols are arrayed in a matrix of display areas;

a storage device including symbol random determination tables each of which specifies a probability of rearrangement for each of the symbols arrayed on the reels in the display areas, in such a manner that the probability of rearrangement for a predetermined symbol in any of the display areas is different amongst the symbol random determination tables; and

a controller configured to execute the processes of:

(2A) at start of game play, randomly determining symbols for an normal mode, which will be rearranged in the display areas on the display device based on a predetermined symbol random determination table;
(2B) displaying, in the display areas, the symbols determined in the process (2A) on the display device by rearranging the reels;
(2C) in cases where the symbols rearranged in the display areas on the display device form a specific symbol combination, randomly determining symbols, which will be rearranged in the display areas on the display device based on a symbol random determination table which specifies a higher probability of rearrangement for the predetermined symbol in a specific display area; and
(2D) displaying, in the display areas, the symbols determined in the process (2C) on the display device by rearranging the reels.

With the above structure, the probability of the predetermined symbol being rearranged in a predetermined display area is increased, in cases where the combination of symbols rearranged on the display device form a specific combination. Namely, when the combination of symbols rearranged on the display device form a specific combination, the predetermined symbol is more likely to be arranged in a predetermined display area. Rearrangement of the predetermined symbol in the predetermined display area could lead to an alignment of the predetermined symbols crossing the display areas in the upper right direction. Thus, when the combination of the symbols rearranged on the display device is a specific combination, the predetermined symbols are more easily aligned across the matrix of the display areas in the upper right direction, in the subsequent game. Further, for example, suppose the predetermined symbols are rearranged in the predetermined display areas, thus resulting in one-step before the formation of a combination which would lead to a winning by a predetermined symbol (so-called tenpai). In this case, if a combination of the symbols rearranged on the display device is a specific combination, a winning of tenpai by the predetermined symbol is likely to be resulted in the subsequent game, which relieves the monotony of the game.

Another aspect of the present invention is a gaming machine, comprising: a display device configured to display a game result according to an arrangement pattern of symbols formed by rearranging reels on which symbols are arrayed in a matrix of display areas;

a storage device including symbol random determination tables each of which specifies a probability of rearrangement for each of the symbols arrayed on the reels in the display areas, in such a manner that an arrangement pattern of symbols rearranged in the display areas is different amongst the symbol random determination tables; and

a controller configured to execute the processes of:

(3A) at start of game play, randomly determining an arrangement pattern of symbols for an normal mode, which will be rearranged in the display areas on the display device based on a predetermined symbol random determination table;
(3B) displaying, in the display areas, the arrangement pattern determined in the process (3A) on the display device by rearranging the reels;
(3C) in cases where the arrangement pattern of symbols rearranged in the display areas on the display device forms a specific symbol combination, randomly determining symbols, which will be rearranged in the display areas on the display device based on a symbol random determination table which specifies a higher probability for the arrangement pattern in which the specific symbol is rearranged in a predetermined display area; and
(3D) displaying, in the display areas, the arrangement pattern determined in the process (3C) on the display device by rearranging the reels.

If the arrangement pattern of the symbols rearranged in the display areas is a specific arrangement pattern in the above structure, the probability will be higher in the subsequent game for having a result of an arrangement pattern in which the predetermined symbol is rearranged in a predetermined display area, which relieves the monotony of the game.

### Advantageous Effects

A gaming machine which makes it possible to avoid monotonous game play is provided.

### BRIEF DESCRIPTION OF THE DRAWINGS

FIG. 1 shows the outline of game content of a slot machine according to an embodiment of the present invention.

FIG. 2 shows a functional flow of the slot machine of the embodiment of the present invention.

FIG. 3 shows a game system including the slot machine of the embodiment of the present invention.

FIG. 4 shows the overall structure of the slot machine of the embodiment of the present invention.

FIG. 5 shows a symbol array on each reel of the slot machine of the embodiment of the present invention.

FIG. 6 shows a reel displayed on a display window of the slot machine of the embodiment of the present invention.

FIG. 7 is an explanatory diagram of a liquid crystal display device of the slot machine of the embodiment of the present invention.

FIG. 8 is a block diagram showing an internal structure of the slot machine of the embodiment of the present invention.

FIG. 9 shows a symbol combination table of the slot machine of the embodiment of the present invention.

FIG. 10 shows a symbol random determination table of the normal mode of the slot machine of the embodiment of the present invention.

FIG. 11 shows a symbol random determination table of the Zone A of the slot machine of the embodiment of the present invention.

FIG. 12 shows a symbol random determination table of the Zone B of the slot machine of the embodiment of the present invention.

FIG. 13 shows a symbol random determination table of the Zone C of the slot machine of the embodiment of the present invention.

FIG. 14 shows a Zone A mode transition random determination table of the slot machine of the embodiment of the present invention.

FIG. 15 is a flowchart of a main control process in the slot machine of the embodiment of the present invention.

FIG. 16 is a flowchart of a bet/start-check process of the slot machine of the embodiment of the present invention.

FIG. 17 is a flowchart of a Zone A mode process in the slot machine of the embodiment of the present invention.

FIG. 18 is a flowchart of a Zone B mode process in the slot machine of the embodiment of the present invention.

FIG. 19 is a flowchart of a Zone C mode process in the slot machine of the embodiment of the present invention.

FIG. 20 illustrates game progress in the slot machine of the embodiment of the present invention.

FIG. 21 illustrates game progress in the slot machine of the embodiment of the present invention.

FIG. 22 illustrates game progress in the slot machine of the embodiment of the present invention.

FIG. 23 illustrates game progress in the slot machine of the embodiment of the present invention.

FIG. 24 shows the outline of game content of the slot machine of the embodiment of the present invention.

FIG. 25 shows a functional flow of the slot machine of the embodiment of the present invention.

FIG. 26 shows a game system including the slot machine of the embodiment of the present invention.

FIG. 27 shows the overall structure of the slot machine of the embodiment of the present invention.

FIG. 28 shows a symbol array on each reel of the slot machine of the embodiment of the present invention.

FIG. 29 shows a reel displayed on a display window of the slot machine of the embodiment of the present invention.

FIG. 30 illustrates the liquid crystal display device of the slot machine of the embodiment of the present invention.

FIG. 31 is a block diagram showing an internal structure of the slot machine of the embodiment of the present invention.

FIG. 32 shows the payout table of the slot machine of the embodiment of the present invention.

FIG. 33 shows a rearrangement symbol combination table of the slot machine of the embodiment of the present invention.

FIG. 34 shows a falling table in the slot machine of the embodiment of the present invention.

FIG. 35 is a flowchart of a main control process in the slot machine of the embodiment of the present invention.

FIG. 36 is a flowchart of a bet/start-check process of the slot machine of the embodiment of the present invention.

FIG. 37 is a flowchart of a high-probability mode process in the slot machine of the embodiment of the present invention.

FIG. 38 illustrates game progress in the slot machine of the embodiment of the present invention.

FIG. 39 shows the outline of game content of the slot machine of the embodiment of the present invention.

FIG. 40 shows a functional flow of the slot machine of the embodiment of the present invention.

FIG. 41 shows a game system including the slot machine of the embodiment of the present invention.

FIG. 42 shows the overall structure of the slot machine of the embodiment of the present invention.

FIG. 43 shows a symbol array on each reel of the slot machine of the embodiment of the present invention.

FIG. 44 shows a reel displayed on a display window of the slot machine of the embodiment of the present invention.

FIG. 45 illustrates the liquid crystal display device of the slot machine of the embodiment of the present invention.

FIG. 46 is a block diagram showing an internal structure of the slot machine of the embodiment of the present invention.

FIG. 47 shows the payout table of the slot machine of the embodiment of the present invention.

FIG. 48 shows a symbol random determination table A of the slot machine of the embodiment of the present invention.

FIG. 49 shows a symbol random determination table B of the slot machine of the embodiment of the present invention.

FIG. 50 shows a symbol random determination table for free games in the slot machine of the embodiment of the present invention.

FIG. 51 shows a game property set table of the slot machine of the embodiment of the present invention.

FIG. 52 is a flowchart of a main control process in the slot machine of the embodiment of the present invention.

FIG. 53 is a flowchart of a bet/start-check process of the slot machine of the embodiment of the present invention.

FIG. 54 is a flowchart of a free game process of the slot machine related to the embodiment of the present invention.

FIG. 55 illustrates game progress in the slot machine of the embodiment of the present invention.

FIG. 56 is a flowchart of a main control process 2 in the slot machine of the embodiment of the present invention.

FIG. 57 shows the outline of game content of the slot machine of the embodiment of the present invention.

FIG. 58 shows a functional flow of the slot machine of the embodiment of the present invention.

FIG. 59 shows a game system including the slot machine of the embodiment of the present invention.

FIG. 60 shows the overall structure of the slot machine of the embodiment of the present invention.

FIG. 61 shows a symbol array on each reel of the slot machine of the embodiment of the present invention.

FIG. 62 shows a reel displayed on a display window of the slot machine of the embodiment of the present invention.

FIG. 63 illustrates the liquid crystal display device of the slot machine of the embodiment of the present invention.

FIG. 64 is a block diagram showing an internal structure of the slot machine of the embodiment of the present invention.

FIG. 65 shows a symbol combination table of the slot machine of the embodiment of the present invention.

FIG. 66 shows a symbol rearrangement table of the slot machine of the embodiment of the present invention.

FIG. 67 is a flowchart of a main control process in the slot machine of the embodiment of the present invention.

FIG. 68 is a flowchart of a bet/start-check process of the slot machine of the embodiment of the present invention.

FIG. 69 is a flowchart of a free game process of the slot machine related to the embodiment of the present invention.

FIG. 70 illustrates game progress in the slot machine of the embodiment of the present invention.

FIG. 71 illustrates game progress in the slot machine of the embodiment of the present invention.

FIG. 72 illustrates game progress in the slot machine of the embodiment of the present invention.

### DESCRIPTION OF EMBODIMENTS

(Outline of Present Invention)

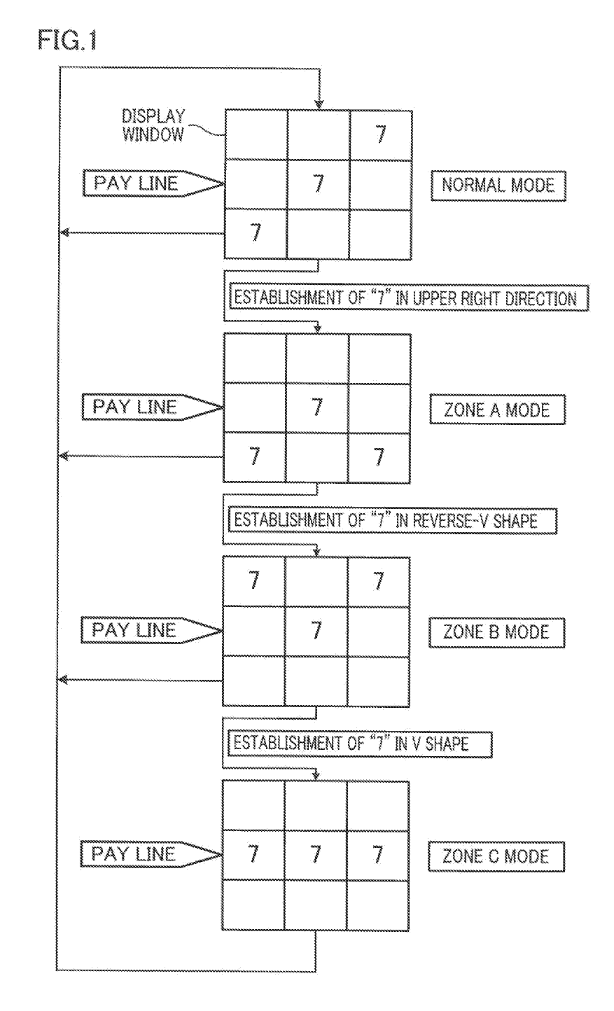

The following will describe an embodiment the present invention with reference to figures. FIG. 1 shows the outline of a game flow of a slot machine according to the embodiment of the present invention. As shown in FIG. 1, in the slot machine of the embodiment of the present invention, a slot game in a normal mode and a slot game in a high-probability modes (Zone A, Zone B, Zone C) transited from the normal mode are executed.

The slot games are of a line type (Left to Right). The slot games employ mechanical reels. The reels are formed of three reels. That is to say, the reels are formed of a first reel, a second reel, and a third reel. Further, a single pay line is set.

In the normal mode, a symbol random determination process is executed to randomly determine symbols to be rearranged in display windows, based on the normal mode symbol random determination table in which each of symbols arrayed on the three reels are associated with a probability of being rearranged in a display window. Then, symbols thus determined are rearranged in the display window, and a benefit according to a combination of symbols (corresponding also to an arrangement pattern) rearranged on the pay line is awarded.

If the combination of symbols rearranged in the display windows in the normal mode is a specific symbol combination (e.g., alignment of “7” towards upper right; detailed later), transition to the Zone A mode (high-probability mode) may occur as the result of a random determination. If the mode does not result from the random determination, the normal mode is maintained.

In the Zone A mode, a symbol random determination process is executed to randomly determine symbols to be rearranged in display windows, based on the Zone A mode symbol random determination table in which each of symbols arrayed on the three reels are associated with a probability of being rearranged in a display window. Then, symbols thus determined are rearranged in the display window, and a benefit according to a combination of symbols rearranged on the pay line is awarded. The Zone A mode symbol random determination table is a symbol random determination table which specifies a higher probability of rearrangement for the predetermined symbol (e.g., “7”) than the normal mode symbol random determination table.

If the combination of symbols rearranged in the display windows in the Zone A mode is a specific symbol combination (e.g., alignment of “7” in a reverse V-shape; detailed later), transition to the Zone B mode (high-probability mode) occurs. If the specific combination of the symbols did not occur in the display windows, the mode transits to the normal mode.

In the Zone B mode, a symbol random determination process is executed to randomly determine symbols to be rearranged in display windows, based on the Zone B mode symbol random determination table in which each of symbols arrayed on the three reels are associated with a probability of being rearranged in a display window. Then, symbols thus determined are rearranged in the display window, and a benefit according to a combination of symbols rearranged on the pay line is awarded. The Zone B mode symbol random determination table is a symbol random determination table which specifies a higher probability of rearrangement for the predetermined symbol (e.g., “7”) than the Zone A mode symbol random determination table.

If the combination of symbols rearranged in the display windows in the Zone B mode is a specific symbol combination (e.g., alignment of “7” in a small V-shape; detailed later), transition to the Zone C mode (high-probability mode) occurs. If the specific combination of the symbols did not occur in the display windows, the mode transits to the normal mode.

In the Zone C mode, a symbol random determination process is executed to randomly determine symbols to be rearranged in display windows, based on the Zone C mode symbol random determination table in which each of symbols arrayed on the three reels are associated with a probability of being rearranged in a display window. Then, symbols thus determined are rearranged in the display window, and a benefit according to a combination of symbols rearranged on the pay line is awarded. The Zone C mode symbol random determination table is a symbol random determination table which specifies a higher probability of rearrangement for the predetermined symbol (e.g., “7”) than the Zone B mode symbol random determination table.

### Definition

The present embodiment deals with a case where the slot machine 1 is the gaming machine; however, the present invention is not limited to this, and is applicable to any given device configured to independently run any type of normal mode (normal game) and another game which develops from the normal game (i.e., a game which is more advantageous for players than the normal game).

The normal game in the present embodiment is run by the slot machines 1, in the present embodiment. The normal game is a slot game of rearranging symbols. The rearrangement of symbols in the slot game is carried out by a mechanical reel unit (equivalent to a display device). The normal game in the normal mode is a game in which, on condition that a gaming value is bet, symbols are rearranged in the display window by the mechanical reel unit, and a payout is awarded according to the rearranged symbols. The high-probability game in the high-probability mode (Zone A, Zone B, Zone C) in the present embodiment is a slot game in which symbols are rearranged in a manner similar to those in the normal game. The high-probability game is a game, the gaming state of which is more advantageous for the player than that of the normal game. In the high-probability game of the present embodiment, the Zone A mode symbol random determination table specifies a higher probability of rearrangement for the predetermined symbol (e.g., “7”) than the normal mode symbol random determination table. The Zone B mode symbol random determination table specifies a higher probability of rearrangement for the predetermined symbol (e.g., “7”) than the Zone A mode symbol random determination table. The Zone C mode symbol random determination table specifies a higher probability of rearrangement for the predetermined symbol (e.g., “7”) than the Zone B mode symbol random determination table. In addition to the above, the high-probability game includes, for example, a free game which does not require betting of a gaming value, a game in which a payout amount and a payout rate are higher than those in the normal game, a mini game different from the normal game, and a game in which a predetermined condition is more probable to be established as compared to the normal game.

The symbols collectively mean “RED7”, “3BAR”, “2BAR”, “1BAR”, and “BLANK”.

The gaming value is electrically valuable information such as electronic money and the like. It is to be noted that the gaming value in the present invention is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Function Flow)

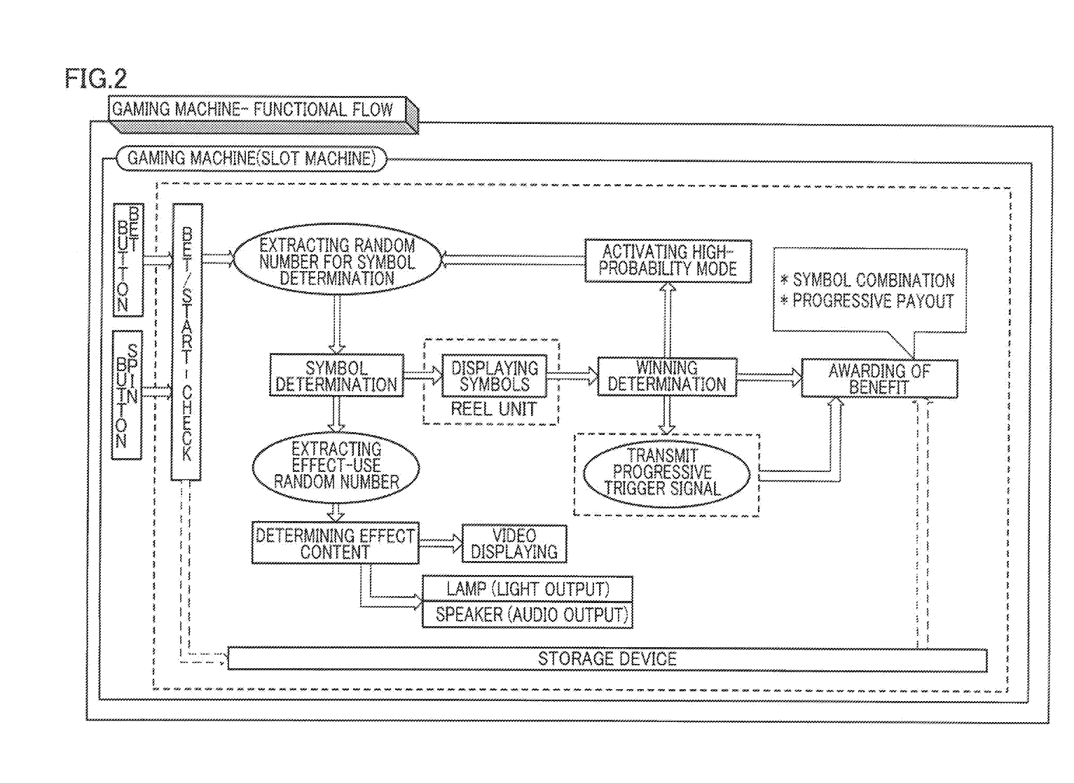

The following describes basic functions of the slot machine related to the embodiment of the present invention, with reference to FIG. 2. FIG. 2 is a diagram showing functional flow of the slot machine related to the embodiment of the present invention.

<Bet/Start-Check>

First, the slot machine checks whether or not a BET button has been pressed by a player, and subsequently checks whether or not a spin button has been pressed by the player.

<Symbol Determination>

Subsequently, when the spin button is pressed by the player, the slot machine extracts a random number for symbol determination, and determines, with reference to the symbol random determination table selected in the symbol random determination table random determination, symbols to be displayed (rearranged) for the player at the time of stopping the scroll of the reel, for respective reels.

<Reel Control>

Thereafter, the slot machine starts the rotation of each reel and stops the rotation of each reel so that the determined symbols are displayed for the player (symbol display).

<Winning Determination>

Subsequently, as the rotation of each reel is stopped, the slot machine determines whether the combination of the symbols displayed for the player is a combination related to winning.

<Awarding Benefit>

When the combination of the symbols displayed for the player is a combination related to winning, the slot machine offers, to the player, benefit according to the type of the combination. For example, when a combination of symbols related to awarding of a credit is displayed, the slot machine awards credits to the player, the amount of which corresponds to the combination of the symbols.

In addition to the above, the slot machine may accumulatively add a part of a bet amount to progressive payout stored in the storage device, each time the unit game is executed. When progressive payout is employed, the slot machine awards the progressive payout accumulatively stored in the storage device to the player, when a progressive trigger condition is established. The progressive (jackpot) is a function of accumulating at least one of coins betted by a player at a slot machine (or slot machines) in the progressive payout and awarding the accumulated progressive payout to a slot machine in which a progressive trigger is established. When the progressive payout is accumulated by plural slot machines, an amount (accumulative amount) accumulated to the progressive payout is calculated and transmitted to an external controller each time the game is executed. The external controller adds the accumulative amount sent from each slot machine to the progressive payout.

When a predetermined condition is satisfied in winning determination, the slot machine is transited from the normal mode to the high-probability mode (Zone A, Zone B, Zone C). In the high-probability mode, a game is run in which the predetermined symbol is more likely to be rearranged as compared to the normal mode.

The slot machine may have other benefits such as a mystery bonus and insurance. In the mystery bonus, a predetermined number of coins are paid out when a win is achieved in dedicated random determination. When a spin button is pressed, the slot machine samples a random number for the mystery bonus, and whether a mystery bonus trigger is established is randomly determined.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine samples an effect-use random number and determines the content of an effect based on randomly determined symbols or the like.

(Overall Structure of Game System)

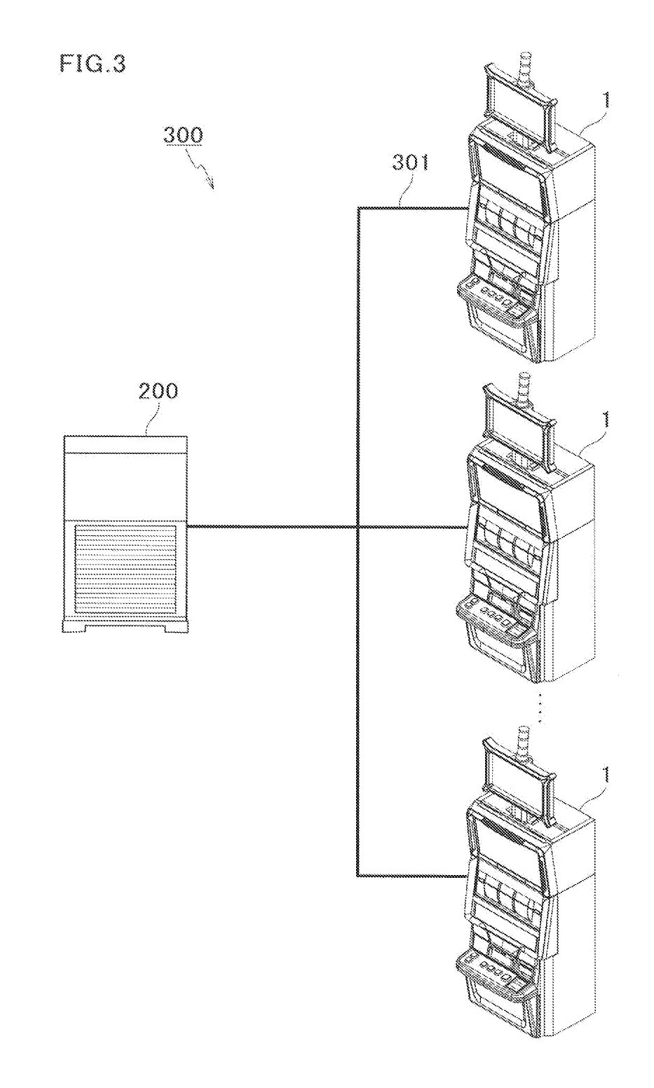

This concludes the description for the basic functions of the slot machine. Now, referring to FIG. 3, a game system including the slot machine will be described. FIG. 3 shows a game system including the slot machine of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

The game system 300 may be constructed in a single gaming facility such as a casino where various games are playable or may be constructed for a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

(Overall Structure of Slot Machine)

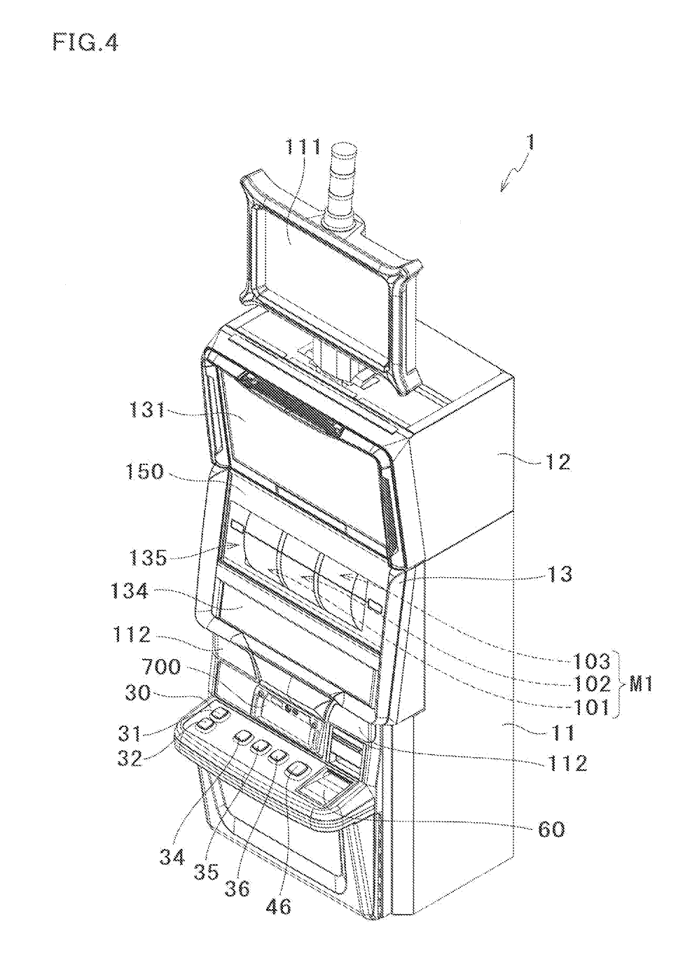

Now, referring to FIG. 4, the overall structure of the slot machine 1 will be described. FIG. 4 shows the overall structure of the slot machine of the embodiment of the present invention.

Electrically valuable information such as electronic money is used as a gaming value in the slot machine 1. It is to be noted that the gaming value is not limited to these, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

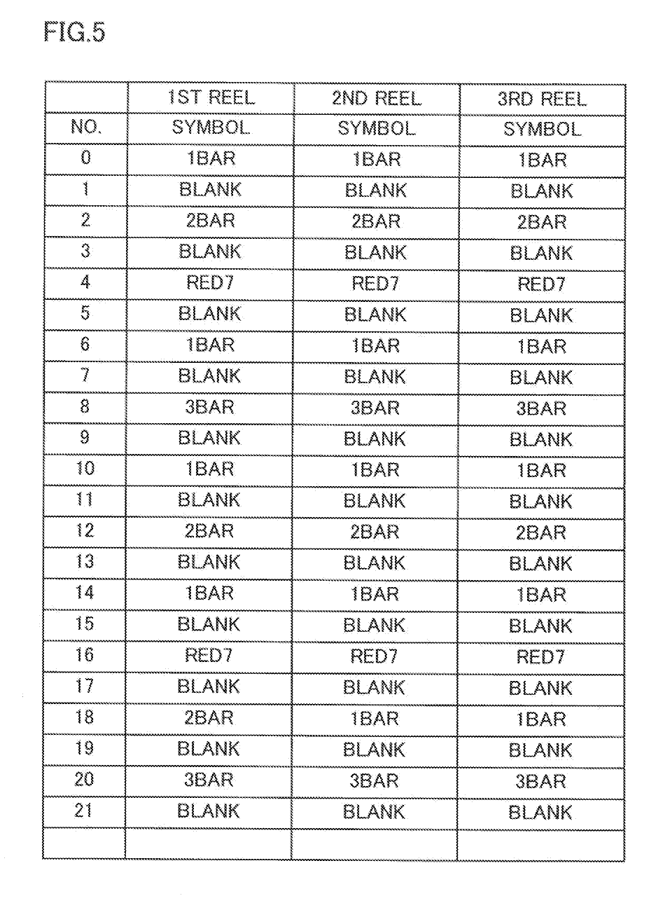

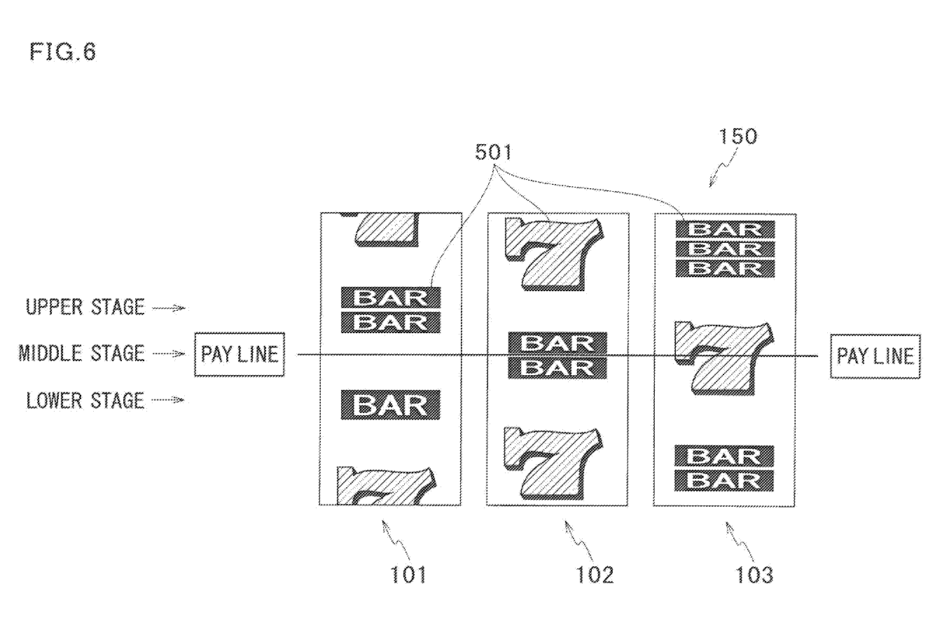

The main door 13 is provided with a reel unit M1 (corresponding to a symbol display device) constituted by three reels 101, 102, and 103. A reel cover 135 is provided in front of the reel device M1. On the front surface of the reel cover 135, a liquid crystal display device 134 by which a gaming status is reported to the player and a transparent panel are provided. This liquid crystal display device 134 is provided with a touch panel 137. The reel cover 135 has the display windows 150 (corresponding to a matrix of display areas) at its central portion. In the display window 150, one symbol 501 is provided in each of three areas (corresponding to display areas) that are: the upper stage, the middle stage, and the lower stage of each of the reels 101, 102, and 103 (see FIG. 6). To put it differently, 9 symbols 501 forming a 3 by 3 matrix are visibly displayed in the display window 150. On the outer circumferential surface of each of the reels 101, 102, and 103, 22 symbols are depicted (see FIG. 5). These 22 symbols 501 are lined up along the rotational direction of the reels 101, 102, and 103 to form a symbol array. Each of the symbol arrays is a combination of “RED7”, “3BAR”, “2BAR”, “1BAR”, and “BLANK”. To the main door 13 is provided a speaker 112.

As shown in FIG. 6, a payline for result determination of symbols 501 rearranged in the display window 150 is set in the slot machine 1. In the present embodiment, one payline is formed at the middle stage of the display window 150 as shown in FIG. 6. Alternatively, plural paylines may be provided and each payline may be activated upon selection by a player.

As shown in FIG. 6, the reel unit M1 rearranges the symbols 501 on the display window 150 by drivingly rotating the reels 101, 102, and 103 each having the symbols 501 on the outer circumferential surface. In the descriptions below, the reels may be referred to as a first reel 101, a second reel 102, and a third reel 103 from the left end in front elevation.

On the inner circumferential side of each of the reels 101, 102, and 103 arranged as above, a backlight unit (not illustrated) is provided. The backlight unit emits illumination light from the inner circumferential side of the reels 101, 102, and 103 to the outer circumferential surface of the reels and is arranged so that the illumination light passing through the outer circumferential surface of the reels is seen from the outside of the display window 150. The backlight unit is configured to be able to change the amount of illumination light in multiple stages. The degree of freedom in the effects using illumination light is therefore high. Furthermore, each backlight unit is able to emit light in multiple colors, and to illuminate the symbols individually with the illumination light.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

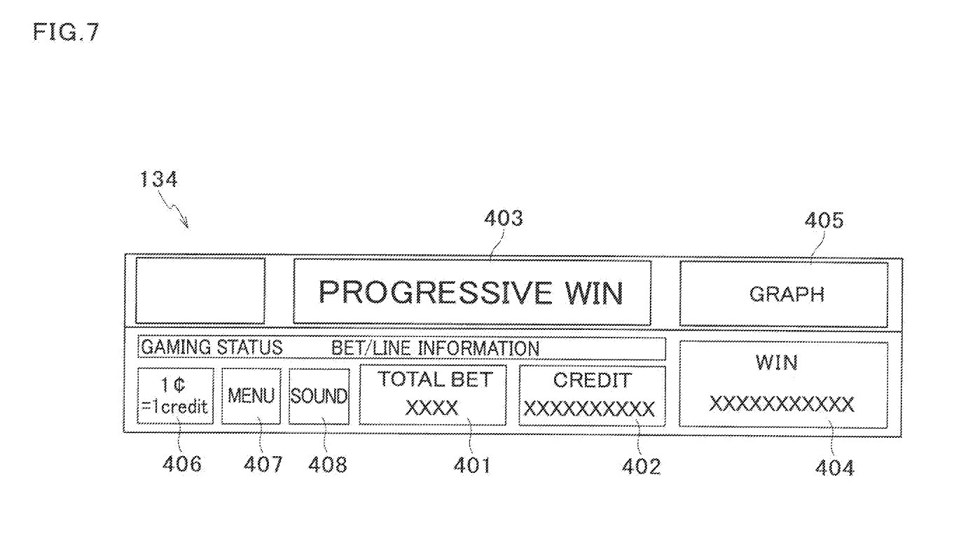

As shown in FIG. 7, on the liquid crystal display device 134 is displayed meters indicating the conditions of the game. For example, a total bet meter 401 displays “Total Bets”. The numerical value is re-calculated at every game play. The credit meter 402 indicates the total credit amount at the time. The default value is 0. The numerical value is increased or decreased according to the gaming value input, the bet, and the game result. A game message area 403 indicates a message explaining the current gaming status. The win meter 404 indicates the total credit amount of the payout having been won.

The liquid crystal display device 134 is provided with a graph touch area 405, a denomination indicator 406, a menu touch area 407, and a sound volume switching touch area 408. When touched by the player, the graph touch area 405 displays, in the form of graphs, the change of the obtained payout amount, the number of game play in the normal mode executed until the transiting to the high-probability mode, and the total obtained credit amount in the Zone A mode, Zone B mode, and Zone C mode, on the upper image display panel 131. As the graph touch area 405 is touched, three types of graph images, i.e., line-graph, bar-graph, and block-graph are displayed in order. The denomination indicator 406 displays current denomination. When the menu touch area 407 is touched by the player, the upper image display panel 131 displays the first page of the HELP screen. The sound volume switching touch area 408 is used for switching the game sound volume in three stages. Each time the sound volume switching touch area 408 is touched by the player, the game sound volume is switched such that, for example, from low to middle to high to small to middle.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the reel unit M1 are provided a control panel 30 having various buttons, a PTS device 700, and a bill entry 60.

The bill entry 60 validate bills and receives genuine bills into the cabinet 11. The bill entry 60 is electrically connected to the PTS device 700, and when a legitimate bill is received, transmits to the PTS device 700 an input signal based on the value of the bill. The input signal includes information on credit data or the like related to the received bill.

The PTS device 700 is a unit in which an LCD (liquid crystal display), a human detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Control Panel 30)

On the control panel 30, a HELP button 31 and a CASHOUT button 32 are arranged in the left side area, a 1-BET button 34, a 2-BET button 35, and a 3-BET button 36 are arranged in the middle area, and a spin button 46 is arranged in the lower stage on the left side area.

The HELP button 31 is pressed when, for example, it is unclear how to play a game. As the HELP button 31 is pressed, various help information is displayed on the upper image display panel 131. The CASHOUT button 32 is an operation button used when checking out credits reserved in the slot machine 1 is discharged.

Each time the 1-BET button 34 is pressed, one of the credits currently owned by the player is betted. The 2-bet button 35 is used to start a game with two bets. The 3-bet button 36 is used to start a game with three bets. A gaming value corresponding to one bet can be optionally changed by setting the denomination.

The spin button 46 is used to start the rotation of the reels 101, 102, and 103.

(Symbol Array)

Now, with reference to FIG. 5, the arrays of the symbols 501 on the first reel 101, the second reel 102, and the third reel 103 of the slot machine 1 will be described.

A symbol table shown in FIG. 5 shows arrays of the symbols 501 displayed on the outer circumferential surfaces of the first reel 101, the second reel 102, and the third reel 103. To each of the first reel 101, the second reel 102, and the third reel 103 is assigned a symbol array including 22 symbols 501 respectively corresponding to code numbers 0 to 21.

As shown in FIG. 5, the types of the symbols include “RED7”, “3BAR”, “2BAR”, “1 BAR”, and “BLANK”.

[Structures of Circuits Provided to Slot Machine]

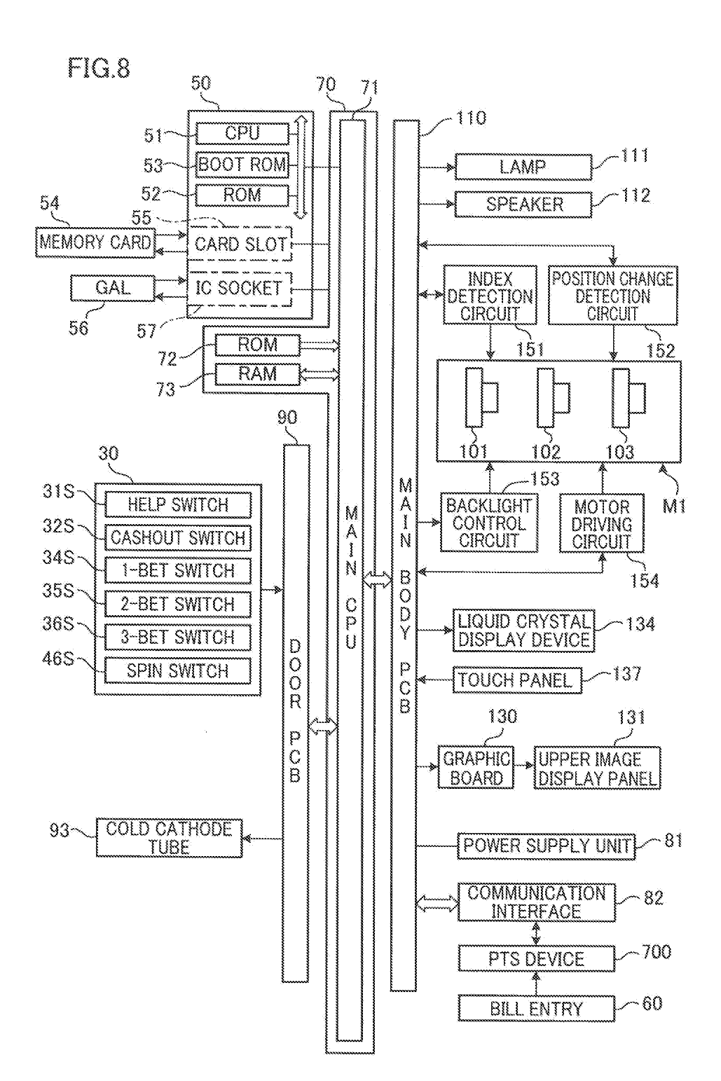

Now, referring to FIG. 8, the configuration of a circuit in the slot machine 1 will be described. FIG. 8 is a block diagram showing an internal structure of the slot machine of the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to a storage device.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the main CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations when these programs are executed. Examples of the areas include: an area that stores counter which manages the number of game play, a bet amount, the credit amount, a payout value of each progressive payout, and the like; and an area that stores symbols (code numbers) randomly determined.

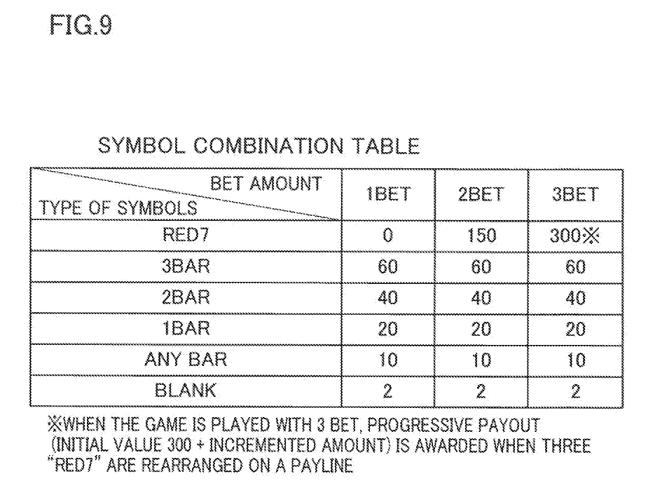

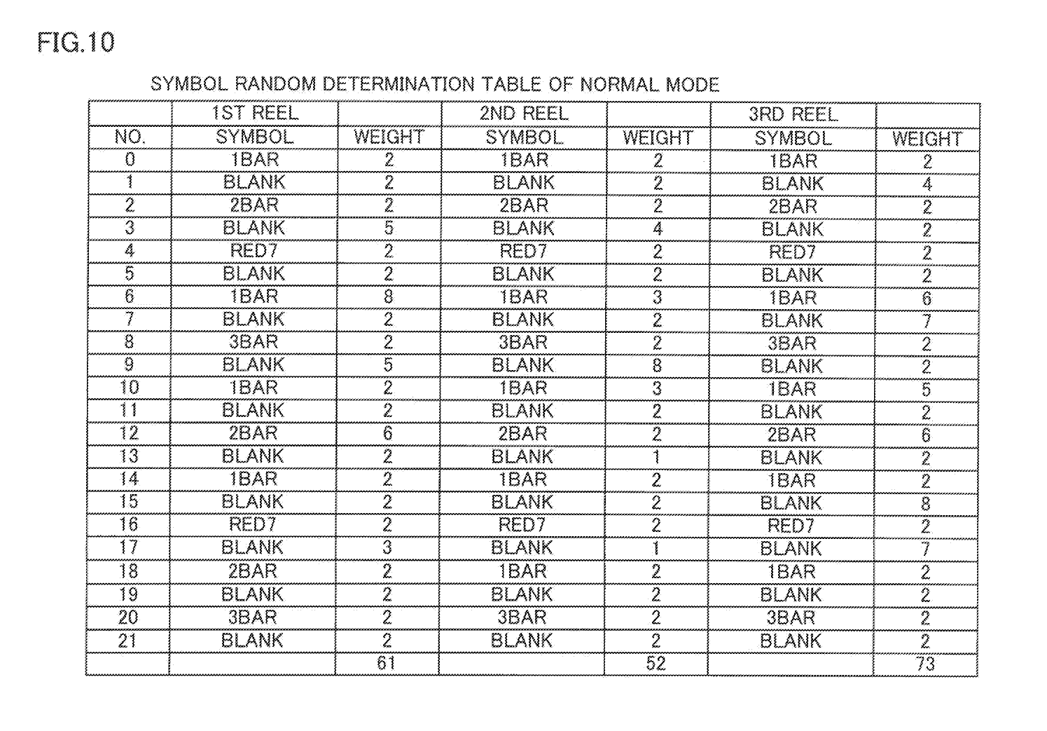

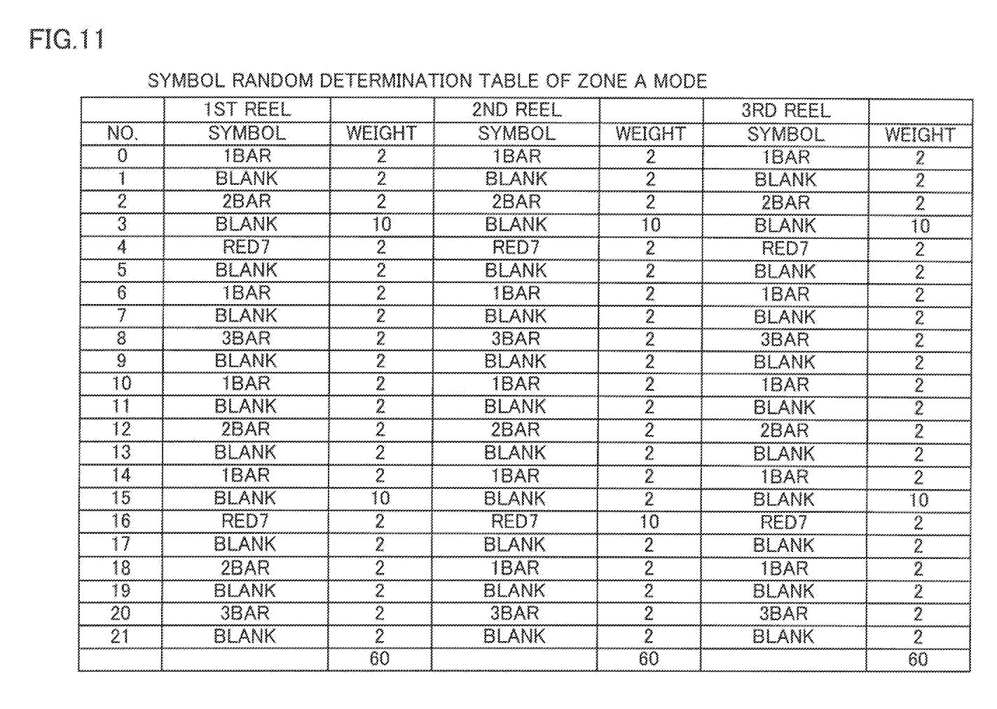

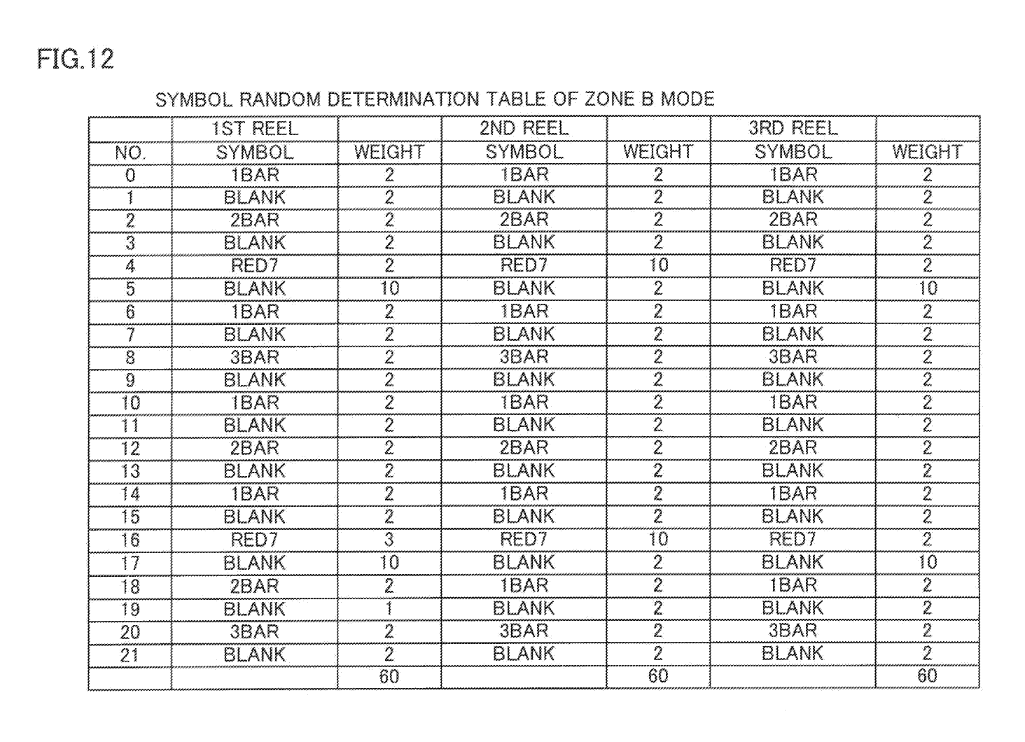

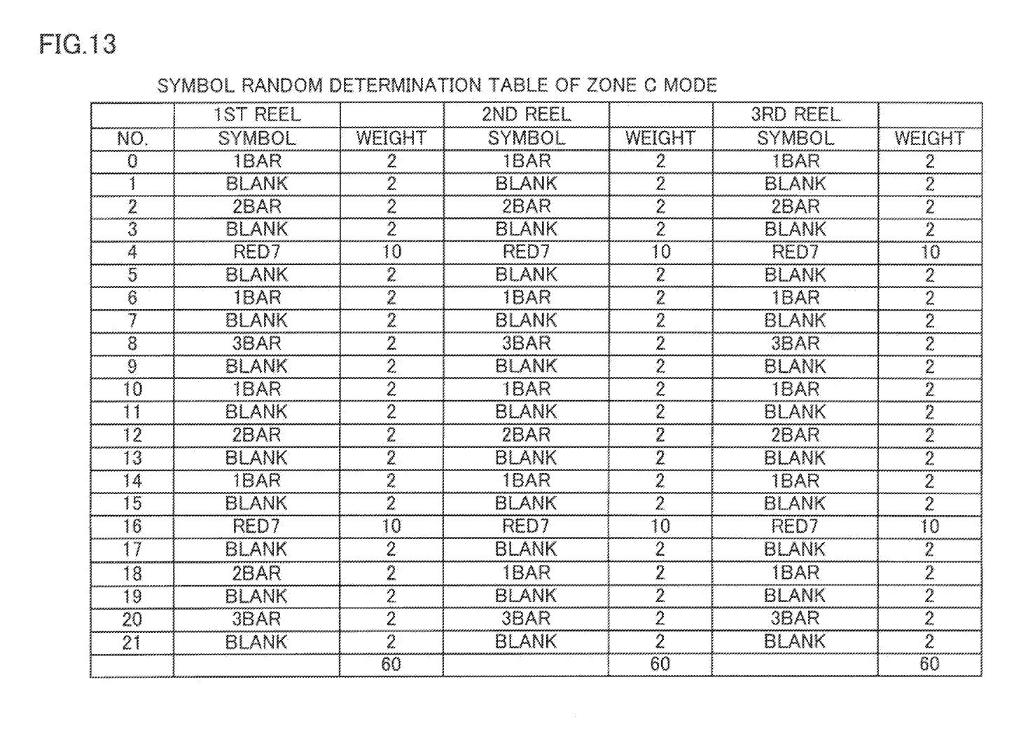

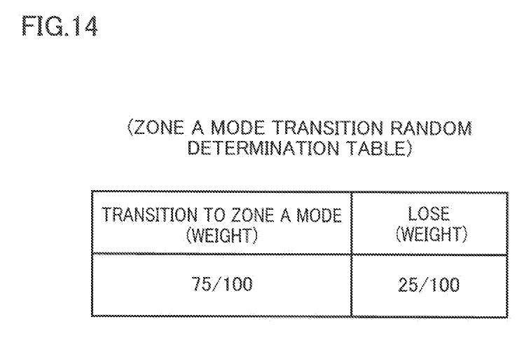

In addition to the above, the RAM 73 stores tables such as a symbol combination table (see FIG. 9), a normal mode symbol random determination table (see FIG. 10), a Zone A mode symbol random determination table (see FIG. 11), a Zone B mode symbol random determination table (see FIG. 12), a Zone C mode symbol random determination tables (see FIG. 13), a Zone A mode transition random determination table (see FIG. 14).

The communication interface 82 is for communicating with the PTS device 700 and the external controller 200. The PTS device 700, upon reception of an input signal from the bill entry 60, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a HELP switch 31S, a CASHOUT switch 32S, a 1-BET switch 34S, a 2-BET switch 35S, a 3-BET switch 36S, and a spin switch 46S, correspondingly to the above-described buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The body PCB 110 is connected with a lamp 111, a speaker 112, a graphic board 130, the liquid crystal display device 134, a touch panel 137, an index detection circuit 151, a position change detection circuit 152, a backlight control circuit 153, and a motor driving circuit 154. The index detection circuit 151, the position change detection circuit 152, a backlight control circuit 153, and a motor driving circuit 154 are connected with the reel unit M1.

The lamp 111 turns on based on a control signal outputted from the main CPU 71. The speaker 112 outputs BGM sound or the like in accordance with a control signal output from the main CPU 71.

The graphic board 130 controls displaying of images on the upper image display panel 131 based on a control signal output from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 134 displays an image based on a control signal output from the main CPU 71. The touch panel 137 detects a position on the liquid crystal display device 134 touched by a finger or the like of the player, and outputs a signal corresponding to the detected position to the main CPU 71.

The motor driving circuit 154 is connected to a stepper motor configured to rotate the reels 101, 102, and 103. Further, the motor driving circuit 154 includes an FPGA (Field Programmable Gate Array) and a driver. The FPGA is an electronic circuit such as a programmable LSI, and functions as a control circuit of the stepper motor. The driver functions as an amplifying circuit for pulses to be input to the stepping motor.

The index detection circuit 151 detects the positions of the rotating reels 101, 102, and 103 and is able to detect the step out of the reels 101, 102, and 103.

The position change detection circuit 152 is configured to detect a change in the stop position of the reels 101, 102, and 103 after the rotation of the reels 101, 102, and 103 is stopped. The position change detection circuit 152 detects a change in the stop positions of the reels 101, 102, and 103 when, for example, a stop position is changed to achieve a winning combination of the symbols 501 by an illicit way when no winning combination of the symbols 501 is achieved. The position change detection circuit 152 is configured to detect a change in the stop position of the reels 101, 102, and 103, for example, by detecting not-shown fins (not illustrated) which is arranged on the inner sides of the reels 101, 102, and 103 at predetermined intervals.

It should be noted that the method of exciting the stepping motor is not particularly limited, and 1-2 phase excitation system or a 2 phase excitation system are adoptable. Further, a DC motor may be adopted in place of the stepping motor. In cases of adopting a DC motor, the main body PCB 110 is connected to an error counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the deviation counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumferential surfaces of the reels 101, 102, and 103 are able to individually illuminate 9 symbols 501 having stopped on the display window 150 by means of the backlight control circuit 153.

(Symbol Combination Table)

Now, symbol combination tables will be described with reference to FIG. 9. FIG. 9 shows a symbol combination table in the slot machine of the embodiment of the present invention.

The symbol combination table defines payouts for bet amounts and symbol combinations achieving winning (WIN). In the slot machine 1, the rotational scroll of the reels 101, 102, and 103 is stopped, and when a combination of three symbols displayed (rearranged) on a payline corresponds to a symbol combination defined in the symbol combination table, winning is achieved. In accordance with the type of winning, a benefit will be given to the player in the form of awarding payout and the like. It is noted that winning is not established (i.e. the game is lost) when the combination of symbols displayed (rearranged) on the payline does not match with any of the combinations of symbols specified by the symbol combination table.

Basically, winning is achieved when three symbols of the following types are displayed on a payline: “RED7”, “3BAR”, “2BAR”, “1BAR”, and “BLANK”. Winning as “ANYBAR” is also achieved when a symbol combination including “3BAR”, “2BAR”, and “1BAR” is established. When the game is played with one bet, no payout is awarded for “RED7”. When the game is played with three bets, progressive payout (initial value 300+incremented amount) is awarded when three “RED7” are rearranged on a payline.

(Symbol Random Determination Table of Normal Mode)

Now, the following will describe a normal mode symbol random determination table (equivalent to the predetermined symbol random determination table) will be described with reference to FIG. 10. In the present embodiment, the normal mode symbol random determination table is a random determination table defining probabilities of 22 symbols regarding the reels 101, 102, and 103, which are referred to in a symbol random determination process of determining symbols to be rearranged in the middle stage (payline) of the display window 150 in a main control process which will be described later.

In the normal mode symbol random determination table, probabilities (WEIGHT) are set for 22 symbols corresponding to code numbers “0” to “21”, respectively, in relation to the reels 101, 102, and 103. Each probability (WEIGHT) indicates a probability that the corresponding symbol 501 is rearranged in the middle stage (on the payline) of the display window 150. For example, in the normal mode symbol random determination table shown in FIG. 10, “1BAR” of the first reel 101 corresponding to the code number “0” is rearranged in the middle stage of the display window 150 (on the payline) at a probability of 2/61. “RED7” of the second reel 102 corresponding to the code number “4” is rearranged in the middle stage of the display window 150 (on the payline) at a probability of 2/52. “3RED” of the third reel 103 corresponding to the code number “8” is rearranged in the middle stage of the display window 150 (on the payline) at a probability of 2/73.

(Symbol Random Determination Table of Zone A Mode)

Now, the Zone A mode symbol random determination table will be described with reference to FIG. 11. In the present embodiment, the Zone A mode symbol random determination table is a random determination table defining probabilities of 22 symbols regarding the reels 101, 102, and 103, which are referred to in a symbol random determination process of determining symbols to be rearranged in the middle stage (payline) of the display window 150 in a Zone A mode process which will be described later.

In the Zone A mode symbol random determination table, probabilities (WEIGHT) are set for 22 symbols corresponding to code numbers “0” to “21”, respectively, in relation to the reels 101, 102, and 103. Each probability (WEIGHT) indicates a probability that the corresponding symbol 501 is rearranged in the middle stage (on the payline) of the display window 150. For example, in the normal mode symbol random determination table shown in FIG. 11, “BLANK” of the first reel 101 corresponding to the code number “3” is rearranged in the middle stage of the display window 150 (on the payline) at a probability of 10/60. “RED7” of the second reel 102 corresponding to the code number “4” is rearranged in the middle stage of the display window 150 (on the payline) at a probability of 10/60. “BLANK” of the third reel 103 corresponding to the code number “3” is rearranged in the middle stage of the display window 150 (on the payline) at a probability of 10/60.

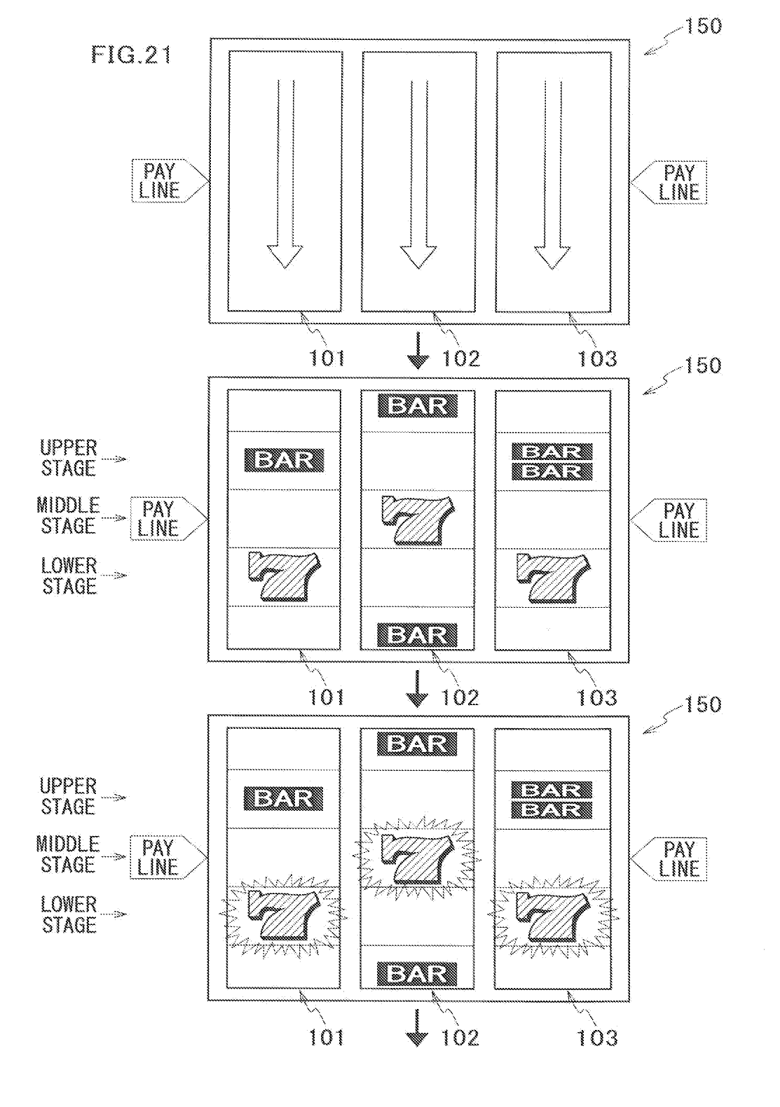

For example, in the Zone A mode symbol random determination table, “BLANK” of the first reel 101 corresponding to the code numbers “3” and “15” is rearranged in the middle stage of the display window 150 (on the payline) at a highest probability of 10/60. As the result, “RED7” corresponding to the code numbers “4” and “16” will also be rearranged in the lower stage of the first reel 101 at a highest probability, as shown in FIG. 21. Further, “RED7” of the second reel 102 corresponding to the code numbers “4” and “16” is rearranged in the middle stage of the display window 150 (on the payline) at a highest probability of 10/60. As the result, “RED7” corresponding to the code numbers “4” and “16” will also be rearranged in the middle stage of the second reel 102 at a highest probability, as shown in FIG. 21. Further, “BLANK” of the third reel 103 corresponding to the code numbers “3” and “15” is rearranged in the middle stage of the display window 150 (on the payline) at a highest probability of 10/60. As the result, “RED7” corresponding to the code numbers “4” and “16” will also be rearranged in the lower stage of the third reel 103 at a highest probability, as shown in FIG. 21. Thus, with the Zone A mode symbol random determination table, “RED7” of the first reel 101 is rearranged in the lower stage, “RED7” of the second reel 102 is rearranged in the middle stage, and “RED7” of the third reel 103 is rearranged in the lower stage. This way, “RED7” symbols form a reverse V-shape at a high probability.

(Symbol Random Determination Table of Zone B Mode)

Now, the Zone B mode symbol random determination table will be described with reference to FIG. 12. In the present embodiment, the Zone B mode symbol random determination table is a random determination table defining probabilities of 22 symbols regarding the reels 101, 102, and 103, which are referred to in a symbol random determination process of determining symbols to be rearranged in the middle stage (payline) of the display window 150 in a Zone B mode process which will be described later.

In the Zone B mode symbol random determination table, probabilities (WEIGHT) are set for 22 symbols corresponding to code numbers “0” to “21”, respectively, in relation to the reels 101, 102, and 103. Each probability (WEIGHT) indicates a probability that the corresponding symbol 501 is rearranged in the middle stage (on the payline) of the display window 150. For example, in the normal mode symbol random determination table shown in FIG. 12, “BLANK” of the first reel 101 corresponding to the code number “5” is rearranged in the middle stage of the display window 150 (on the payline) at a probability of 10/60. “RED7” of the second reel 102 corresponding to the code number “4” is rearranged in the middle stage of the display window 150 (on the payline) at a probability of 10/60. “BLANK” of the third reel 103 corresponding to the code number “5” is rearranged in the middle stage of the display window 150 (on the payline) at a probability of 10/60.

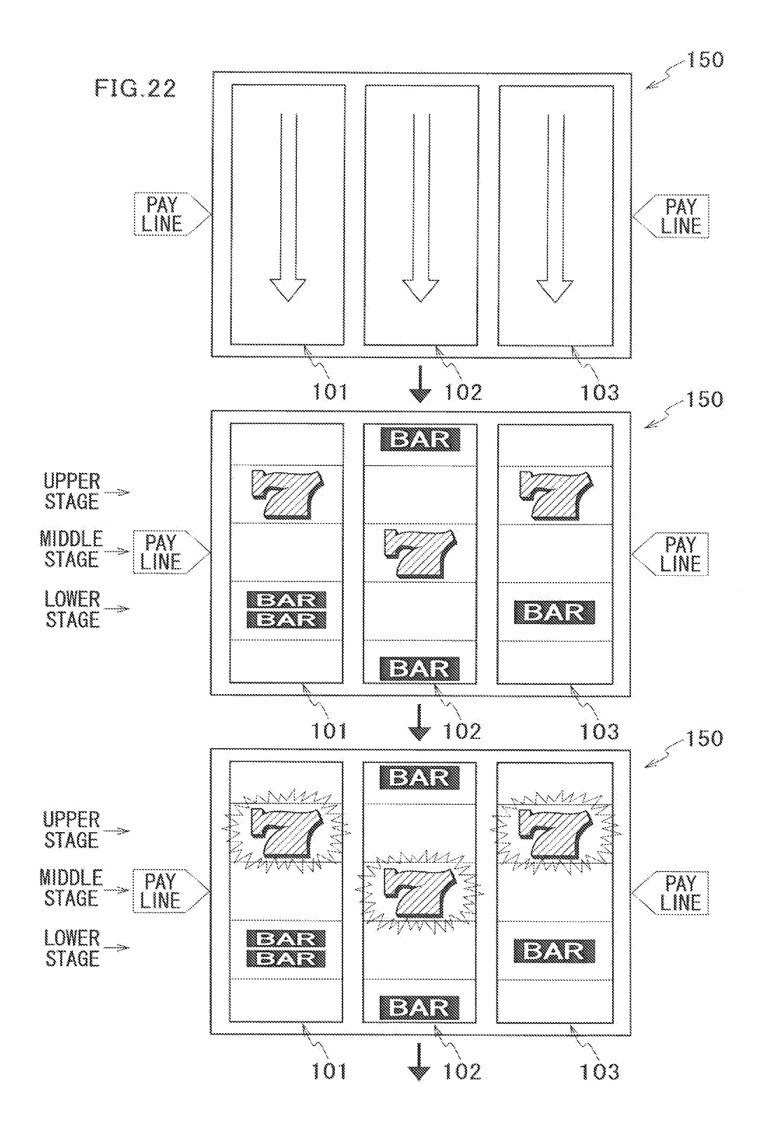

For example, in the Zone B mode symbol random determination table, “BLANK” of the first reel 101 corresponding to the code numbers “5” and “17” is rearranged in the middle stage of the display window 150 (on the payline) at a highest probability of 10/60. As the result, “RED7” corresponding to the code numbers “4” or “16” will also be rearranged in the upper stage of the first reel 101 at a highest probability, as shown in FIG. 22. Further, “RED7” of the second reel 102 corresponding to the code numbers “4” and “16” is rearranged in the middle stage of the display window 150 (on the payline) at a highest probability of 10/60. As the result, “RED7” corresponding to the code numbers “4” and “16” will also be rearranged in the middle stage of the second reel 102 at a highest probability, as shown in FIG. 22. Further, “BLANK” of the third reel 103 corresponding to the code numbers “5” and “17” is rearranged in the middle stage of the display window 150 (on the payline) at a highest probability of 10/60. As the result, “RED7” corresponding to the code numbers “4” or “16” will also be rearranged in the upper stage of the third reel 103 at a highest probability, as shown in FIG. 22. Thus, with the Zone A mode symbol random determination table, “RED7” of the first reel 101 is rearranged in the upper stage, “RED7” of the second reel 102 is rearranged in the middle stage, and “RED7” of the third reel 103 is rearranged in the upper stage. This way, “RED7” symbols form a V-shape at a high probability.

(Symbol Random Determination Table of Zone C Mode)

Now, the Zone C mode symbol random determination table will be described with reference to FIG. 13. In the present embodiment, the Zone C mode symbol random determination table is a random determination table defining probabilities of 22 symbols regarding the reels 101, 102, and 103, which are referred to in a symbol random determination process of determining symbols to be rearranged in the middle stage (payline) of the display window 150 in a Zone C mode process which will be described later.

In the Zone C mode symbol random determination table, probabilities (WEIGHT) are set for 22 symbols corresponding to code numbers “0” to “21”, respectively, in relation to the reels 101, 102, and 103. Each probability (WEIGHT) indicates a probability that the corresponding symbol 501 is rearranged in the middle stage (on the payline) of the display window 150. For example, in the normal mode symbol random determination table shown in FIG. 13, “RED7” of the first reel 101 corresponding to the code number “4” is rearranged in the middle stage of the display window 150 (on the payline) at a probability of 10/60. “RED7” of the second reel 102 corresponding to the code number “4” is rearranged in the middle stage of the display window 150 (on the payline) at a probability of 10/60. “RED7” of the third reel 103 corresponding to the code number “4” is rearranged in the middle stage of the display window 150 (on the payline) at a probability of 10/60.

For example, in the Zone C mode symbol random determination table, “RED7” of the first reel 101 corresponding to the code numbers “4” and “16” is rearranged in the middle stage of the display window 150 (on the payline) at a highest probability of 10/60. Further, “RED7” of the second reel 102 corresponding to the code numbers “4” and “16” is rearranged in the middle stage of the display window 150 (on the payline) at a highest probability of 10/60. Further, “RED7” of the third reel 103 corresponding to the code numbers “4” and “16” is rearranged in the middle stage of the display window 150 (on the payline) at a highest probability of 10/60. Thus, with the Zone C mode symbol random determination table, “RED7” of the first reel 101 is rearranged in the middle stage, “RED7” of the second reel 102 is rearranged in the middle stage, and “RED7” of the third reel 103 is rearranged in the middle stage. This way, “RED7” symbols are arranged on the payline at a high probability.

As described, the Zone A mode symbol random determination table specifies a higher probability of rearrangement for the predetermined symbol (“RED7”) than the normal mode symbol random determination table. The Zone B mode symbol random determination table specifies a higher probability of rearrangement for the predetermined symbol (“RED7”) than the Zone A mode symbol random determination table. The Zone C mode symbol random determination table specifies a higher probability of rearrangement for the predetermined symbol (“RED7”) than the Zone B mode symbol random determination table.

(Zone A Mode Transition Random Determination Table)

Now, the Zone A mode transition random determination table will be described with reference to FIG. 14. The Zone A mode transition random determination table is a table which is referred to in a later-described Zone A mode transition random determination process in the main control process.

As shown in FIG. 14, the Zone A mode transition random determination table specifies probability of transition from the normal mode to the Zone A mode, and the probability (probability of losing) of no transition from the normal mode to the Zone A mode. To be more specific, the probability of transition from the normal mode to the Zone A mode is 75/100, and the probability of no transition (probability of losing) from the normal mode to the Zone A mode is 25/100.

(Contents of Program)

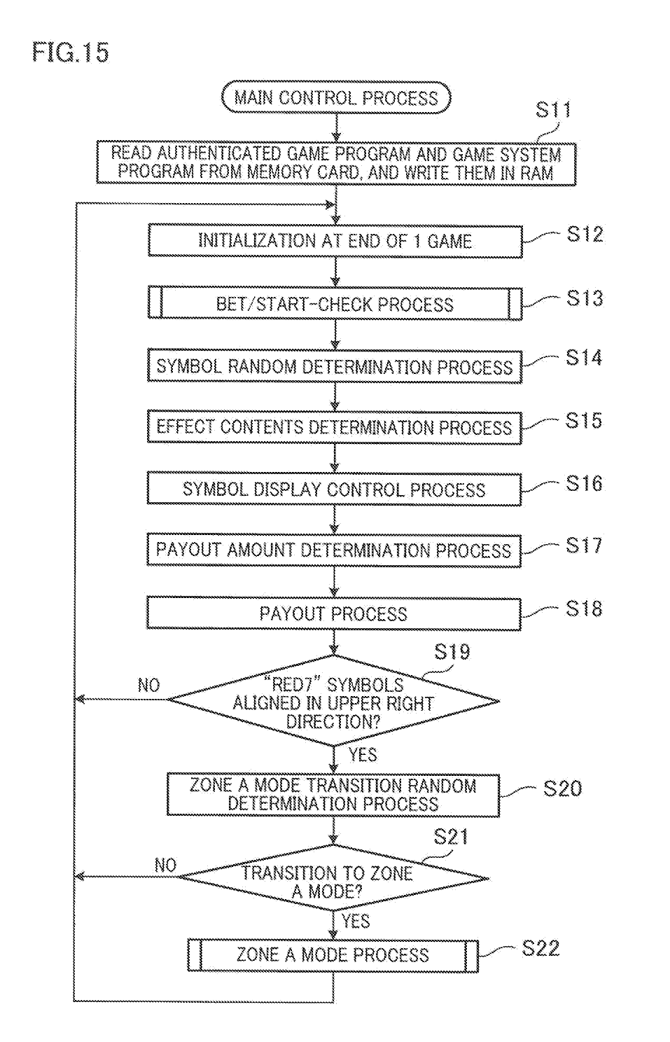

Now, the program to be executed by the slot machine 1 is described with reference to FIG. 15 to FIG. 19.

(Main Control Process)

Referring to FIG. 15, a main control process will be described. In the main control process, a game (normal game) is executed in the normal mode.

First, when the slot machine 1 is powered on, the main CPU 71 reads an authenticated game program and a game system program from a memory card 54 via a gaming board 50, and then write them in the RAM 73 (S11).

Subsequently, the main CPU 71 executes an initializing process at the end of each play of the game, in order to start the normal game (S12). This process clears data in a working area of the RAM 73, which becomes unnecessary at the end of each play of the normal game, e.g., the bet amount, symbols randomly determined, and the like.

The main CPU 71 then executes a later-described bet/start-check process (S13). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S14). In this symbol random determination process, three to-be-stopped symbols (on the first reel 101, the second reel 102, and the third reel 103) to be rearranged in the middle stage of the display window 150 (on the payline) are randomly determined based on the probabilities defined in the normal mode symbol random determination table (see FIG. 10).

When the code number “0” is selected at the random determination probability of 2/61 for the first reel 101, “1BAR” corresponding to the code number “0” of the first reel 101 is selected as a to-be-stopped symbol to be rearranged in the middle stage of the display window 150 (on the payline) When the code number “4” is selected at the random determination probability of 2/52 for the second reel 102, “RED7” corresponding to the code number “4” of the second reel 102 is selected as a to-be-stopped symbol to be rearranged in the middle stage of the display window 150 (on the PAY LINE). When the code number “8” is selected at the random determination probability of 2/73 for the third reel 103, “3BAR” corresponding to the code number “8” of the third reel 103 is selected as a to-be-stopped symbol to be rearranged in the middle stage of the display window 150 (on the PAY LINE).

The main CPU 71 stores the determined to-be-stopped symbols on the reels 101 to 103 in a symbol storing area in the RAM 73.

Subsequently, the main CPU 71 executes an effect contents determination process (S15). The main CPU 71 extracts an effect-use random number and randomly selects one of a plurality of predetermined effect contents.

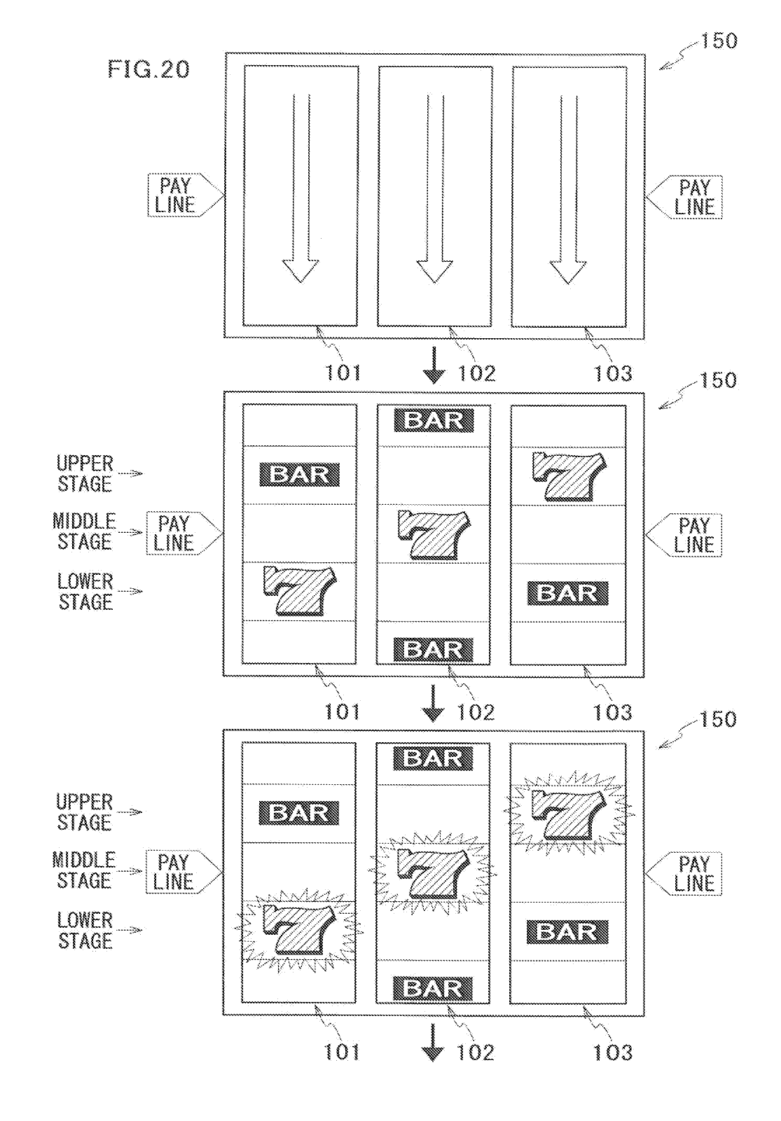

Then, the main CPU 71 executes a symbol display control process (S16). In this symbol display control process, as shown in FIG. 20, the scroll of the reels 101 to 103 starts, and after a predetermined time elapses, the to-be-stopped symbols corresponding to the reels 101 to 103 selected in the symbol random determination process in S14 stop one by one in the middle stage of the display window 150 (on the PAY LINE). That is, nine symbols including the to-be-stopped symbols are displayed in the display window 150 (in the upper stage, the middle stage, and the lower stage). For example, when the to-be-stopped symbol on the first reel 101 is “RED7”, the to-be-stopped symbol on the second reel 102 is “BLANK”, and the to-be-stopped symbol on the third reel 103 is “BLANK”, “RED7”, “BLANK”, and “BLANK” are rearranged in the middle stage of the display window 150 (on the payline) as shown in FIG. 20.

The main CPU 71 then executes a payout amount determination process (S17). In this process, payout is determined based on a symbol combination displayed on the payline with reference to the symbol combination table (see FIG. 9) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “3BAR”, “60” credits are determined as the payout with reference to the symbol combination table and stored in the payout amount storage area in the RAM 73.

When the value of the bet counter is “3” (MAXBET) and the symbol combination displayed on the payline is three “RED7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 300 in each game play. When the progressive payout is won, the value of the progressive payout counter is stored in the payout amount storage area of the RAM 73. Furthermore, when the progressive payout is won, a message which notifies that the progressive payout has been awarded is displayed. To be more specific, messages “CONGRATULATIONS!”, “PROGRESSIVE WIN”, and “XXXXXXXX CREDITS” are displayed on the upper image display panel 131.

Then a payout process is executed (S18). The main CPU 71 adds the value stored in the payout amount storage area to the value of the credit counter in the RAM 73.

Then, the main CPU 71 determines whether three “RED7” symbols are aligned in the upper right direction, in relation to the nine symbols rearranged in the display window 150 (S19). To be more specific, as shown in FIG. 20, “RED7” of the first reel 101 is rearranged in the lower stage, “RED7” of the second reel 102 is rearranged in the middle stage, and “RED7” of the third reel 103 is rearranged in the upper stage. Then, whether or not the “RED7” symbols are aligned in the upper right direction is determined. Then, the main CPU 71, if determining that the three “RED7” symbols are not aligned in the upper right direction (S19: NO), proceeds to the process of S12.

On the other hand, the main CPU 71, if determining that the three “RED7” symbols are aligned in the upper right direction (S19: YES), proceeds to the Zone A mode transition random determination process (S20).

In the Zone A mode transition random determination process, the main CPU 71 randomly determines whether to make a transition from the normal mode to the Zone A mode (75/100) or not to make a transition from the normal mode to the Zone A mode (25/100), based on the Zone A mode transition random determination table (see FIG. 14).

Subsequently, as a result of the Zone A transition random determination process of S20, the main CPU 71 determines whether to make a transition from the normal mode to the Zone A mode (S21). When not transition from the normal mode to the Zone A mode (S21: NO), the routine proceeds to S12.

To the contrary, if transition from the normal mode to the Zone A mode is to occur as a result of the Zone A transition random determination process of S20 (S21: YES), the later-described Zone A mode process is executed (S22). After the Zone A mode process, the routine proceeds to S12.

(Bet/Start-Check Process)

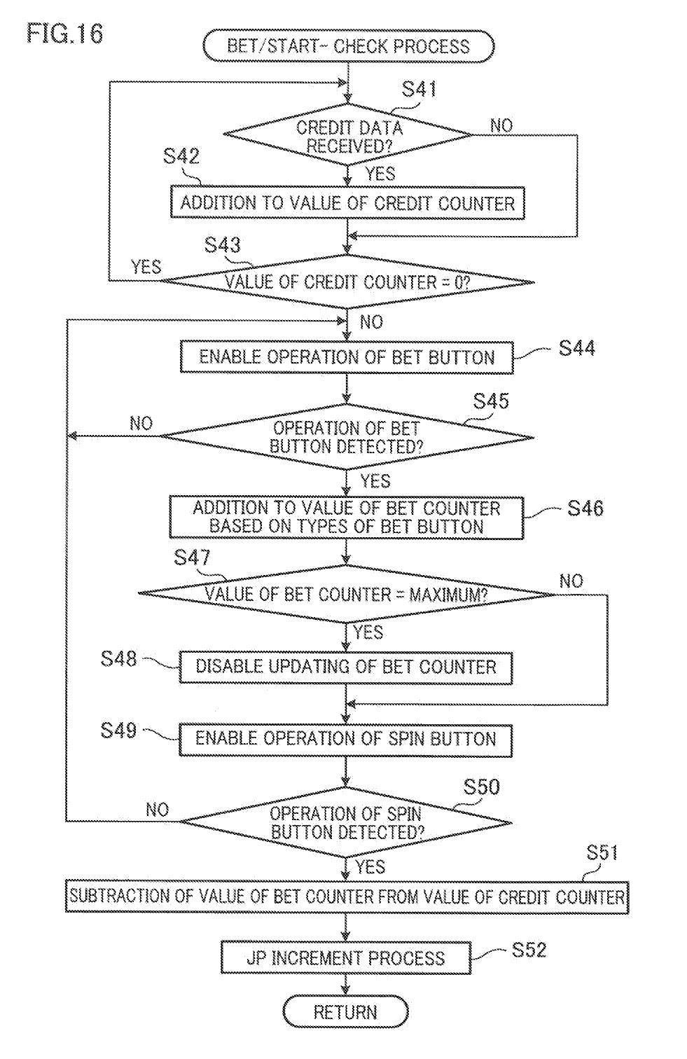

Now the bet/start-check process will be described with reference to FIG. 16.

To begin with, the main CPU 71 determines whether credit data has been received from the PTS device 700 (S41). The credit data is sent from the PTS device 700 to the main CPU 71, for example, when the IC card is inserted into the card insertion slot and when the bill entry 60 receives a genuine bill.

When the credit data is received (S41: YES), the main CPU 71 adds the amount indicated by the received credit data to the value of the credit counter (S42).

After the step S42 or when determining in S41 that no credit data is received (S41: NO), the main CPU 71 determines whether or not the value stored in the credit counter is 0 (S43). When determining that the value of the credit counter is 0 (S43: YES), the main CPU 71 goes back to S41.

When the main CPU 71 determines that the value of the credit counter is not 0 (S43: NO), the main CPU 71 permits operation acceptance of the BET buttons (1-BET button 34, 2-BET button 35, and 3-BET button 36) (S44).

Then the main CPU 71 determines whether an operation of the BET button is detected (S45). When an operation of the bet button by a player is detected by the bet switch (1-BET switch 34S, 2-BET switch 35S, or 3-BET switch 36S), the main CPU 71 performs addition to the value of the bet counter in the RAM 73, based on the type of the BET button (S46).

Subsequently, the main CPU 71 determines whether the value of the bet counter is at the maximum (S47). When determining that the value of the bet counter is at the maximum (S47: YES), the main CPU 71 prohibits the update of the value of the bet counter (S48). After S48, when determining in S47 that the value of the bet counter is not at the maximum (S47: NO), the main CPU 71 enables operation of the spin button 46 (S49).

After S49, the main CPU 71 determines whether an operation of the spin button 46 is detected (S50). When the main CPU 71 determines that an operation of the spin button 46 is not detected (S50: NO), the routine proceeds to S41.

In the meanwhile, when the main CPU 71 determines that operation of the spin button 46 is detected (S50: YES), the main CPU 71 subtracts the value of the bet counter calculated in S46 from the value of the credit counter (S51).

The main CPU 71 then executes a JP increment process (S52). In the JP increment process, as the resource of the progressive payout, the value of the progressive payout counter in the RAM 73 is incremented by a value calculated by multiplying the value of the bet counter calculated in S46 by an increment rate (0.01 but may be optionally set) set in the present embodiment. For example, when the value of the bet counter calculated in S46 is “3”, 3×0.01=0.03 credit is added to the value of the progressive payout counter. In the present embodiment, the initial value of the progressive payout counter is 300 credits. Therefore, in the progressive payout counter, a value calculated by multiplying the value of the bet counter by the increment rate (0.01) is accumulatively added to the initial value of 300 in each game play.

Then the bet/start-check process is terminated.

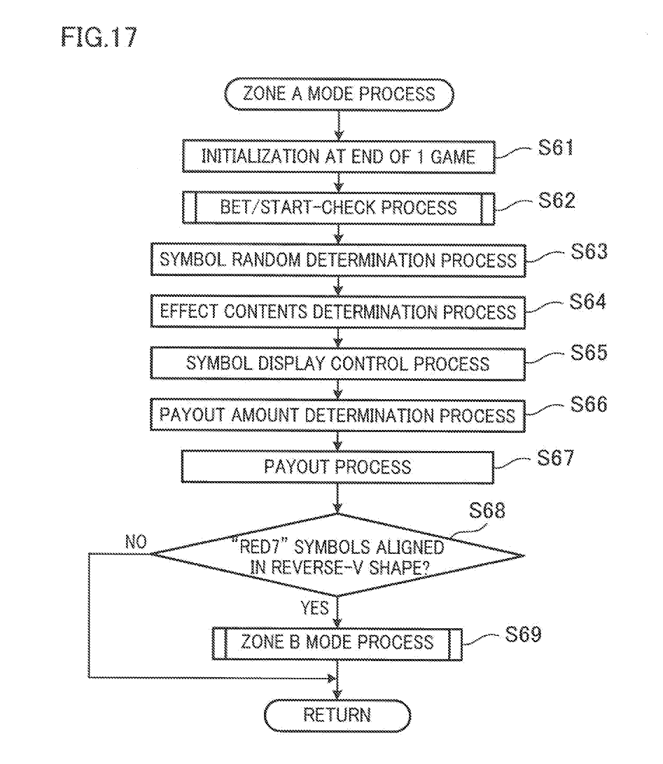

(Zone A Mode Process) Next, the Zone A mode process will be described with reference to FIG. 17. In the Zone A mode process, a game (high-probability mode) is executed in the Zone A mode.

To A with, the main CPU 71 executes an initializing process at the end of each play of the game, in order to start the Zone A mode game (S61). This process clears data in a working area of the RAM 73, which becomes unnecessary at the end of each play of the game, e.g., the bet amount, symbols randomly determined, and the like.

The main CPU 71 then executes the above-described bet/start-check process (S62). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S63). In this symbol random determination process, three to-be-stopped symbols (on the first reel 101, the second reel 102, and the third reel 103) to be rearranged in the middle stage of the display window 150 (on the payline) are randomly determined based on the probabilities defined in the Zone A mode symbol random determination table (see FIG. 11).

When the code number “3” is selected at the random determination probability of 10/60 for the first reel 101, “BLANK” corresponding to the code number “3” of the first reel 101 is selected as a to-be-stopped symbol to be rearranged in the middle stage of the display window 150 (on the payline) When the code number “4” is selected at the random determination probability of 10/60 for the second reel 102, “RED7” corresponding to the code number “4” of the second reel 102 is selected as a to-be-stopped symbol to be rearranged in the middle stage of the display window 150 (on the PAY LINE). When the code number “3” is selected at the random determination probability of 10/60 for the third reel 103, “BLANK” corresponding to the code number “3” of the third reel 103 is selected as a to-be-stopped symbol to be rearranged in the middle stage of the display window 150 (on the PAY LINE).

The main CPU 71 stores the determined to-be-stopped symbols on the reels 101 to 103 in a symbol storing area in the RAM 73.

Then, the main CPU 71 executes an effect contents determination process (S64). The main CPU 71 extracts an effect-use random number and randomly selects one of a plurality of predetermined effect contents.

Then, the main CPU 71 executes a symbol display control process (S65). In this symbol display control process, as shown in FIG. 21, the scroll of the reels 101 to 103 starts, and after a predetermined time elapses, the to-be-stopped symbols corresponding to the reels 101 to 103 selected in the symbol random determination process in S63 stop one by one in the middle stage of the display window 150 (on the PAY LINE). That is, nine symbols including the to-be-stopped symbols are displayed in the display window 150 (in the upper stage, the middle stage, and the lower stage). For example, when the to-be-stopped symbol on the first reel 101 is “RED7”, the to-be-stopped symbol on the second reel 102 is “BLANK”, and the to-be-stopped symbol on the third reel 103 is “BLANK”, “RED7”, “BLANK”, and “BLANK” are rearranged in the middle stage of the display window 150 (on the payline) as shown in FIG. 21.

Then, the main CPU 71 executes a payout amount determination process (S66). In this process, payout is determined based on a symbol combination displayed on the payline with reference to the symbol combination table (see FIG. 9) stored in the RAM 73 and the value (1BET, 2BET, or 3BET) of the bet counter, and the payout is stored in the payout amount storage area provided in the RAM 73.

When the value of the bet counter is “3” (MAXBET) and the symbol combination displayed on the payline is three “RED7”, progressive payout is awarded.

Then a payout process is executed (S67). The main CPU 71 adds the value stored in the payout amount storage area to the value of the credit counter in the RAM 73.

Then, the main CPU 71 determines whether three “RED7” symbols are aligned in a small reverse V-shape, in relation to the nine symbols rearranged in the display window 150 (S68). To be more specific, as shown in FIG. 21, “RED7” of the first reel 101 is rearranged in the lower stage, “RED7” of the second reel 102 is rearranged in the middle stage, and “RED7” of the third reel 103 is rearranged in the lower stage. Then, whether or not three “RED7” symbols are aligned in a reverse V-shape is determined. Then, the main CPU 71 ends this process, if it determines that the three “RED7” symbols are not aligned in a reverse V-shape (S68: NO).

In cases where the three “RED7” symbols do not form a reverse V-shape (S68: No), the main CPU 71 may randomly determine whether to continue the game in the Zone A mode (high-probability mode), or to perform falling (i.e., make a transition from the Zone A mode game (high-probability mode) to the normal mode game). If the game in the Zone A mode is to be continued as the result of the random determination, the process returns to S61. If the falling is to occur as the result of the random determination, the Zone A mode is ended.

On the other hand, if it is determined that the three “RED7” symbols form a reverse V-shape (S68: Yes), the main CPU 71 makes a transition to the later described Zone B mode (S69). Then, the present routine ends.

As described, if it is determined that the three “RED7” symbols do not form a reverse V-shape, the process is to return to the normal game of the normal mode. Thus, stepping up to a game with a higher probability of the predetermined symbol (“RED7”) being rearranged on the display window 150 (transitions of normal game-->Zone A-->Zone B) occurs only when a specific combination of symbols continues to occur (e.g., “RED7” symbols are aligned in the upper right direction, three “RED7” symbols form a reverse V-shape). This relieves the monotony of the game by drawing the players' attention to see if a combination of rearranged symbols forms the specific combination.

(Zone B Mode Process)

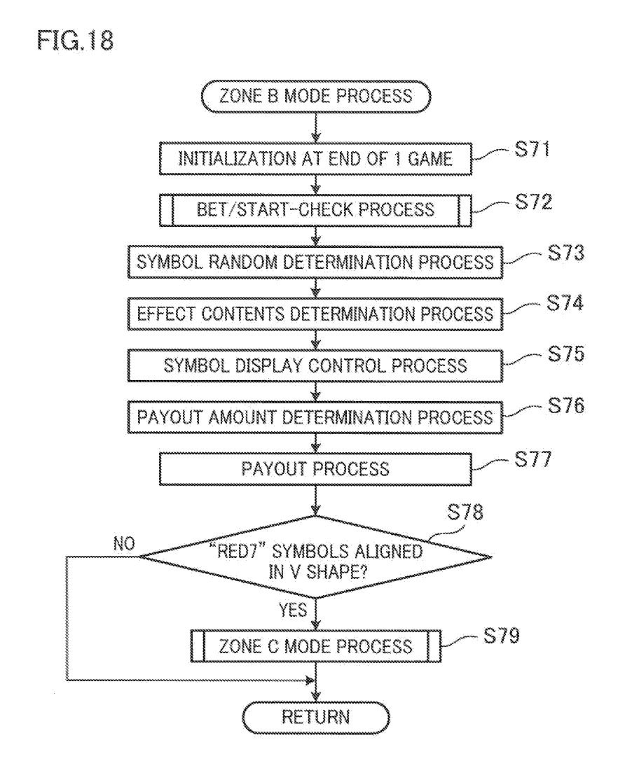

Next, the Zone B mode process will be described with reference to FIG. 18. In the Zone B mode process, B game (high-probability mode) is executed in the Zone A mode.

To begin with, the main CPU 71 executes an initializing process at the end of each play of the game, in order to start the Zone B mode game (S71). This process clears data in a working area of the RAM 73, which becomes unnecessary at the end of each play of the game, e.g., the bet amount, symbols randomly determined, and the like.

The main CPU 71 then executes the above-described bet/start-check process (S72). In this process, an input check or the like is executed for switches such as the 1-BET switch 34S, the 2-BET switch 35S, the 3-BET switch 36S, and the spin switch 46S.

Then, the main CPU 71 executes a symbol random determination process (S73). In this symbol random determination process, three to-be-stopped symbols (on the first reel 101, the second reel 102, and the third reel 103) to be rearranged in the middle stage of the display window 150 (on the payline) are randomly determined based on the probabilities defined in the Zone B mode symbol random determination table (see FIG. 12).

When the code number “5” is selected at the random determination probability of 10/60 for the first reel 101, “BLANK” corresponding to the code number “5” of the first reel 101 is selected as a to-be-stopped symbol to be rearranged in the middle stage of the display window 150 (on the payline) When the code number “4” is selected at the random determination probability of 10/60 for the second reel 102, “RED7” corresponding to the code number “4” of the second reel 102 is selected as a to-be-stopped symbol to be rearranged in the middle stage of the display window 150 (on the PAY LINE). When the code number “5” is selected at the random determination probability of 10/60 for the third reel 103, “BLANK” corresponding to the code number “5” of the third reel 103 is selected as a to-be-stopped symbol to be rearranged in the middle stage of the display window 150 (on the PAY LINE).

The main CPU 71 stores the determined to-be-stopped symbols on the reels 101 to 103 in a symbol storing area in the RAM 73.

Subsequently, the main CPU 71 executes an effect contents determination process (S74). The main CPU 71 extracts an effect-use random number and randomly selects one of a plurality of predetermined effect contents.

Then, the main CPU 71 executes a symbol display control process (S75). In this symbol display control process, as shown in FIG. 22, the scroll of the reels 101 to 103 starts, and after a predetermined time elapses, the to-be-stopped symbols corresponding to the reels 101 to 103 selected in the symbol random determination process in S73 stop one by one in the middle stage of the display window 150 (on the PAY LINE). That is, nine symbols including the to-be-stopped symbols are displayed in the display window 150 (in the upper stage, the middle stage, and the lower stage). For example, when the to-be-stopped symbol on the first reel 101 is “RED7”, the to-be-stopped symbol on the second reel 102 is “BLANK”, and the to-be-stopped symbol on the third reel 103 is “BLANK”, “RED7”, “BLANK”, and “BLANK” are rearranged in the middle stage of the display window 150 (on the payline) as shown in FIG. 22.

The main CPU 71 then executes a payout amount determination process (S76). In this process, payout is determined based on a symbol combination displayed on the payline with reference to the symbol combination table (see FIG. 9) stored in the RAM 73 and the value (1BET, 2BET, or 3BET) of the bet counter, and the payout is stored in the payout amount storage area provided in the RAM 73.

When the value of the bet counter is “3” (MAXBET) and the symbol combination displayed on the payline is three “RED7”, progressive payout is awarded.

Then a payout process is executed (S77). The main CPU 71 adds the value stored in the payout amount storage area to the value of the credit counter in the RAM 73.

Then, the main CPU 71 determines whether three “RED7” symbols are aligned in a reverse V-shape, in relation to the nine symbols rearranged in the display window 150 (S78). To be more specific, as shown in FIG. 22, “RED7” of the first reel 101 is rearranged in the upper stage, “RED7” of the second reel 102 is rearranged in the middle stage, and “RED7” of the third reel 103 is rearranged in the upper stage. Then, whether or not three “RED7” symbols are aligned in a V-shape is determined. Then, the main CPU 71 ends this process, if it determines that the three “RED7” symbols are not aligned in a reverse V-shape (S78: NO).

In cases where the three “RED7” symbols do not form a V-shape (S78: No), the main CPU 71 may randomly determine whether to continue the game in the Zone B mode (high-probability mode), or to perform falling (i.e., make a transition from the Zone B mode game (high-probability mode) to the normal mode game). If the game in the Zone B mode is to be continued as the result of the random determination, the process returns to S71. If the falling is to occur as the result of the random determination, the Zone B mode is ended.

On the other hand, if it is determined that the three “RED7” symbols form a V-shape (S78: Yes), the main CPU 71 makes a transition to the later described Zone C mode (S79). Then, the present routine ends.

(Zone C Mode Process)

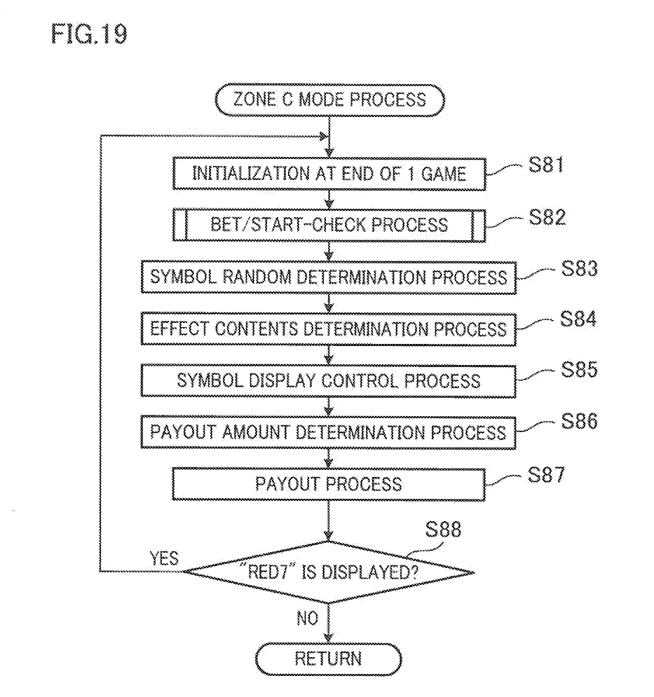

Next, the Zone C mode process will be described with reference to FIG. 19. In the Zone C mode process, C game (high-probability mode) is executed in the Zone C mode.

To begin with, the main CPU 71 executes an initializing process at the end of each play of the game, in order to start the Zone C mode game (S81). This process clears data in a working area of the RAM 73, which becomes unnecessary at the end of each play of the game, e.g., the bet amount, symbols randomly determined, and the like.

The main CPU 71 then executes the above-described bet/start-check process (S82). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S83). In this symbol random determination process, three to-be-stopped symbols (on the first reel 101, the second reel 102, and the third reel 103) to be rearranged in the middle stage of the display window 150 (on the payline) are randomly determined based on the probabilities defined in the Zone C mode symbol random determination table (see FIG. 13).

When the code number “4” is selected at the random determination probability of 10/60 for the first reel 101, “RED7” corresponding to the code number “4” of the first reel 101 is selected as a to-be-stopped symbol to be rearranged in the middle stage of the display window 150 (on the payline) When the code number “4” is selected at the random determination probability of 10/60 for the second reel 102, “RED7” corresponding to the code number “4” of the second reel 102 is selected as a to-be-stopped symbol to be rearranged in the middle stage of the display window 150 (on the PAY LINE). When the code number “4” is selected at the random determination probability of 10/60 for the third reel 103, “RED7” corresponding to the code number “4” of the third reel 103 is selected as a to-be-stopped symbol to be rearranged in the middle stage of the display window 150 (on the PAY LINE).

The main CPU 71 stores the determined to-be-stopped symbols on the reels 101 to 103 in a symbol storing area in the RAM 73.

Subsequently, the main CPU 71 executes an effect contents determination process (S84). The main CPU 71 extracts an effect-use random number and randomly selects one of a plurality of predetermined effect contents.

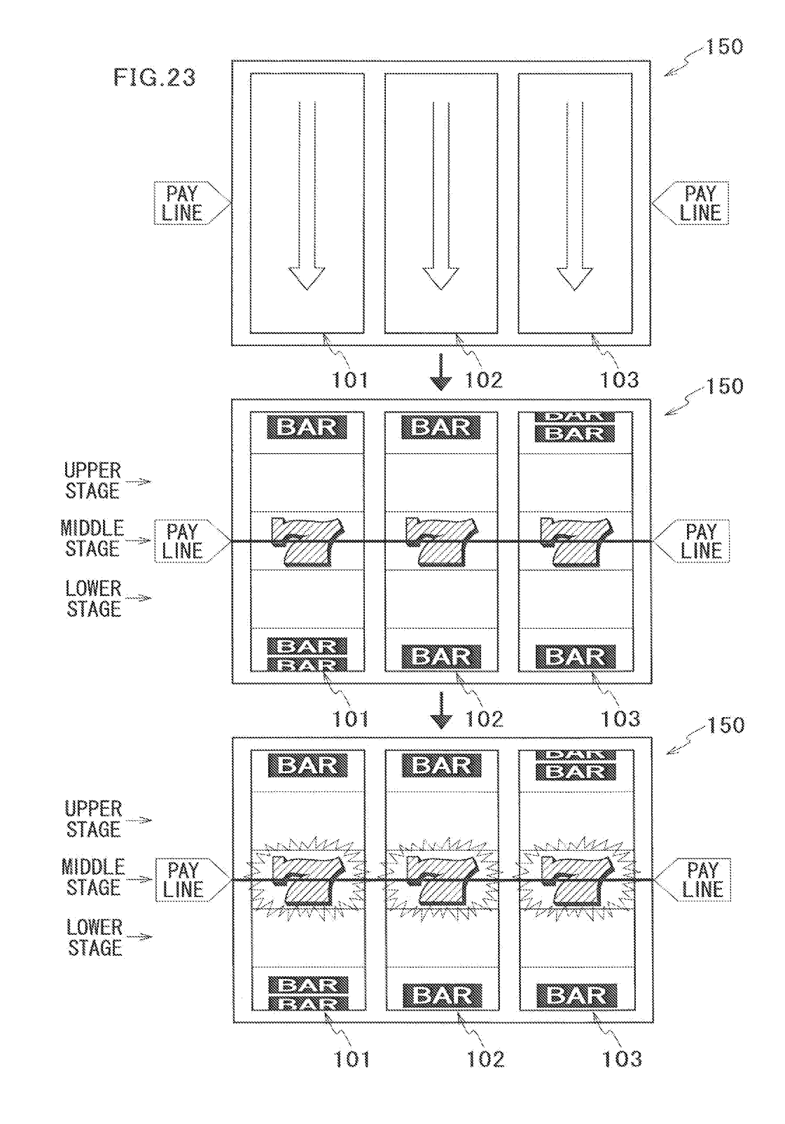

Then, the main CPU 71 executes a symbol display control process (S85). In this symbol display control process, as shown in FIG. 23, the scroll of the reels 101 to 103 starts, and after a predetermined time elapses, the to-be-stopped symbols corresponding to the reels 101 to 103 selected in the symbol random determination process in S83 stop one by one in the middle stage of the display window 150 (on the PAY LINE). That is, nine symbols including the to-be-stopped symbols are displayed in the display window 150 (in the upper stage, the middle stage, and the lower stage). For example, when the to-be-stopped symbol on the first reel 101 is “RED7”, the to-be-stopped symbol on the second reel 102 is “RED7”, and the to-be-stopped symbol on the third reel 103 is “RED7”, “RED7”, “RED7”, and “RED7” are rearranged in the middle stage of the display window 150 (on the payline) as shown in FIG. 23.

Then, the main CPU 71 executes a payout amount determination process (S86). In this process, payout is determined based on a symbol combination displayed on the payline with reference to the symbol combination table (see FIG. 9) stored in the RAM 73 and the value (1BET, 2BET, or 3BET) of the bet counter, and the payout is stored in the payout amount storage area provided in the RAM 73.

When the value of the bet counter is “3” (MAXBET) and the symbol combination displayed on the payline is three “RED7”, progressive payout is awarded.

Then a payout process is executed (S87). The main CPU 71 adds the value stored in the payout amount storage area to the value of the credit counter in the RAM 73.

Then, the main CPU 71 determines whether or not at least one “RED7” symbol is displayed, in relation to the nine symbols rearranged in the display window 150 (S88). Specifically, the main CPU 71 determines whether or not at least one “RED7” symbol is included in the nine symbols rearranged in the display window 150. Then, the main CPU 71 proceeds to S81, if it determines that at least one “RED7” symbol is displayed (S88: Yes).

On the other hand, the main CPU 71 ends this process, if it determines that no “RED7” symbol is displayed (S88: NO).

With the structure, stepping up occurs, to a game with a higher probability of the predetermined symbol (“RED7”) being rearranged on the display window 150 (transitions of normal game-->Zone A-->Zone B-->Zone C), every time the specific combination of symbols are rearranged (e.g., three “RED7” symbols being aligned in an upper right direction; three “RED7” symbols forming a reverse V-shape; three “RED7” symbols forming a V-shape). Thus, the probability of the predetermined symbol (“RED7”) being rearranged on the display window 150 increases as the game progresses, which relieves the monotony of the game.

In the above structure, in the symbol random determination process in ZONE C, which is executed after the step-up in the order of the normal game-->Zone A-->Zone B-->Zone C, the probability of a combination of the predetermined symbol (“RED7”) being rearranged is the highest. Therefore, a combination of the predetermined symbol (“RED7”) is most easily established. This relieves the monotony of the game.

Further, in the above structure, if a combination of the symbols rearranged on the display window 150 is a specific combination (e.g., three “RED7” symbols being aligned in an upper right direction; three “RED7” symbols forming a reverse V-shape), it is possible to raise the probability of the predetermined symbol (“RED7”) being rearranged in a predetermined display area of the display window 150, such as the upper stage, the middle stage, or the lower stage, in the subsequent game.

### Another Embodiment 1: P15-0258

The descriptions below may use the same reference numerals as in the embodiment above, but the embodiment below will describe arrangements different from those in the embodiment above.

As a typical gaming machine, a slot machine is arranged such that, as a player presses a button on a control panel, reels on which symbols are provided are scrolled and then stopped, with the result that the symbols are rearranged on a display device. In such a slot machine, a benefit such as a payout is awarded to a player based on a combination of rearranged symbols.

In some cases, such a slot machine has a random determination table which specifies for each reel the probability of each symbol being rearranged (see the publication of Japanese Laid-Open Patent Application, Tokukai 2013-153875). For example, there is a slot machine with three reels, which uses, for a first reel, a first reel random determination table whereby an A symbol is rearranged at a probability of 1/10 and a B symbol is rearranged at a probability of 1/5; uses, for a second reel, a second reel random determination table whereby the A symbol is rearranged at a probability of 1/22 and the B symbol is rearranged at a probability of 1/4; and uses, for a third reel, a third reel random determination table whereby the A symbol is rearranged at a probability of 1/40 and the B symbol is rearranged at a probability of 1/3.

In this slot machine in general, a combination involving a specific symbol, which yields a great benefit, is set to hardly occur. Therefore, there is a case in which the specific symbol is hardly displayed, and the game becomes monotonous.

An object of the present invention is to provide a gaming machine which makes it possible to relieve the monotony of the game.

An aspect of the present invention is a gaming machine, comprising: a display device configured to display symbols by rearranging reels on which symbols are arrayed; a storage device configured to store rearrangement symbol combination table in which combinations of symbols are associated with winning probabilities, respectively, the combination of symbols being formed by symbols displayed on the display device, by rearranging all the reels; and

a controller configured to execute the processes of:

(1A) at start of game play, randomly determining a combination of symbols to be displayed on the display device based on the rearrangement symbol combination table; and
(1D) displaying the combination of the symbols determined in the process (1A) on the display device by rearranging the reels.

In the above structure, combinations of symbols to be displayed on the display device are associated with winning probabilities, respectively. Therefore, by directly setting the winning probabilities of the combinations of symbols, it is possible to delicately adjust which combination of symbols is to be displayed more frequently, and which combination of symbols is to be displayed less. This relieves the monotony of the game.

Further, another aspect of the present invention is a gaming machine, comprising: a display device configured to display symbols by rearranging reels on which symbols are arrayed;

a storage device configured to store a rearrangement symbol combination table in which combinations of symbols to be displayed on the display device by rearranging the reels are associated with winning probabilities, respectively, the combinations of symbols including a combination of symbols which leads to a winning awarding a predetermined benefit and a combination of symbols lacking one symbol needed to form the combination of symbols leading to the winning; and

a controller configured to execute the processes of:

(2A) at start of game play, randomly determining a combination of symbols to be displayed on the display device based on the rearrangement symbol combination table;
(2B) displaying the combination of the symbols determined in the process (2A) on the display device by rearranging the reels; and
(2C) in cases where the combination of symbols rearranged on the display device is the combination of symbols leading to the winning, awarding a benefit corresponding to the winning.

In the above structure, combinations of symbols to be displayed on the display device are associated with winning probabilities, respectively. Therefore, by directly setting the winning probabilities of the combinations of symbols, it is possible to delicately adjust which combination of symbols is to be displayed more frequently such as the combination of symbols leading to the winning, and which combination of symbols is to be displayed less such as the combination of symbols lacking one symbol needed to form the combination of symbols leading to the winning. This relieves the monotony of the game.

In the present invention, the above-described gaming machine is arranged such that, the rearrangement symbol combination table is set so that the winning probability corresponding to the combination of symbols lacking one symbol needed to form the combination of symbols leading to the winning is higher than the winning probability corresponding to the combination of symbols leading to the winning.

The above structure provides more opportunities of having the symbol leading to the winning being rearranged on the display device. This relieves the monotony of the game, by inducing players' expectation for rearrangement of the combination of symbols leading to the winning, in the subsequent game.

Further, another aspect of the present invention is a gaming machine, comprising: a display device configured to display one or more arrangement patterns of symbols each formed by rearranging symbols arrayed on reels, in a matrix of display areas;

a storage device configured to store a rearrangement symbol combination table in which the arrangement patterns each formed by rearranging symbols in the matrix of display areas are associated with winning probabilities, respectively; and

a controller configured to execute the processes of:

(3A) at start of game play, randomly determining an arrangement pattern to be displayed in the matrix of display areas, based on the rearrangement symbol combination table; and
(3B) displaying the arrangement pattern determined in the process (3A) in the matrix of display areas, by rearranging symbols arrayed on the reels.

In the above structure, the arrangement patterns which could be displayed in the matrix of display areas are associated with winning probabilities, respectively. Therefore, by directly setting the winning probabilities of the arrangement patterns, it is possible to delicately adjust which arrangement pattern is to be more frequently displayed in the matrix of display areas, and which arrangement pattern is to be displayed less in the matrix of display areas. This relieves the monotony of the game.

A gaming machine which makes it possible to avoid monotonous game play is provided.

(Outline of Present Invention)

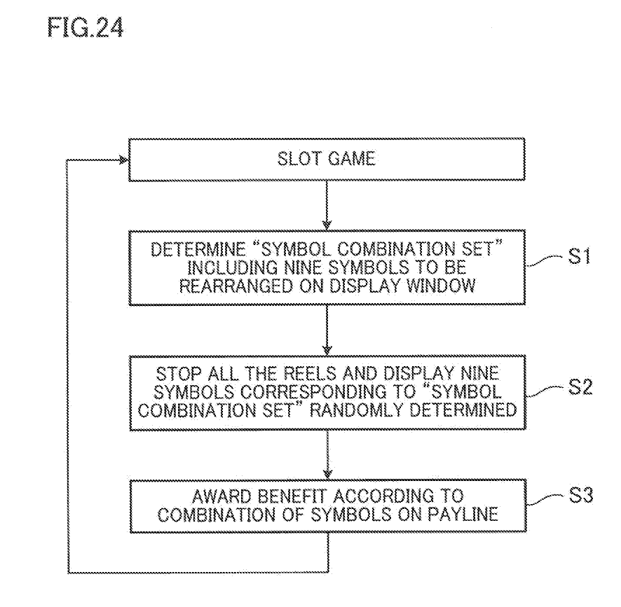

The following will describe an embodiment of the present invention with reference to the drawings. FIG. 24 shows the outline of a game flow of a slot machine according to the embodiment of the present invention. As shown in FIG. 24, the slot machine of the embodiment of the present invention executes a slot game.

The slot games are of a line type (Left to Right). The slot games employ mechanical reels on which symbols are arrayed. There are three reels used. That is to say, the reels are formed of a first reel, a second reel, and a third reel. Furthermore, a single pay line is set.

In the slot game of the present embodiment, there are “symbol combination sets” each set including nine symbols rearranged on the display window. A symbol random determination process is performed to randomly determine a “symbol combination set” to be displayed on the display window, based on a rearrangement symbol combination table in which the “symbol combination sets” are associated with “probabilities”, respectively (S1). Nine symbols corresponding to the “symbol combination set” determined are rearranged on the display window, by rotating and stopping three reels (S2). Then, a process of awarding a benefit according to the combination of symbols rearranged on the payline is performed (S3).

### Definition

The slot game in the present embodiment is run by the slot machines 1, in the present embodiment. The slot game is a game of rearranging symbols. The rearrangement of symbols in the slot game is carried out by a mechanical reel unit (equivalent to a display device). In the slot game, on condition that a gaming value is bet, symbols are rearranged in the display window by the mechanical reel unit, and a payout is awarded according to the rearranged symbols. In addition to the above, it is possible to run, for example, a free game which does not require betting of a gaming value, a high-probability mode (game) in which a predetermined symbol occurs at a higher probability than the normal game, a mini game different from the normal game, and a game in which a predetermined condition is more probable to be established as compared to the normal game.

The symbols collectively mean “FIRE7”, “RED7”, “3BAR”, “2BAR”, “1BAR”, and “BLANK”.

The gaming value is electrically valuable information such as electronic money and the like. It is to be noted that the gaming value in the present invention is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Function Flow)

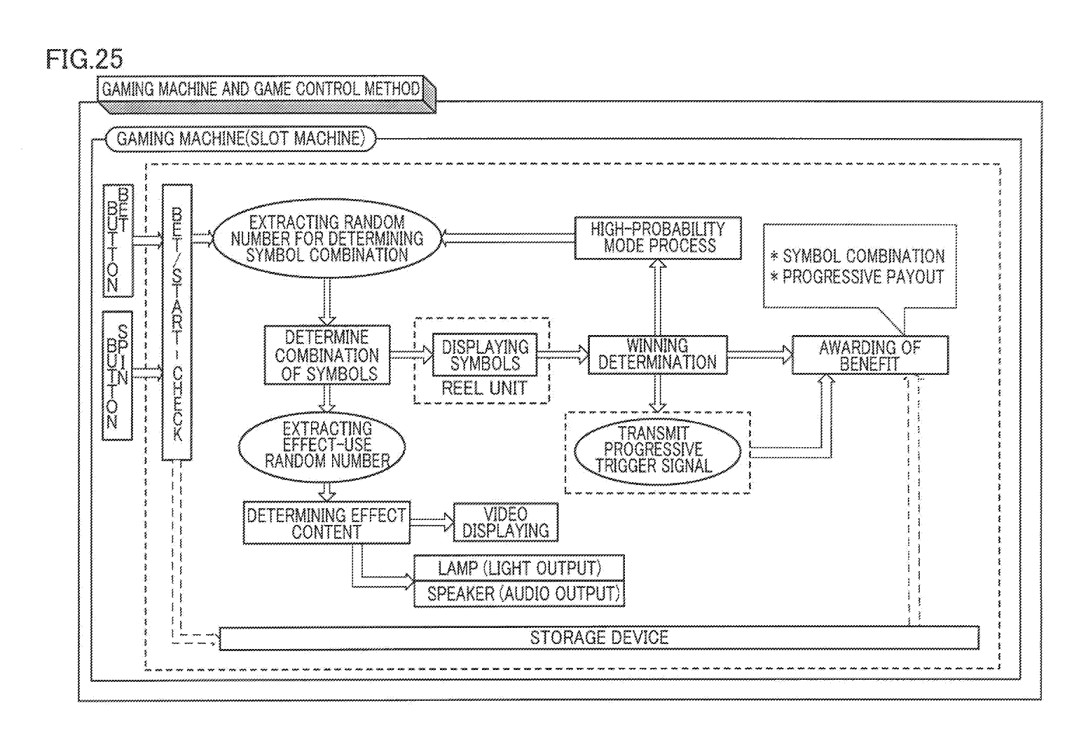

The following describes basic functions of the slot machine related to the embodiment of the present invention, with reference to FIG. 25. FIG. 25 shows the functional flow of the slot machine of the embodiment of the present invention.

<Bet/Start-Check>

First, the slot machine checks whether or not a BET button has been pressed by a player, and subsequently checks whether or not a spin button has been pressed by the player.

<Symbol Determination>

Next, when the spin button is pressed by the player, the slot machine extracts a random number for determining a symbol combination, with reference to the rearrangement symbol combination table, and determines a combination of nine symbols to be displayed (rearranged) for the player at the time of stopping the scroll of the reel.

<Reel Control>

Thereafter, the slot machine starts the rotation of each reel and stops the rotation of each reel so that the determined nine symbols are displayed for the player (symbol display).

<Winning Determination>

Subsequently, as the rotation of each reel is stopped, the slot machine determines whether the combination of the symbols displayed for the player is a combination related to winning.

(High-Probability Mode Process)

When a predetermined condition is satisfied in winning determination, the slot machine is transmitted from the normal mode to the high-probability mode. The high-probability mode uses a symbol random determination table with a higher probability of having the predetermined symbol being rearranged, as compared to the symbol random determination table used in the normal mode.

<Awarding Benefit>

When the combination of the symbols displayed for the player is a combination related to winning, the slot machine offers, to the player, benefit according to the type of the combination. For example, when a combination of symbols related to awarding of a credit is displayed, the slot machine awards credits to the player, the amount of which corresponds to the combination of the symbols.

In addition to the above, the slot machine may accumulatively add a part of a bet amount to progressive payout stored in the storage device, each time the unit game is executed. When progressive payout is employed, the slot machine awards the progressive payout accumulatively stored in the storage device to the player, when a progressive trigger condition is established. The progressive (jackpot) is a function of accumulating at least one of coins betted by a player at a slot machine (or slot machines) in the progressive payout and awarding the accumulated progressive payout to a slot machine in which a progressive trigger is established. When the progressive payout is accumulated by plural slot machines, an amount (accumulative amount) accumulated to the progressive payout is calculated and transmitted to an external controller each time the game is executed. The external controller adds the accumulative amount sent from each slot machine to the progressive payout.

The slot machine may have other benefits such as a mystery bonus and insurance. In the mystery bonus, a predetermined number of coins are paid out when a win is achieved in dedicated random determination. When a spin button is pressed, the slot machine samples a random number for the mystery bonus, and whether a mystery bonus trigger is established is randomly determined.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine extracts an effect-use random number and determines the contents of the effect based on randomly determined symbols or the like.

(Overall Structure of Game System)

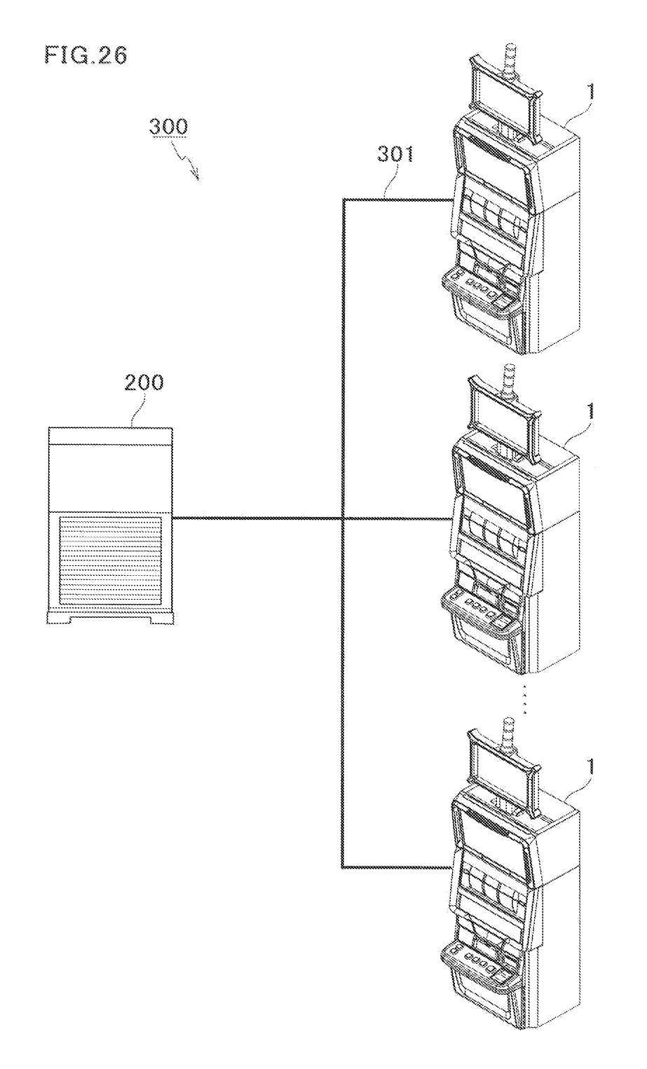

This concludes the description for the basic functions of the slot machine. Now, referring to FIG. 26, a game system including the slot machines will be described. FIG. 26 shows the game system including the slot machines of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

It is to be noted that the game system 300 may be constructed within a single gaming facility where various games can be performed, such as a casino, or may be constructed among a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

(Overall Structure of Slot Machine)

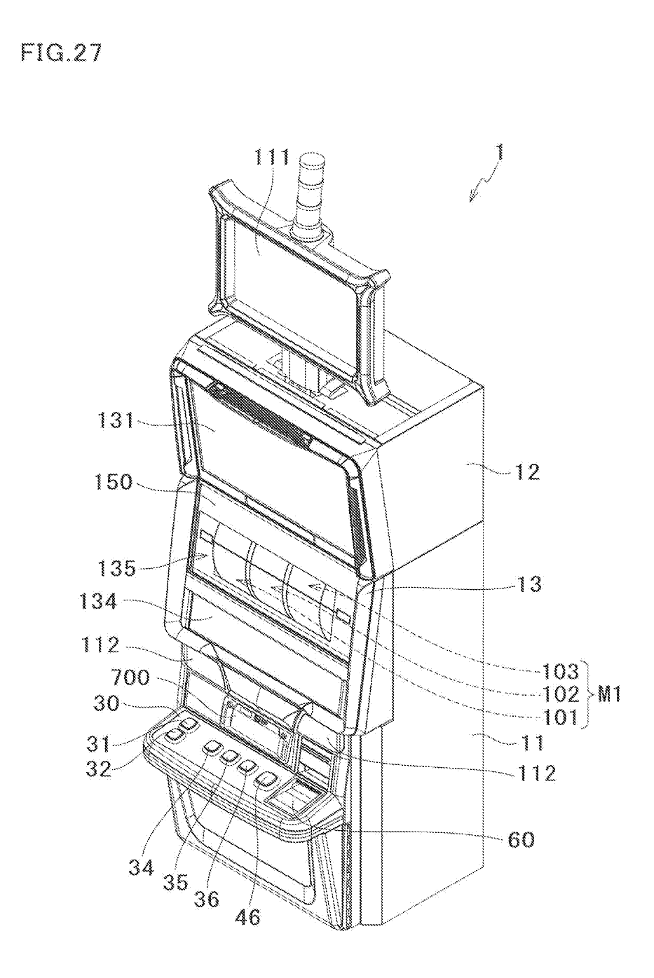

Now, referring to FIG. 27, the overall structure of the slot machine 1 will be described. FIG. 27 shows the overall structure of the slot machine of the embodiment of the present invention.

Electrically valuable information such as electronic money is used as a gaming value in the slot machine 1. It is to be noted that the gaming value is not limited to this, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

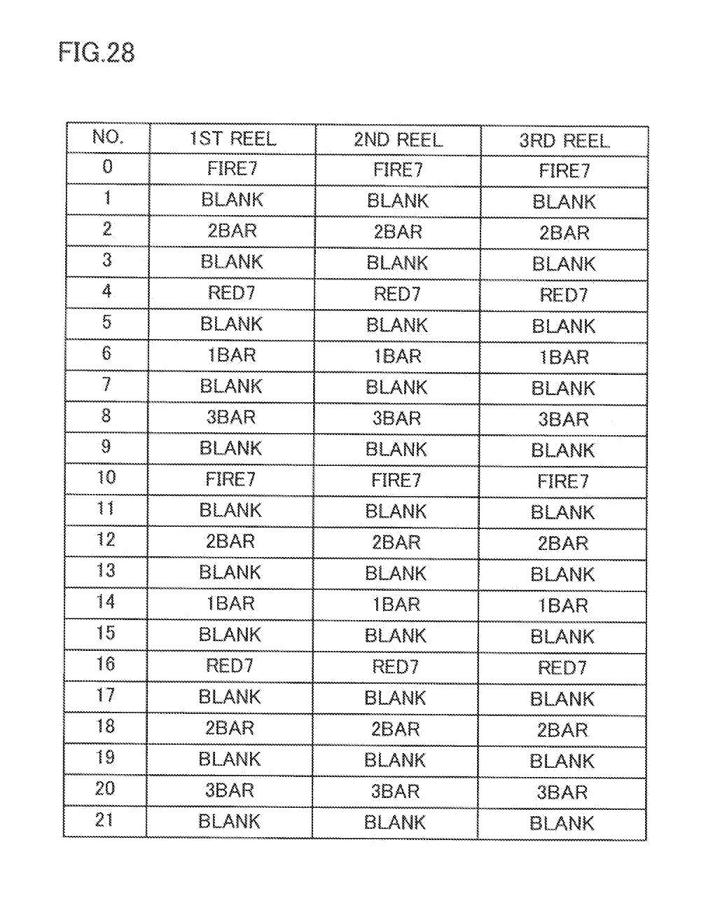

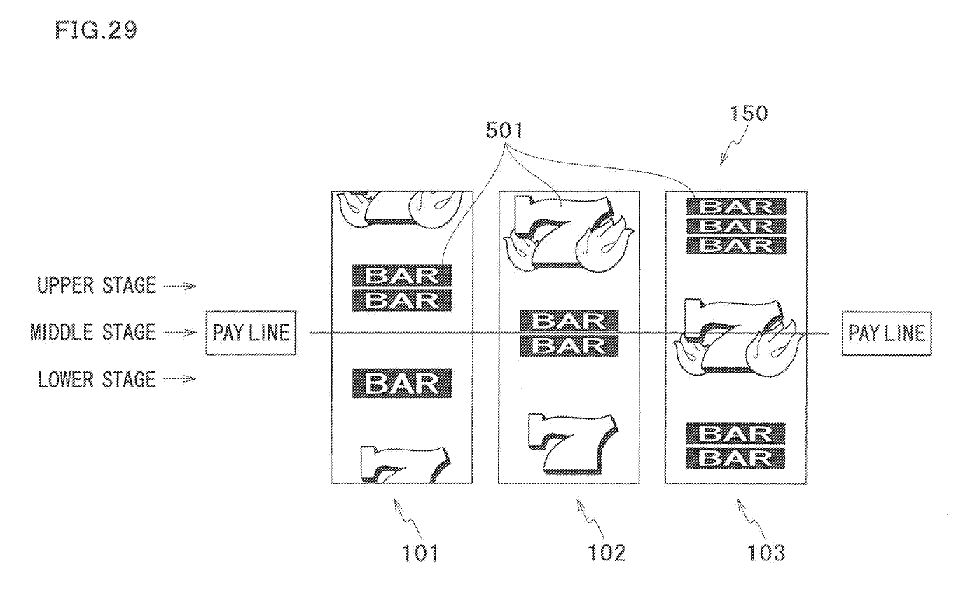

The main door 13 is provided with a reel unit M1 (corresponding to a symbol display device) constituted by three reels 101, 102, and 103. A reel cover 135 is provided in front of the reel device M1. On the front surface of the reel cover 135, a liquid crystal display device 134 by which a gaming status is reported to the player and a transparent panel are provided. This liquid crystal display device 134 is provided with a touch panel 137. The reel cover 135 has the display window 150 (corresponding to the display device 150, and also to a matrix of display areas) at its central portion. In the display window 150, one symbol 501 is provided in each of the upper stage, the middle stage, and the lower stage of each of the reels 101, 102, and 103 (see FIG. 29). To put it differently, nine symbols 501 forming a three-by-three matrix are visibly displayed in the display window 150. On the outer circumferential surface of each of the reels 101, 102, and 103, 22 symbols are depicted (see FIG. 28). These 22 symbols 501 are lined up along the rotational direction of the reels 101, 102, and 103 to form a symbol array. Each of the symbol arrays is a combination of “FIRE7”, “RED7”, “3BAR”, “2BAR”, “1BAR”, and “BLANK”. To the main door 13 is provided a speaker 112.

As shown in FIG. 29, a payline for result determination of symbols 501 rearranged in the display window 150 is set in the slot machine 1. In the present embodiment, one payline is formed at the middle stage of the display window 150 as shown in FIG. 29. Alternatively, plural paylines may be provided and each payline may be activated upon selection by a player.

As shown in FIG. 29, the reel unit M1 rearranges the symbols 501 on the display window 150 by drivingly rotating the reels 101, 102, and 103 each having the symbols 501 on the outer circumferential surface. In the descriptions below, the reels may be referred to as a first reel 101, a second reel 102, and a third reel 103 from the left end in front elevation.

On the inner circumferential side of each of the reels 101, 102, and 103 arranged as above, a backlight unit (not illustrated) is provided. The backlight unit emits illumination light from the inner circumferential side of the reels 101, 102, and 103 to the outer circumferential surface of the reels and is arranged so that the illumination light passing through the outer circumferential surface of the reels is seen from the outside of the display window 150. The backlight unit is configured to be able to change the amount of illumination light in multiple stages. The degree of freedom in the effects using illumination light is therefore high. Furthermore, each backlight unit is able to emit light in multiple colors, and to illuminate the symbols individually with the illumination light.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

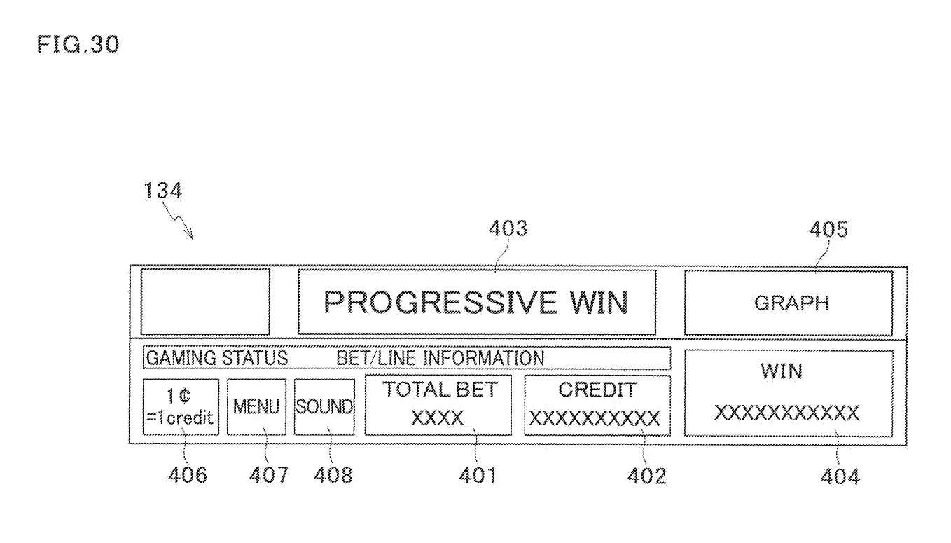

As shown in FIG. 30, on the liquid crystal display device 134 is displayed meters indicating the conditions of the game. For example, a total bet meter 401 displays “Total Bets”. The numerical value is re-calculated at every game play. The credit meter 402 indicates the total credit amount at the time. The default value is 0. The numerical value is increased or decreased according to the gaming value input, the bet, and the game result. A game message area 403 indicates a message explaining the current gaming status. The win meter 404 indicates the total credit amount of the payout having been won.

The liquid crystal display device 134 is provided with a graph touch area 405, a denomination indicator 406, a menu touch area 407, and a sound volume switching touch area 408. When touched by the player, the touch area 405 displays, in the form of graphs, the change in the obtained payout amount, the total number of game plays, and the total obtained credit amount, on the upper image display panel 131. As the graph touch area 405 is touched, three types of graph images, i.e., line-graph, bar-graph, and block-graph are displayed in order. The denomination indicator 406 displays current denomination. When the menu touch area 407 is touched by the player, the upper image display panel 131 displays the first page of the HELP screen. The sound volume switching touch area 408 is used for switching the game sound volume in three stages. Each time the sound volume switching touch area 408 is touched by the player, the game sound volume is switched such that, for example, from low to middle to high to small to middle.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the reel unit M1 are provided a control panel 30 having various buttons, a PTS device 700, and a bill entry 60.

The bill entry 60 validate bills and receives genuine bills into the cabinet 11. The bill entry 60 is electrically connected to the PTS device 700, and when a legitimate bill is received, transmits to the PTS device 700 an input signal based on the value of the bill. The input signal represents information of credit data and the like related to the bill received.

The PTS device 700 is a unit in which an LCD (liquid crystal display), a human detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Control Panel 30)

On the control panel 30, a HELP button 31 and a CASHOUT button 32 are arranged in the left side area, a 1-BET button 34, a 2-BET button 35, and a 3-BET button 36 are arranged in the middle area, and a spin button 46 is arranged in the lower stage on the left side area.

The HELP button 31 is pressed when, for example, it is unclear how to play a game. As the HELP button 31 is pressed, various help information is displayed on the upper image display panel 131. The CASHOUT button 32 is an operation button used when checking out credits reserved in the slot machine 1 is discharged.

Each time the 1-BET button 34 is pressed, one of the credits currently owned by the player is betted. The 2-bet button 35 is used to start a game with two bets. The 3-bet button 36 is used to start a game with three bets. A gaming value corresponding to one bet can be optionally changed by setting the denomination.

The spin button 46 is used to start the rotation of the reels 101, 102, and 103.

(Symbol Array)

Now, with reference to FIG. 28, the arrays of the symbols 501 on the first reel 101, the second reel 102, and the third reel 103 of the slot machine 1 will be described.

A symbol table shown in FIG. 28 shows arrays of the symbols 501 displayed on the outer circumferential surfaces of the first reel 101, the second reel 102, and the third reel 103. To each of the first reel 101, the second reel 102, and the third reel 103 is assigned a symbol array including 22 symbols 501 respectively corresponding to code numbers 0 to 21.

As shown in FIG. 28, the types of the symbols include “FIRE7”, “RED7”, “3BAR”, “2BAR”, “1BAR”, and “BLANK”.

[Structures of Circuits Provided to Slot Machine]

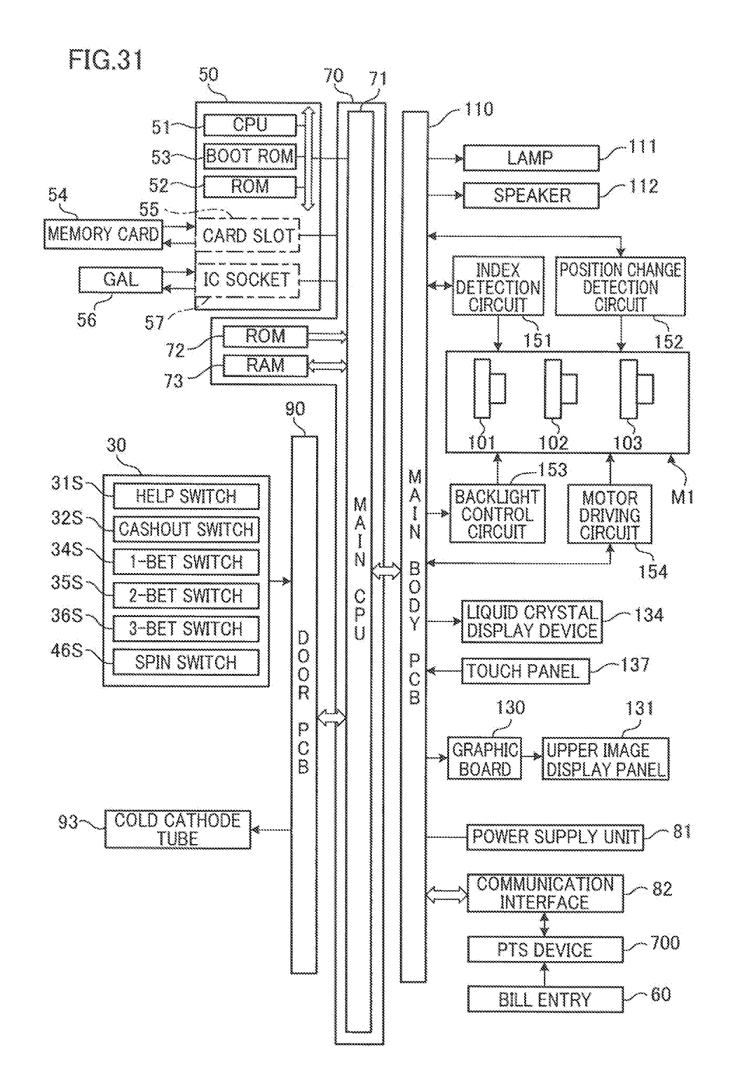

Now, referring to FIG. 31, the configuration of a circuit in the slot machine 1 will be described. FIG. 31 is a block diagram showing an internal structure of the slot machine of the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (programmable logic device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to a storage device.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the main CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations when these programs are executed. Examples of the areas include: an area that stores counter which manages the number of game play, a bet amount, the credit amount, a payout value of each progressive payout, and the like; and an area that stores symbols (code numbers) randomly determined.

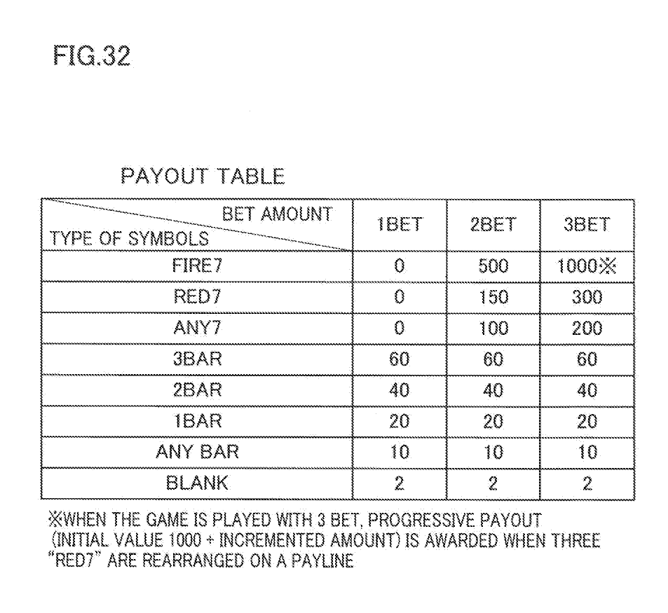

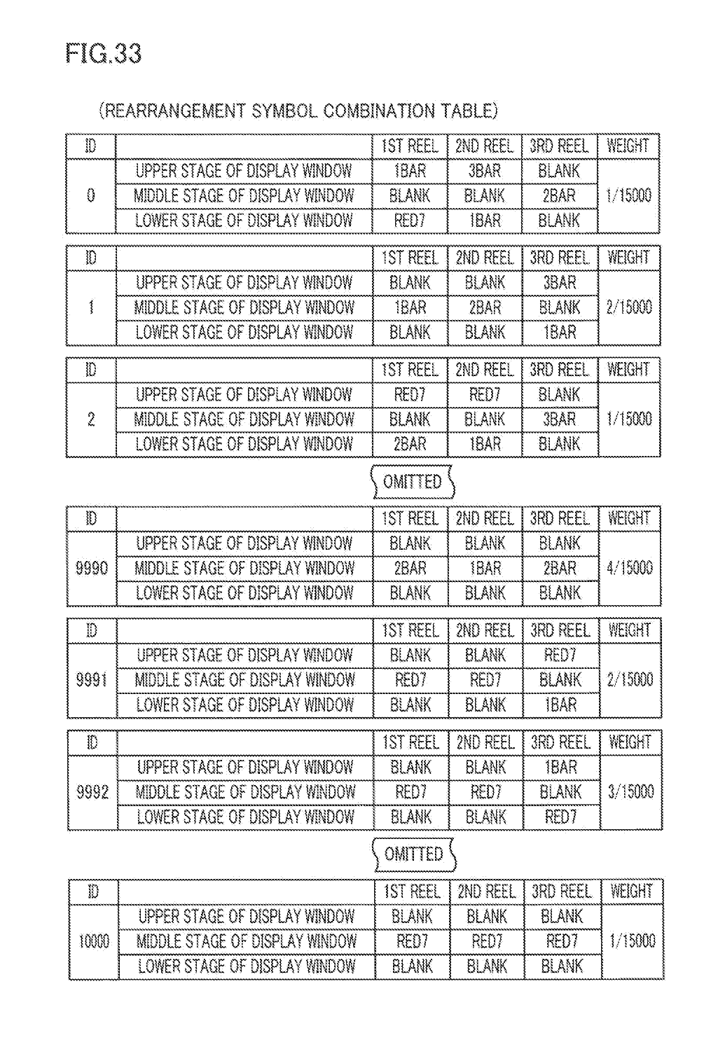

Further, the RAM 73 stores various tables such as the payout table (see FIG. 32) and the rearrangement symbol combination table (see FIG. 33).

The communication interface 82 is for communicating with the PTS device 700 and the external controller 200. The PTS device 700, upon reception of an input signal from the bill entry 60, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a HELP switch 31S, a CASHOUT switch 32S, a 1-BET switch 34S, a 2-BET switch 35S, a 3-BET switch 36S, and a spin switch 46S, correspondingly to the above-described buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The body PCB 110 is connected with a lamp 111, a speaker 112, a graphic board 130, the liquid crystal display device 134, a touch panel 137, an index detection circuit 151, a position change detection circuit 152, a backlight control circuit 153, and a motor driving circuit 154. The index detection circuit 151, the position change detection circuit 152, a backlight control circuit 153, and a motor driving circuit 154 are connected with the reel unit M1.

The lamp 111 turns on based on a control signal outputted from the main CPU 71. The speaker 112 outputs BGM sound or the like in accordance with a control signal output from the main CPU 71.

The graphic board 130 controls displaying of images on the upper image display panel 131 based on a control signal output from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 134 displays an image based on a control signal output from the main CPU 71. The touch panel 137 detects a position on the liquid crystal display device 134 touched by a finger or the like of the player, and outputs a signal corresponding to the detected position to the main CPU 71.

The motor driving circuit 154 is connected to a stepper motor configured to rotate the reels 101, 102, and 103. Further, the motor driving circuit 154 includes an FPGA (Field Programmable Gate Array) and a driver. The FPGA is an electronic circuit such as a programmable LSI, and functions as a control circuit of the stepper motor. The driver functions as an amplifying circuit for pulses to be input to the stepping motor.

The index detection circuit 151 detects the positions of the rotating reels 101, 102, and 103 and is able to detect the step out of the reels 101, 102, and 103.

The position change detection circuit 152 is configured to detect a change in the stop position of the reels 101, 102, and 103 after the rotation of the reels 101, 102, and 103 is stopped. The position change detection circuit 152 detects a change in the stop positions of the reels 101, 102, and 103 when, for example, a stop position is changed to achieve a winning combination of the symbols 501 by an illicit way when no winning combination of the symbols 501 is achieved. The position change detection circuit 152 is configured to detect a change in the stop position of the reels 101, 102, and 103, for example, by detecting not-shown fins (not illustrated) which is arranged on the inner sides of the reels 101, 102, and 103 at predetermined intervals.

It should be noted that the method of exciting the stepping motor is not particularly limited, and 1-2 phase excitation system or a 2 phase excitation system are adoptable. Further, a DC motor may be adopted in place of the stepping motor. In cases of adopting a DC motor, the main body PCB 110 is connected to an error counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the deviation counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumferential surfaces of the reels 101, 102, and 103 are able to individually illuminate 9 symbols 501 having stopped on the display window 150 by means of the backlight control circuit 153.

(Payout Table)

Now, the payout table will be described with reference to FIG. 32. FIG. 32 shows a payout table in the slot machine of the embodiment of the present invention.

The payout table defines payouts for bet amounts and symbol combinations achieving winning (WIN). In the slot machine 1, the rotational scroll of the reels 101, 102, and 103 is stopped, and when a combination of three symbols displayed (rearranged) on a payline corresponds to a symbol combination defined in the payout table, winning is achieved. In accordance with the type of winning, a benefit will be given to the player in the form of awarding payout and the like. It is noted that a winning is not established (i.e. the game is lost) when the combination of symbols displayed (rearranged) on the payline does not match with any of the combinations of symbols specified by the payout table.

Basically, winning is achieved when three symbols of the following types are displayed on a payline: “FIRE7”, “RED7”, “3BAR”, “2BAR”, “1BAR”, and “BLANK”. Furthermore, winning is achieved as “ANY7” when a symbol combination including “FIRE7” and “RED7” is established. Winning as “ANYBAR” is also achieved when a symbol combination including “3BAR”, “2BAR”, and “1BAR” is established. When the game is played with one bet, no payout is awarded for “FIRE7”, “RED7”, and “ANY7”. When the game is played with three bets, progressive payout (initial value 1000+incremented amount) is awarded when three “FIRE7” are rearranged on a payline.

(Rearrangement Symbol Combination Table)

Now, the rearrangement symbol combination table will be described with reference to FIG. 33. In the present embodiment, the rearrangement symbol combination table is a random determination table referred to in the later-described main control process (normal mode).

The rearrangement symbol combination table contains 10001 “symbol combination sets”, each of which is constituted by nine symbols displayed (rearranged) on the display window 150, when the first reel 101, the second reel 102, and the third reel 103 stop scrolling. To these 10001 “symbol combination sets” are associated ID numbers ranging from “0” to “10000” and 10001 probabilities (WEIGHTS). The probabilities (WEIGHTS) are each the value of probability the corresponding one of the “symbol combination set” being selected randomly (i.e., the corresponding nine symbols being displayed on the display window 150) out of the 10001 “symbol combination sets”. For example, in the rearrangement symbol combination table shown in FIG. 33, a “symbol combination set” of ID number “0” with “1BAR”, “3BAR”, and “BLANK” in the upper stage of the display window 150, “BLANK”, “BLANK”, and “2BAR” in the middle stage of the display window 150, and “RED7”, “1BAR”, and “BLANK” in the lower stage of the display window 150 is selected with a probability of 1/15000. Further, a “symbol combination set” of ID number “10000” with “BLANK”, “BLANK”, and “BLANK” in the upper stage of the display window 150, “RED7”, “RED7”, and “RED7” in the middle stage of the display window 150, and “BLANK”, “BLANK”, and “BLANK” in the lower stage of the display window 150 is selected with a probability of 1/15000. It should be noted that the “symbol combination set” also corresponds to an arrangement pattern.

For example, in the “symbol combination set” of ID number “10000” of the present embodiment, the “RED7”, “RED7”, “RED7” are displayed in the middle stage of the display window 150. As such, a combination of “RED7”, “RED7”, “RED7” is rearranged on the payline, which leads to a winning whereby a predetermined benefit is to be awarded. Further, for example, in a “symbol combination set” of ID number “9992”, “RED7”, “RED7”, “BLANK” are displayed in the middle stage of the display window 150. The combination of “RED7”, “RED7”, “BLANK” on the payline is in a state (no tenpai) of lacking one “RED7” needed to achieve the combination of “RED7”, “RED7”, “RED7” leading to a winning.

In a slot game in the high-probability mode which is a mode that occurs after transition from the normal mode (normal game), only four ID numbers “9990”, “9991”, “9992”, and “10000” out of the above rearrangement symbol combination table are used. Therefore, each of the four ID numbers is selected with a probability of 1/4, in the high-probability mode. For example, in the high-probability mode, a “symbol combination set” of ID number “9992” (no tenpai for “RED7” winning) with “BLANK”, “BLANK”, and “1BAR” in the upper stage of the display window 150, “RED7”, “RED7”, and “BLANK” in the middle stage of the display window 150, and “BLANK”, “BLANK”, and “RED7” in the lower stage of the display window 150 is selected with a probability of 1/4. Similarly, in the high-probability mode, the ID number “10000” with “RED7”, “RED7”, “RED7” in the middle stage on the display window 150 (i.e., “RED7” winning) is also selected with a probability of 1/4. Thus, in the high-probability mode, by limiting the range of the ID numbers of the rearrangement symbol combination table used in the normal mode (limiting to four sets from 10001 sets in the normal mode), the winning of “RED7” is established with a higher probability. In other words, the probability “RED7” winning is made higher in the high-probability mode, while using the same rearrangement symbol combination table as the one used in the normal mode.

In the above structure, the “symbol combination sets” each constituted of nine symbols to be displayed (rearranged) on the display window 150 are associated with winning probabilities, respectively. Therefore, by an administrator of the slot machine 1 (encompassing the designer, and the like) directly setting the probabilities of the “symbol combination sets” each constituted of nine symbols, it is possible to delicately adjust which “symbol combination set” is to be displayed on the display window 150 more frequently, e.g., a “symbol combination set” leading to a winning, and which “symbol combination set” is to be displayed less frequently on the display window 150, e.g., a “symbol combination set” of no tenpai. This relieves the monotony of the game.

Further, the rearrangement symbol combination table is set so that the probabilities (WEIGHTS) corresponding to “symbol combination sets” leading to no tenpai such as those with ID numbers “9991” and “9992” are higher than the probability (WEIGHT) corresponding to a “symbol combination set” leading to a winning such as one with ID number “10000”.

This increases, for example, the chances of the winning-leading “RED7” symbol rearranged on the display window 150, and relieves the monotony of the game, by inducing players' expectation for the “RED7” winning, in the subsequent game.

(Falling Table)

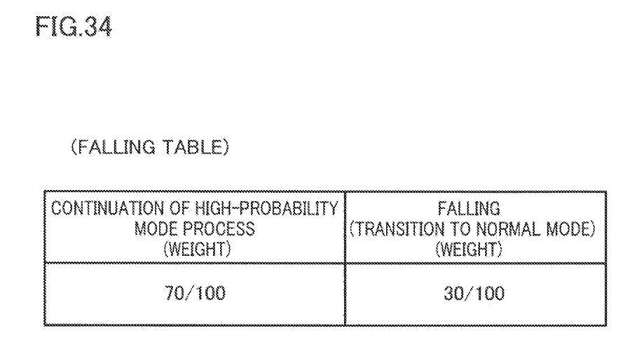

Now, the falling table will be described with reference to FIG. 34. The falling table is referred to in a later-described falling random determination process in the high-probability mode process.

In the falling table, as shown in FIG. 34, a probability (WEIGHT) of maintenance of the high-probability mode and a probability of falling, i.e., making transition from the high-probability mode to the normal mode are defined. To be more specific, in the table, the probability (WEIGHT) of maintenance of the high-probability mode is 70/100 (70%) whereas the probability of falling (making transition from the high-probability mode to the normal mode) is 30/100 (30%).

(Contents of Program)

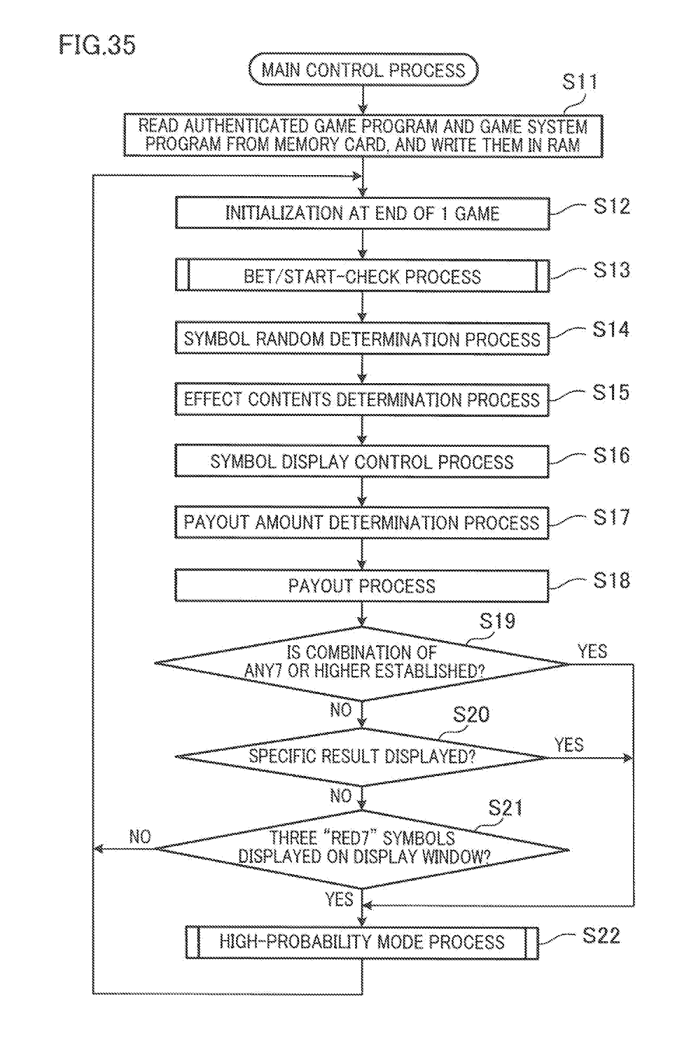

Now, the program to be executed by the slot machine 1 is described with reference to FIG. 35 to FIG. 37.

(Main Control Process)

Referring to FIG. 35, a main control process will be described. In the main control process, a slot game is run in the normal mode.

First, when the slot machine 1 is powered on, the main CPU 71 reads an authenticated game program and a game system program from a memory card 54 via a gaming board 50, and then write them in the RAM 73 (S11).

Subsequently, the main CPU 71 executes an initializing process at the end of each play of the game, in order to start the slot game (S12). This process clears data in a working area of the RAM 73, which becomes unnecessary at the end of each play of the slot games (normal mode), e.g., the bet amount, symbols randomly determined, and the like.

The main CPU 71 then executes a later-described bet/start-check process (S13). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S14). In this symbol random determination process, a “symbol combination set” constituted of nine symbols to be displayed (rearranged) on the display window 150 is randomly determined based on the probabilities (WEIGHTS) specified in the rearrangement symbol combination table (see FIG. 33). It should be noted that, in the “symbol combination set”, to-be-stopped symbols for the middle stages of the display window 150 are determined in relation to the first reel 101, the second reel 102, and the third reel 103.

For example, when the ID number “9991” is selected with a random determination probability of 3/15000 based on the probabilities (WEIGHTS) in the rearrangement symbol combination table (FIG. 33), “RED7” (Code: “16”), “RED7” (Code: “16”), and “BLANK” (Code: “17”) out of the nine symbols to be displayed in the middle stage on the display window 150 are determined as the to-be-stopped symbols for the first reel 101, the second reel 102, and the third reel 103.

Then, the main CPU 71 stores the to-be-stopped symbols determined for the first reel 101, the second reel 102, the third reel 103 in a symbol storing area provided in the RAM 73.

Subsequently, the main CPU 71 executes an effect contents determination process (S15). The main CPU 71 extracts an effect-use random number and randomly selects one of a plurality of predetermined effect contents.

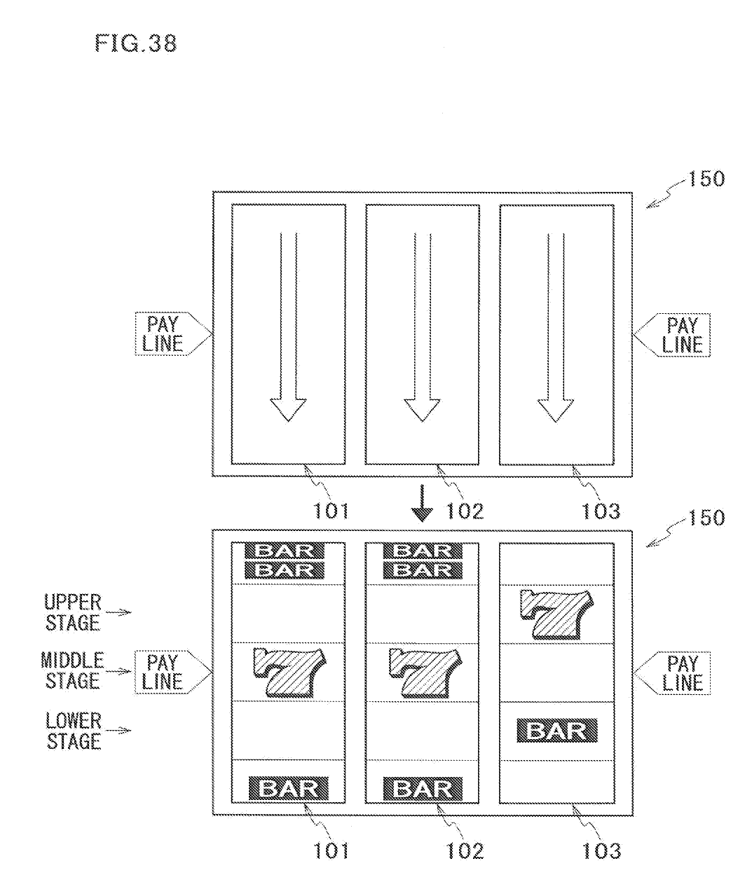

Then, the main CPU 71 executes a symbol display control process (S16). As shown in FIG. 38, in this symbol display control process, scrolling of the first reel 101, the second reel 102, and the third reel 103 is started, and after a predetermined period of time, a to-be-stopped symbol determined in the symbol random determination process of S14, in relation to the first reel 101 is rearranged in the middle stage (payline) of the display window 150. Next, a to-be-stopped symbol determined in the symbol random determination process of S14, in relation to the second reel 102 is rearranged in the middle stage (payline) of the display window 150. Further, a to-be-stopped symbol determined in the symbol random determination process of S14, in relation to the third reel 103 is rearranged in the middle stage (payline) of the display window 150. As described, the to-be-stopped symbols corresponding to the first reel 101 to the third reel 103 are successively stopped in the middle stage (payline) on the display window 150. In other words, nine symbols related to the “symbol combination set” determined in the symbol random determination process are rearranged on the display window 150 (in the upper stage, the middle stage, and the lower stage). For example, in cases where “RED7” (Code: “16”), “RED7” (Code: “16”), and “BLANK” (Code: “17”) are determined as the to-be-stopped symbols for the first reel 101, the second reel 102, and the third reel 103, “BLANK”, “BLANK”, and “RED7” are rearranged in the upper stage of the display window 150, “FIRE7”, “FIRE7”, and “BLANK” are rearranged in the middle stage of the display window 150, and “BLANK”, “BLANK”, and “1BAR” are rearranged in the lower stage of the display window 150, as shown in FIG. 38.

The main CPU 71 then executes a payout amount determination process (S17). In this process, payout is determined based on a symbol combination displayed on the payline with reference to the payout table (see FIG. 32) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “3BAR”, “60” credits are determined as the payout with reference to the payout table of FIG. 32 and stored in the payout amount storage area in the RAM 73.

When the value of the bet counter is “3” (MAXBET) and the symbol combination displayed on the payline is three “FIRE7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 1000 in each game play. When the progressive payout is won, the value on the progressive payout counter is stored in the payout amount storage area of the RAM 73. Furthermore, when the progressive payout is won, a message which notifies that the progressive payout has been awarded is displayed. To be more specific, messages “CONGRATULATIONS!”, “PROGRESSIVE WIN”, and “XXXXXXXX CREDITS” are displayed on the upper image display panel 131.

Then a payout process is executed (S18). The main CPU 71 adds the value stored in the payout amount storage area to the value of the credit counter in the RAM 73.

Next, the main CPU 71 determines if the combination of the to-be-stopped symbols determined in the symbol random determination process is a combination of “ANY7”, a combination of “RED7”, or a combination of “FIRE7” (see FIG. 32: symbol combinations equal to or higher than ANY7) (S19). When the symbol combination is a combination of “ANY7”, a combination of “RED7”, or a combination of “FIRE7” (S19: YES), the routine proceeds to the later-described high-probability mode process. That is to say, when the symbols rearranged in the display window 150 include a combination of “ANY7”, a combination of “RED7”, or a combination of “FIRE7”, the mode of the slot game is switched from the normal mode to the high-probability mode.

In the meanwhile, when the symbol combination is none of a combination of “ANY7”, a combination of “RED7”, or a combination of “FIRE7” (S19: NO), the main CPU 71 determines if the symbol combination displayed in the display window 150 corresponds to a specific suit (specific symbol combination), i.e., if a winning of “3BAR” of the present embodiment is established (S20). Then, when the symbol combination displayed on the display window 150 is the specific suit (S20: YES), the high-probability mode process is executed (S22).

On the other hand, if the symbol combination displayed on the display window 150 is not the specific suit (S20: No), the main CPU 71 determines if three “RED7” symbols or three “FIRE7” symbols are displayed (S21). If neither three “RED7” symbols nor three “FIRE7” symbols are displayed on the display window 150 (S21: No), the process proceeds to S12.

If three “RED7” symbols or three “FIRE7” symbols are displayed on the display window 150 (S21: Yes), the high-probability mode process is executed (S22). Then, after the high-probability mode process, the routine proceeds to S12.

In the above structure, the “symbol combination sets” each constituted of nine symbols to be displayed (rearranged) on the display window 150 are associated with winning probabilities, respectively. Therefore, by an administrator of the slot machine 1 (encompassing the designer, and the like) directly setting the probabilities of the “symbol combination sets” each constituted of nine symbols, it is possible to delicately adjust which “symbol combination set” is to be displayed on the display window 150 more frequently, e.g., a “symbol combination set” leading to a winning, and which “symbol combination set” is to be displayed less frequently on the display window 150, e.g., a “symbol combination set” of no tenpai. This relieves the monotony of the game.

(Bet/Start-Check Process)

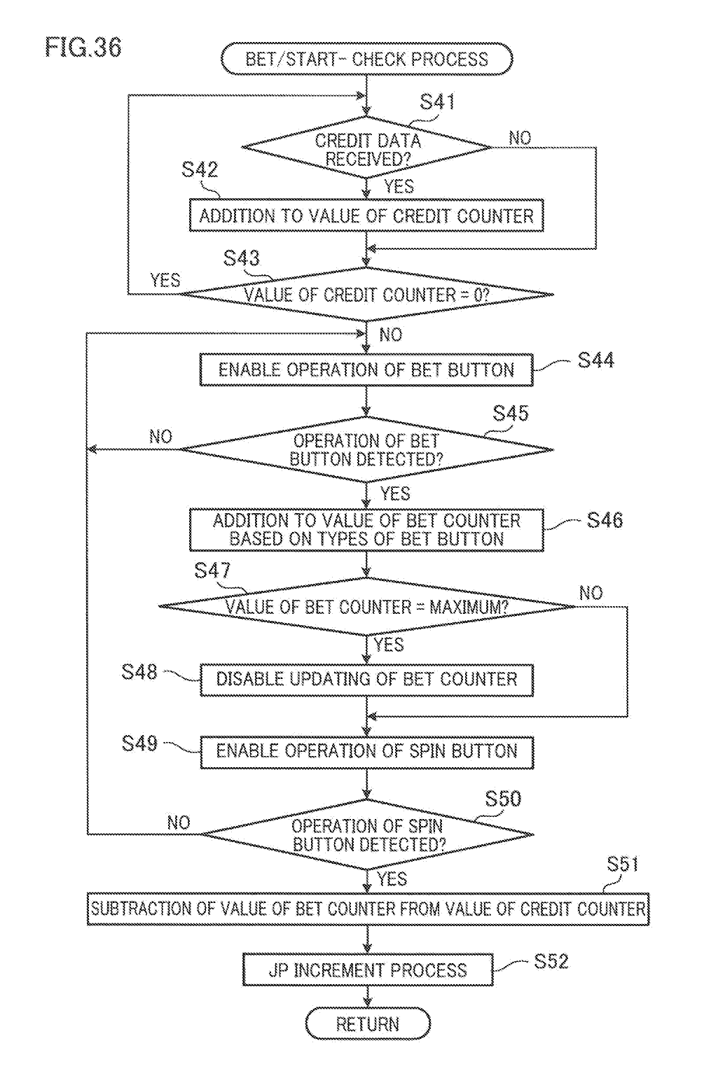

Now the bet/start-check process will be described with reference to FIG. 36.

To begin with, the main CPU 71 determines whether credit data has been received from the PTS device 700 (S41). The credit data is sent from the PTS device 700 to the main CPU 71, for example, when the IC card is inserted into the card insertion slot and when the bill entry 60 receives a genuine bill.

When the credit data is received (S41: YES), the main CPU 71 adds the amount indicated by the received credit data to the value of the credit counter (S42).

After the step S42 or when determining in S41 that no credit data is received (S41: NO), the main CPU 71 determines whether or not the value stored in the credit counter is 0 (S43). When determining that the value of the credit counter is 0 (S43: YES), the main CPU 71 goes back to S41.

When the main CPU 71 determines that the value of the credit counter is not 0 (S43: NO), the main CPU 71 permits operation acceptance of the BET buttons (1-BET button 34, 2-BET button 35, and 3-BET button 36) (S44).

Then the main CPU 71 determines whether an operation of the BET button is detected (S45). When an operation of the bet button by a player is detected by the bet switch (1-BET switch 34S, 2-BET switch 35S, or 3-BET switch 36S), the main CPU 71 performs addition to the value of the bet counter in the RAM 73, based on the type of the BET button (S46).

Subsequently, the main CPU 71 determines whether the value of the bet counter is at the maximum (S47). When determining that the value of the bet counter is at the maximum (S47: YES), the main CPU 71 prohibits the update of the value of the bet counter (S48). After S48, when determining in S47 that the value of the bet counter is not at the maximum (S47: NO), the main CPU 71 enables operation of the spin button 46 (S49).

After S49, the main CPU 71 determines whether an operation of the spin button 46 is detected (S50). When the main CPU 71 determines that an operation of the spin button 46 is not detected (S50: NO), the routine proceeds to S41.

In the meanwhile, when the main CPU 71 determines that operation of the spin button 46 is detected (S50: YES), the main CPU 71 subtracts the value of the bet counter calculated in S46 from the value of the credit counter (S51).

The main CPU 71 then executes a JP increment process (S52). In the JP increment process, as the resource of the progressive payout, the value of the progressive payout counter in the RAM 73 is incremented by a value calculated by multiplying the value of the bet counter calculated in S46 by an increment rate (0.01 but may be optionally set) set in the present embodiment. For example, when the value of the bet counter calculated in S46 is “3”, 3×0.01=0.03 credit is added to the value of the progressive payout counter. In the present embodiment, the initial value of the progressive payout counter is 1000 credits. Therefore, in the progressive payout counter, a value calculated by multiplying the value of the bet counter by the increment rate (0.01) is accumulatively added to the initial value of 1000 in each game play.

Then the bet/start-check process is terminated.

(High-Probability Mode Process)

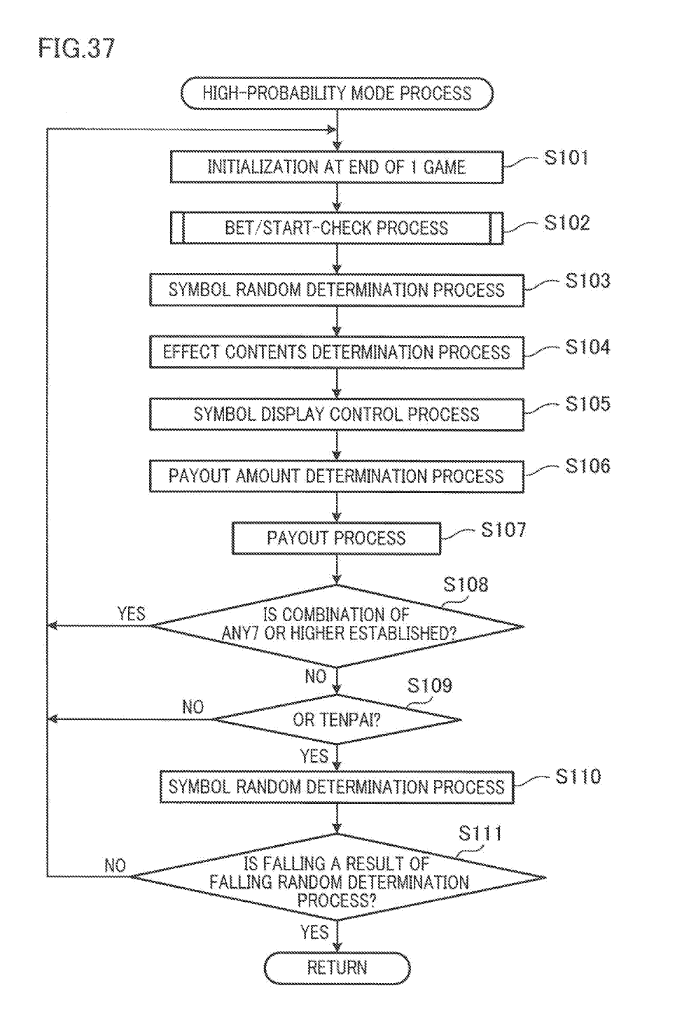

Now, the high-probability mode process will be described with reference to FIG. 37. The high-probability mode process is executed in S22 of the main control process. In the high-probability mode process, a slot game is executed in the high-probability mode.

First, the main CPU 71 executes an initializing process at the end of each play of the game, in order to start the slot game in the high-probability mode (S101). This process clears data in a working area of the RAM 73, which becomes unnecessary at the end of each play of the slot game in the high-probability mode, e.g., the bet amount, symbols randomly determined, and the like.

The main CPU 71 then executes the above-described bet/start-check process (S102). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S103). In this symbol random determination process, a single ID number is randomly selected out of four ID numbers “9990”, “9991”, “9992”, and “10000” out of the above rearrangement symbol combination table (see FIG. 33) are used. It should be noted that each of the four ID numbers is selected with a probability of 1/4.

For example, when the ID number “9991” is selected with a random determination probability of 1/4, “RED7” (Code: “16”), “RED7” (Code: “16”), and “BLANK” (Code: “17”) to be displayed in the middle stage of the display window 150 are selected out of the nine symbols to be displayed on the display window 150, as the to-be-stopped symbols for the first reel 101, the second reel 102, and the third reel 103. Further, when the ID number “10000” is selected with a random determination probability of 1/4, “RED7” (Code: “16”), “RED7” (Code: “16”), and “RED7” (Code: “16”) to be displayed in the middle stage of the display window 150 are selected out of the nine symbols to be displayed on the display window 150, as the to-be-stopped symbols for the first reel 101, the second reel 102, and the third reel 103.

Thus, in the high-probability mode, by limiting the range of the ID numbers of the rearrangement symbol combination table used in the normal mode (limiting to four sets from 10001 sets in the normal mode), the winning of “RED7” is established with a higher probability. In other words, the probability “RED7” winning is made higher in the high-probability mode, while using the same rearrangement symbol combination table as the one used in the normal mode.

The main CPU 71 stores the determined to-be-stopped symbols on the reels 101 to 103 in a symbol storing area in the RAM 73.

Subsequently, the main CPU 71 executes an effect contents determination process (S104). The main CPU 71 extracts an effect-use random number and randomly selects one of a plurality of predetermined effect contents.

Then, the main CPU 71 executes a symbol display control process (S105). In this symbol display control process, the scroll of the reels 101 to 103 starts, and after a predetermined time elapses, the to-be-stopped symbols corresponding to the reels 101 to 103 selected in the symbol random determination process in S103 stop one by one in the middle stage of the display window 150 (on the payline). That is, nine symbols including the to-be-stopped symbols are displayed in the display window 150. For example, when the to-be-stopped symbol on the first reel 101 is “RED7”, the to-be-stopped symbol on the second reel 102 is “RED7”, and the to-be-stopped symbol on the third reel 103 is “BLANK”, “RED7”, “RED7”, and “BLANK” are rearranged in the middle stage of the display window 150 (on the payline).

Then, the main CPU 71 executes a payout amount determination process (S106). In this process, payout is determined based on a symbol combination displayed on the payline with reference to the payout table (see FIG. 32) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “RED7”, “300” credits are determined as the payout with reference to the payout table and stored in the payout amount storage area in the RAM 73.

When the value of the bet counter is “3” (MAXBET) and the symbol combination displayed on the payline is three “FIRE7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 1000 in each game play. When the progressive payout is won, the value on the progressive payout counter is stored in the payout amount storage area of the RAM 73. Furthermore, when the progressive payout is won, a message which notifies that the progressive payout has been awarded is displayed. To be more specific, messages “CONGRATULATIONS!”, “PROGRESSIVE WIN”, and “XXXXXXXX CREDITS” are displayed on the upper image display panel 131.

Then a payout process is executed (S107). The main CPU 71 adds the value stored in the payout amount storage area to the value of the credit counter in the RAM 73.

Next, the main CPU 71 determines if the combination of the to-be-stopped symbols determined in the symbol random determination process is a combination of “ANY7”, a combination of “RED7”, or a combination of “FIRE7” (see FIG. 32: symbol combinations equal to or higher than ANY7) (S108).

When the symbol combination is a combination of “ANY7”, a combination of “RED7”, or a combination of “FIRE7” (S108: YES), the high-probability mode is maintained and the routine proceeds to S101.

In the meanwhile, when the symbol combination is not a combination of “ANY7”, a combination of “RED7”, or a combination of “FIRE7” (S108: NO), the main CPU 71 determines if the combination of the to-be-stopped symbols determined in the symbol random determination process is tenpai (a state in which a combination of symbols is one short of a predetermined symbol combination) of a combination of “ANY7”, a combination of “RED7”, or a combination of “FIRE7” (S109). When the symbol combination is not tenpai (S109: NO), the routine proceeds to S101.

In the meanwhile, when the symbol combination is tenpai (S109: YES), the main CPU 71 executes the falling random determination process (S110). In the falling random determination process, whether to maintain the high-probability mode or execute falling (making transition from the high-probability mode to the normal mode) is randomly determined based on the falling table (see FIG. 34). To be more specific, as shown in FIG. 34, as a result of random determination, the high-probability mode is maintained at the probability of 70/100 (70%) or falling (making transition from the high-probability mode to the normal mode) is performed at the probability of 30/100 (30%).

Then whether falling is performed as a result of the falling random determination process in S110 is determined (S111). When the falling is not performed and the high-probability mode is maintained (S111: NO), the high-probability mode is maintained and the routine proceeds to S101.

When the falling is performed (S111: YES), the process ends. In other words, there is transition from the high-probability mode to the normal mode.

### Another Embodiment 2: P15-0259

The descriptions below may use the same reference numerals as in the embodiment above, but the embodiment below will describe arrangements different from those in the embodiment above.

As a typical gaming machine, a slot machine is arranged such that, as a player presses a button on a control panel, reels on which symbols are provided are scrolled and then stopped, with the result that the symbols are rearranged. In such a slot machine, a benefit such as a payout is awarded to a player based on a combination of rearranged symbols.

The above described slot machine, in some cases, awards a free game as a bonus game, when a symbol combination satisfies a predetermined condition (establishment of bonus game trigger) (Publication of Japanese Laid-Open Patent Application Tokukai 2014-221107). In the free game, a slot game is run without a special bet required, and a benefit such as a payout is awarded according to the combination of symbols.

In the slot machine in general, the bonus game trigger is established with a uniform probability, and the payout awarded in the free game is also uniform, which could lead to the monotony of the game.

An object of the present invention is to provide a gaming machine which makes it possible to avoid monotonous game play.

An aspect of the present invention is a gaming machine, comprising: a storage device configured to store

a first random determination table specifying a probability of making a transition from a normal game to a bonus game,

a second random determination table specifying a higher probability of making a transition from the normal game to the bonus game, as compared to the first random determination table, and
a characteristic table specifying a first expectation value for a payout awarded in cases where the transition to the bonus game occurs based on the first random determination table and a second expectation value for a payout awarded in cases where the transition to the bonus game occurs based on the second random determination table, the second expectation value being lower than the first expectation value;

a controller configured to execute the processes of:

(1A) when a predetermined condition is satisfied, switching a currently referenced random determination table to another random determination table;
(1B) running a normal game, and determining whether to make a transition from the normal game to the bonus game, based on the random determination table active as the result of (1A);
(1C) if the transition from the normal game to the bonus game is determined as to occur in (1B), running the bonus game, and awarding a payout to be awarded for a result of the bonus game, based on an expectation value specified in the characteristic table.

In the above structure, it is possible to change the probability of making the transition from the normal game to the bonus game, and change the expectation value for the payout awarded for the result of the bonus game, when the predetermined condition is satisfied. Since the probability of making the transition to the bonus game and the expectation value for the payout awarded for the result of the bonus game are associated with each other in the characteristic table, the probability of making a transition from the normal game to the bonus game and the expectation value are set in association with each other. This way, when the predetermined condition is satisfied, it is possible to change the entire balance of payout for the normal game and the bonus game, thereby relieving the monotony of the game.

While the first random determination table is referred to, the transition from the normal game to the bonus game hardly occurs. However, when the transition to the bonus game occurs, a high bonus game payout is awarded based on a high expectation value for the payout. If the predetermined condition is satisfied, and the random determination table is switched to the second random determination table, the transition from the normal game to the bonus game more easily occurs; however, when the transition to the bonus game occurs, a low bonus game payout is awarded based on the low expectation value for the payout. Thus, when the random determination table is switched, it gives a player an impression as if the player is given a higher chance for transition from the normal game to the bonus game, and for winning a high bonus game payout, consequently relieving the monotony of the game.

In the present invention, the above-described gaming machine is arranged such that the predetermined condition in the process (1A) is the time.

In the above structure, it is possible to change the probability of making the transition from the normal game to the bonus game, and change the expectation value for the payout awarded for the result of the bonus game, at a predetermined time. Thus, for example, it is possible to switch from a state where transition from the normal game to the bonus game hardly occurs, but when it does, a high bonus game payout is awarded based on a high expectation value for the payout to a state where the transition from the normal game to the bonus game easily occurs, but when it does, a lower bonus game payout is awarded based on a lower expectation value for the payout, or other way around, based on the time. Therefore, for example, the probability of transition from the normal game to the bonus game and the expectation value for the payout awarded for the result of the bonus game may be set to be changed at the late night or the early morning, where there are not too many players. This attract the attention of the player, and increases the opportunity for the player to participate the game.

In the present invention, the above-described gaming machine is arranged such that the predetermined condition in the process (1A) is the result of the normal game being a predetermined result.

In the above structure, it is possible to change the probability of making the transition from the normal game to the bonus game, and change the expectation value for the payout awarded for the result of the bonus game, when the result of the normal game is a predetermined result. Thus, for example, it is possible to switch from a state where transition from the normal game to the bonus game hardly occurs, but when it does, a high bonus game payout is awarded based on a high expectation value for the payout to a state where the transition from the normal game to the bonus game easily occurs, but when it does, a lower bonus game payout is awarded based on a lower expectation value for the payout, or other way around, when the result of the normal game is a predetermined result. Therefore, for example, the probability of transition from the result to the bonus game and the expectation value for the payout awarded for the result of the bonus game may be set to be changed when the normal game results in the predetermined result. This attract the attention of the player, and induces the player to continue or start participating the game.

A gaming machine which makes it possible to avoid monotonous game play is provided.

(Outline of Present Invention)

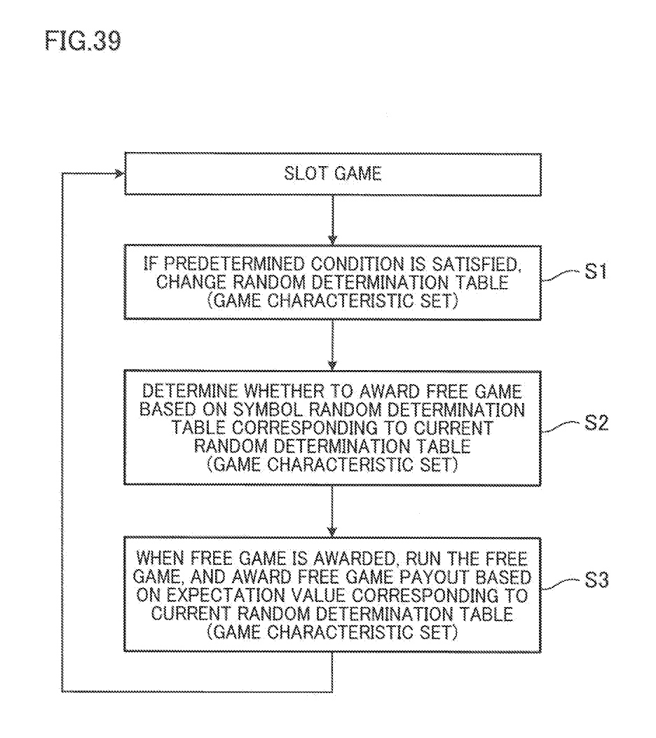

The following will describe an embodiment of the present invention with reference to the drawings. FIG. 39 shows the outline of a game flow of a slot machine according to the embodiment of the present invention. As shown in FIG. 39, the slot machine of the embodiment of the present invention runs a slot game as the normal game, and a free game (a slot game similar to the normal game) as the bonus game which is run as the result of transition from the normal game.

The slot games are of a line type (Left to Right). The slot games employ mechanical reels. The reels are formed of three reels. That is to say, the reels are formed of a first reel, a second reel, and a third reel. Furthermore, a single pay line is set.

The slot game of the present invention uses symbol random determination tables (corresponding to the random determination tables) specifying the probabilities of making a transition from the normal game to the free game and game characteristic sets (characteristic tables) in which expectation values (multiplying factors) are associated with payouts awarded for results of the bonus game. When a predetermined condition is satisfied, a game characteristic set currently referred to is switched to another game characteristic set (S1).

Then, the normal game is run, and whether to make a transition from the normal game to the free game is randomly determined based on the transition probability (symbol random determination table) of the game characteristic set made active as the result of the switching over (S2). Then, when the transition from the normal game to the free game is determined as to occur, the free game is run and a free game payout is awarded based on the expectation value of the current game characteristic set (S3).

### Definition

The present embodiment deals with a case where the slot machine 1 is the gaming machine; however, the present invention is not limited to this, and is applicable to any given device configured to independently run any type of normal games and another game which develops from the normal game (i.e., a game which is more advantageous for players than the normal game).

The normal game in the present embodiment is run by the slot machines 1, in the present embodiment. The normal game is a slot game of rearranging symbols. The rearrangement of symbols in the slot game is carried out by a mechanical reel unit (equivalent to a display device). In the normal game, on condition that a gaming value is bet, symbols are rearranged in the display window by the mechanical reel unit, and a payout is awarded according to the rearranged symbols. A free game employed in the present embodiment is a slot game of rearranging symbols without requiring betting of a gaming value. This free game is an example of the bonus game, and the bonus game may be any types of games as long as the game is more advantageous for the player than the normal game. For example, the free game includes a game in which a payout amount and a payout rate are higher than those in the normal game, a mini game different from the normal game, and a game in which a predetermined condition is more probable to be established as compared to the normal game.

The symbols collectively mean “RED7”, “3BAR”, “2BAR”, “1BAR”, “BLANK”, and “FEATURE”.

The gaming value is electrically valuable information such as electronic money and the like. It is to be noted that the gaming value in the present invention is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Function Flow)

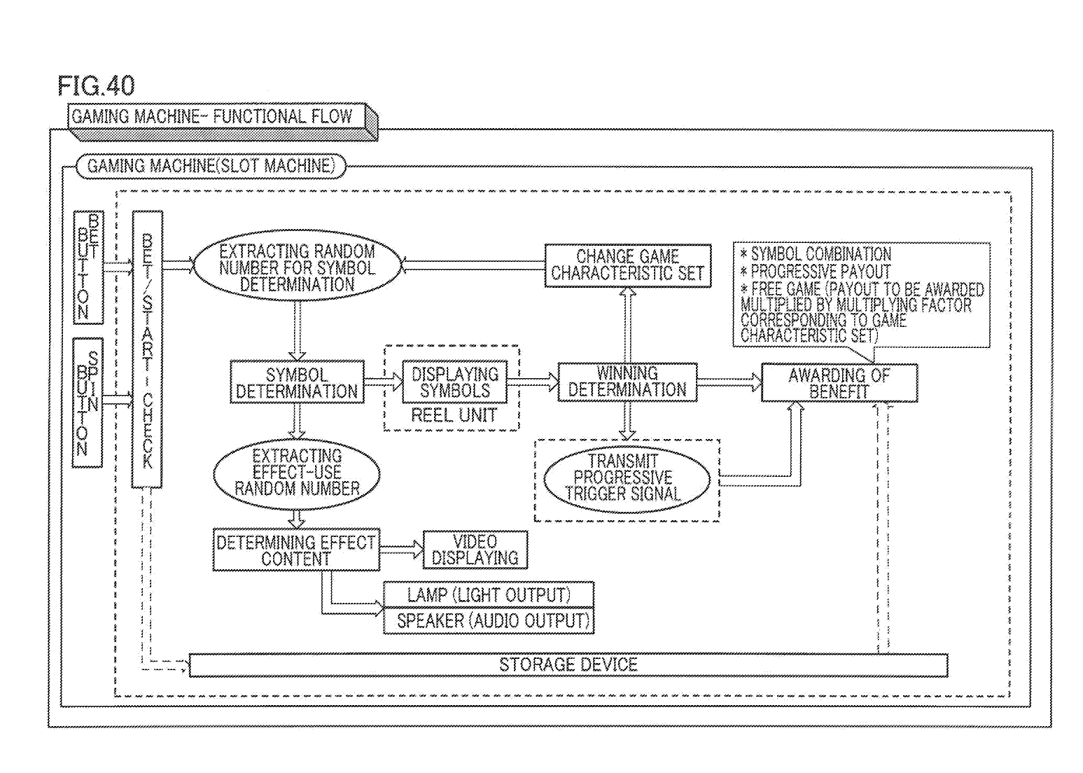

The following describes basic functions of the slot machine related to the embodiment of the present invention, with reference to FIG. 40. FIG. 40 is a diagram showing functional flow of the slot machine related to the embodiment of the present invention.

<Bet/Start-Check>

First, the slot machine checks whether or not a BET button has been pressed by a player, and subsequently checks whether or not a spin button has been pressed by the player.

<Symbol Determination>

Subsequently, when the spin button is pressed by the player, the slot machine extracts a random number for determination, and determines, with reference to the symbol random determination table corresponding to the current game characteristic set, symbols to be displayed (rearranged) for the player at the time of stopping the scroll of the reel, for respective reels.

<Reel Control>

Thereafter, the slot machine starts the rotation of each reel and stops the rotation of each reel so that the determined symbols are displayed for the player (symbol display).

<Winning Determination>

Subsequently, as the rotation of each reel is stopped, the slot machine determines whether the combination of the symbols displayed for the player is a combination related to winning.

<Awarding Benefit>

When the combination of the symbols displayed for the player is a combination related to winning, the slot machine offers, to the player, benefit according to the type of the combination. For example, when a combination of symbols related to awarding of a credit is displayed, the slot machine awards credits to the player, the amount of which corresponds to the combination of the symbols.

In the present embodiment, when a combination of a predetermined symbol is established, transition to the free game occurs. In the free game, the slot game is run without requiring betting from the player. When the combination of the symbols displayed for the player is a combination related to winning as a result of the free game, a payout for the type of symbol combination is multiplied by the multiplying factor corresponding to the current game characteristic set, and the resulting value is awarded to the player as the free game payout.

In addition to the above, the slot machine may accumulatively add a part of a bet amount to progressive payout stored in the storage device, each time the unit game is executed. When progressive payout is employed, the slot machine awards the progressive payout accumulatively stored in the storage device to the player, when a progressive trigger condition is established. The progressive (jackpot) is a function of accumulating at least one of coins betted by a player at a slot machine (or slot machines) in the progressive payout and awarding the accumulated progressive payout to a slot machine in which a progressive trigger is established. When the progressive payout is accumulated by plural slot machines, an amount (accumulative amount) accumulated to the progressive payout is calculated and transmitted to an external controller each time the game is executed. The external controller adds the accumulative amount sent from each slot machine to the progressive payout.

<Modification of Game Characteristic Set>

When the predetermined condition is satisfied in the winning determination, the slot machine switches the game characteristic set currently referred to, to another game characteristic set (random determination table is changed). This way, the probability of making a transition from the normal game to the free game is changed, and the multiplying factor for the payout awarded for the result of the free game is also changed.

The slot machine may have other benefits such as a mystery bonus and insurance. In the mystery bonus, a predetermined number of coins are paid out when a win is achieved in dedicated random determination. When a spin button is pressed, the slot machine samples a random number for the mystery bonus, and whether a mystery bonus trigger is established is randomly determined.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine samples an effect-use random number and determines the content of an effect based on randomly determined symbols or the like.

(Overall Structure of Game System)

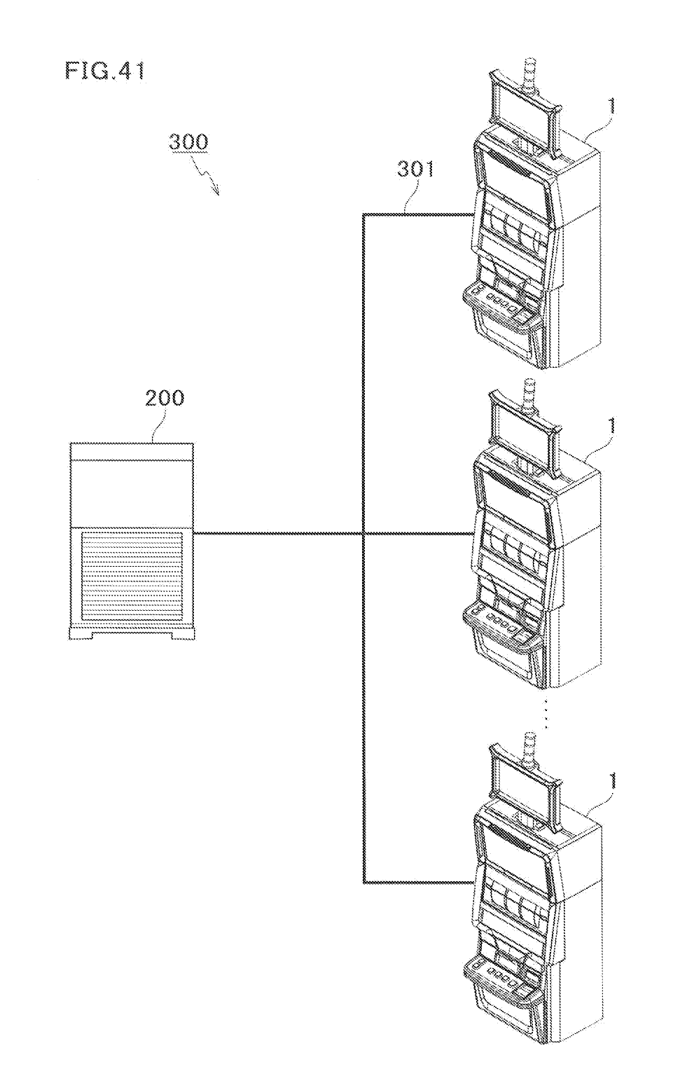

This concludes the description for the basic functions of the slot machine. Now, referring to FIG. 41, a game system including the slot machines will be described. FIG. 41 shows the game system including the slot machines of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

It is to be noted that the game system 300 may be constructed within a single gaming facility where various games can be performed, such as a casino, or may be constructed among a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

(Overall Structure of Slot Machine)

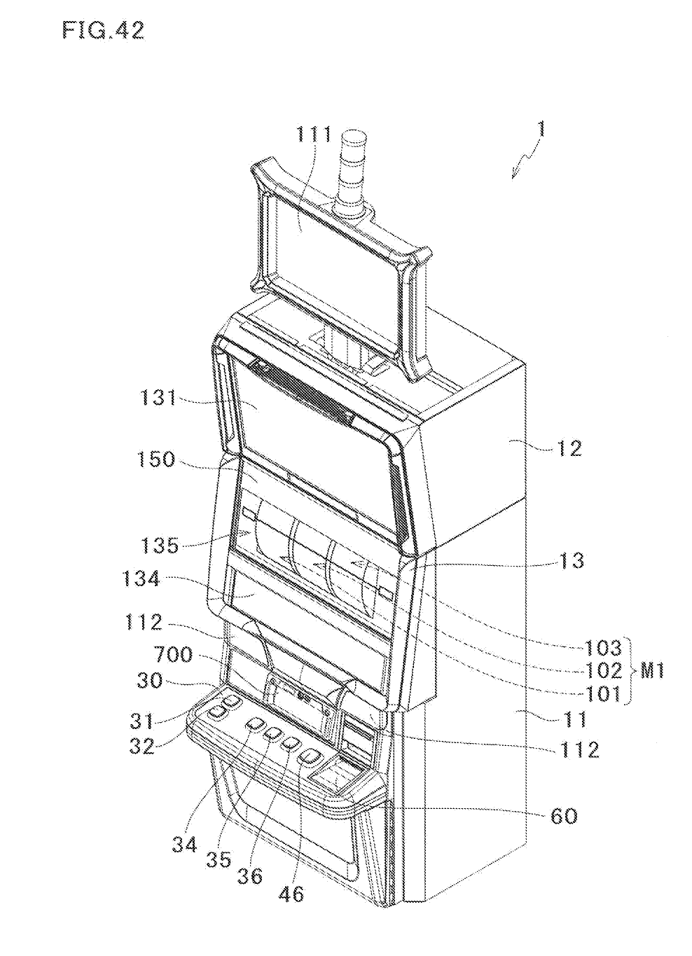

Now, referring to FIG. 42, the overall structure of the slot machine 1 will be described. FIG. 42 shows the overall structure of the slot machine of the embodiment of the present invention.

Electrically valuable information such as electronic money is used as a gaming value in the slot machine 1. It is to be noted that the gaming value is not limited to these, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

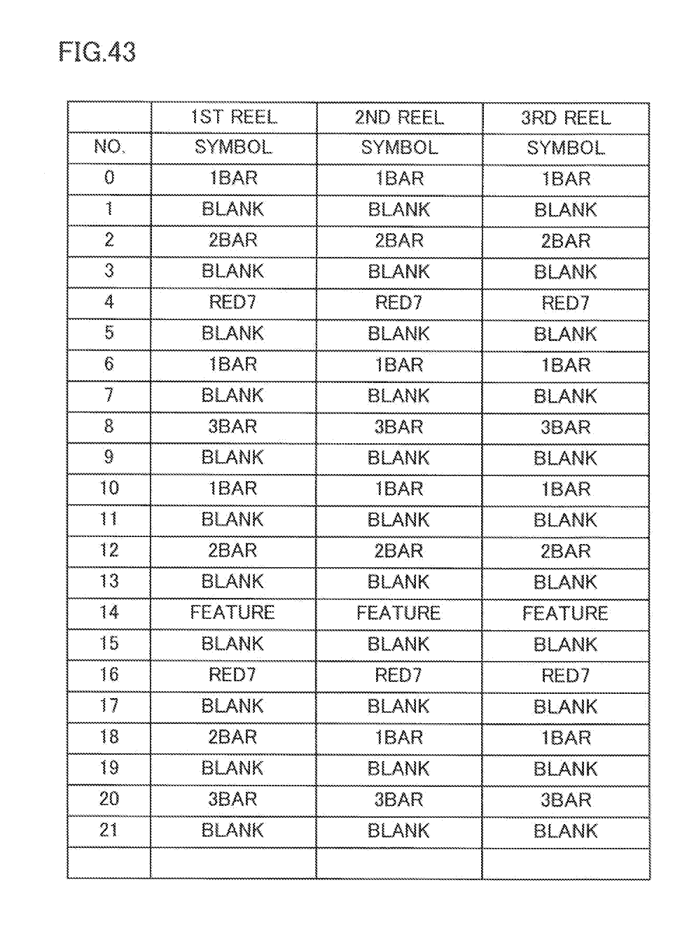

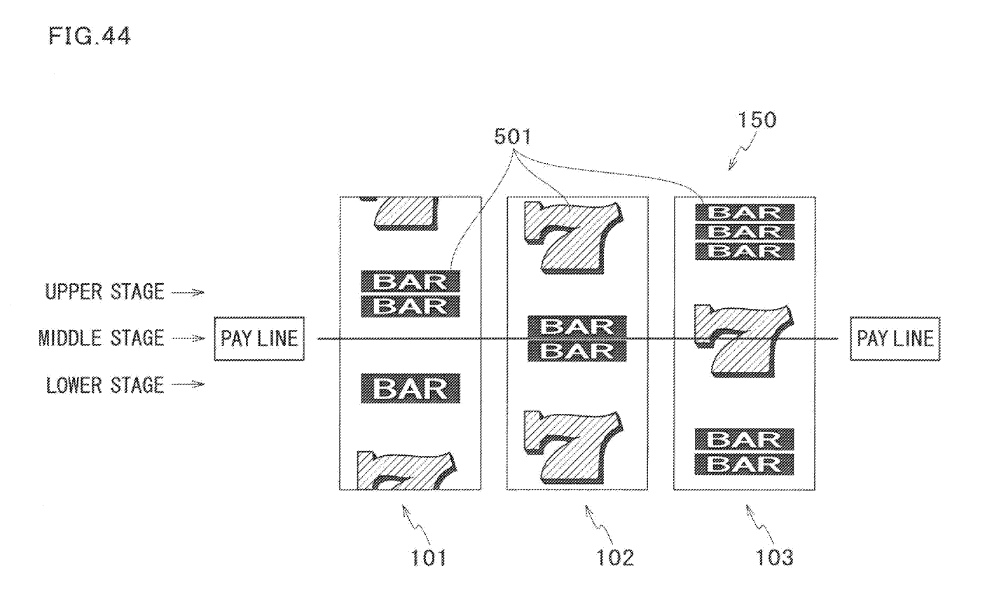

The main door 13 is provided with a reel unit M1 (corresponding to a symbol display device) constituted by three reels 101, 102, and 103. A reel cover 135 is provided in front of the reel device M1. On the front surface of the reel cover 135, a liquid crystal display device 134 by which a gaming status is reported to the player and a transparent panel are provided. This liquid crystal display device 134 is provided with a touch panel 137. The reel cover 135 has the display window 150 at its central portion. In the display window 150, one symbol 501 is provided in each of three areas (corresponding to display areas) that are: the upper stage, the middle stage, and the lower stage of each of the reels 101, 102, and 103 (see FIG. 44). To put it differently, 9 symbols 501 forming a three-by-three matrix matrix are visibly displayed in the display window 150. On the outer circumferential surface of each of the reels 101, 102, and 103, 22 symbols are depicted (see FIG. 43). These 22 symbols 501 are lined up along the rotational direction of the reels 101, 102, and 103 to form a symbol array. Each of the symbol arrays is a combination of “RED7”, “3BAR”, “2BAR”, “1BAR”, “BLANK”, and “FEATURE”. To the main door 13 is provided a speaker 112.

As shown in FIG. 44, a payline for result determination of symbols 501 rearranged in the display window 150 is set in the slot machine 1. In the present embodiment, one payline is formed at the middle stage of the display window 150 as shown in FIG. 44. Alternatively, plural paylines may be provided and each payline may be activated upon selection by a player.

As shown in FIG. 44, the reel unit M1 rearranges the symbols 501 on the display window 150 by drivingly rotating the reels 101, 102, and 103 each having the symbols 501 on the outer circumferential surface. In the descriptions below, the reels may be referred to as a first reel 101, a second reel 102, and a third reel 103 from the left end in front elevation.

On the inner circumferential side of each of the reels 101, 102, and 103 arranged as above, a backlight unit (not illustrated) is provided. The backlight unit emits illumination light from the inner circumferential side of the reels 101, 102, and 103 to the outer circumferential surface of the reels and is arranged so that the illumination light passing through the outer circumferential surface of the reels is seen from the outside of the display window 150. The backlight unit is configured to be able to change the amount of illumination light in multiple stages. The degree of freedom in the effects using illumination light is therefore high. Furthermore, each backlight unit is able to emit light in multiple colors, and to illuminate the symbols individually with the illumination light.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

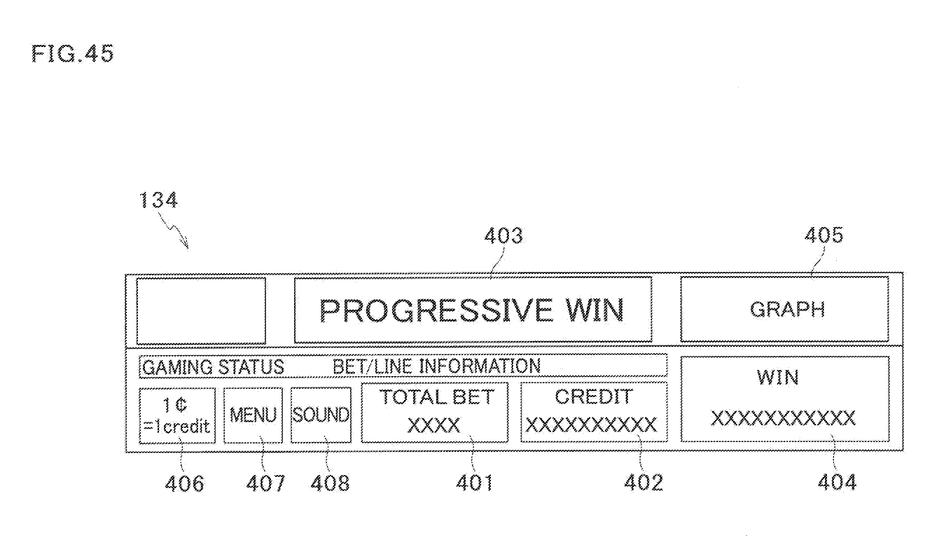

As shown in FIG. 45, on the liquid crystal display device 134 is displayed meters indicating the conditions of the game. For example, a total bet meter 401 displays “Total Bets”. The numerical value is re-calculated at every game play. The credit meter 402 indicates the total credit amount at the time. The default value is 0. The numerical value is increased or decreased according to the gaming value input, the bet, and the game result. A game message area 403 indicates a message explaining the current gaming status. The win meter 404 indicates the total credit amount of the payout having been won.

The liquid crystal display device 134 is provided with a graph touch area 405, a denomination indicator 406, a menu touch area 407, and a sound volume switching touch area 408. When touched by the player, the graph touch area 405 displays, in the form of graphs, the change of the obtained payout amount, the number of game play in the normal mode executed until the transiting to the high-probability mode, and the total obtained credit amount in the Zone A mode, Zone B mode, and Zone C mode, on the upper image display panel 131. As the graph touch area 405 is touched, three types of graph images, i.e., line-graph, bar-graph, and block-graph are displayed in order. The denomination indicator 406 displays current denomination. When the menu touch area 407 is touched by the player, the upper image display panel 131 displays the first page of the HELP screen. The sound volume switching touch area 408 is used for switching the game sound volume in three stages. Each time the sound volume switching touch area 408 is touched by the player, the game sound volume is switched such that, for example, from low to middle to high to small to middle.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the reel unit M1 are provided a control panel 30 having various buttons, a PTS device 700, and a bill entry 60.

The bill entry 60 validate bills and receives genuine bills into the cabinet 11. The bill entry 60 is electrically connected to the PTS device 700, and when a legitimate bill is received, transmits to the PTS device 700 an input signal based on the value of the bill. The input signal represents information of credit data and the like related to the bill received.

The PTS device 700 is a unit in which an LCD (liquid crystal display), a human detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Control Panel 30)

On the control panel 30, a HELP button 31 and a CASHOUT button 32 are arranged in the left side area, a 1-BET button 34, a 2-BET button 35, and a 3-BET button 36 are arranged in the middle area, and a spin button 46 is arranged in the lower stage on the left side area.

The HELP button 31 is pressed when, for example, it is unclear how to play a game. As the HELP button 31 is pressed, various help information is displayed on the upper image display panel 131. The CASHOUT button 32 is an operation button used when checking out credits reserved in the slot machine 1 is discharged.

Each time the 1-BET button 34 is pressed, one of the credits currently owned by the player is betted. The 2-bet button 35 is used to start a game with two bets. The 3-bet button 36 is used to start a game with three bets. A gaming value corresponding to one bet can be optionally changed by setting the denomination.

The spin button 46 is used to start the rotation of the reels 101, 102, and 103.

(Symbol Array)

Now, with reference to FIG. 43, the arrays of the symbols 501 on the first reel 101, the second reel 102, and the third reel 103 of the slot machine 1 will be described.

A symbol table shown in FIG. 43 shows arrays of the symbols 501 displayed on the outer circumferential surfaces of the first reel 101, the second reel 102, and the third reel 103. To each of the first reel 101, the second reel 102, and the third reel 103 is assigned a symbol array including 22 symbols 501 respectively corresponding to code numbers 0 to 21.

As shown in FIG. 43, the types of the symbols include “RED7”, “3BAR”, “2BAR”, “1 BAR”, “BLANK”, and “FEATURE”.

[Structures of Circuits Provided to Slot Machine]

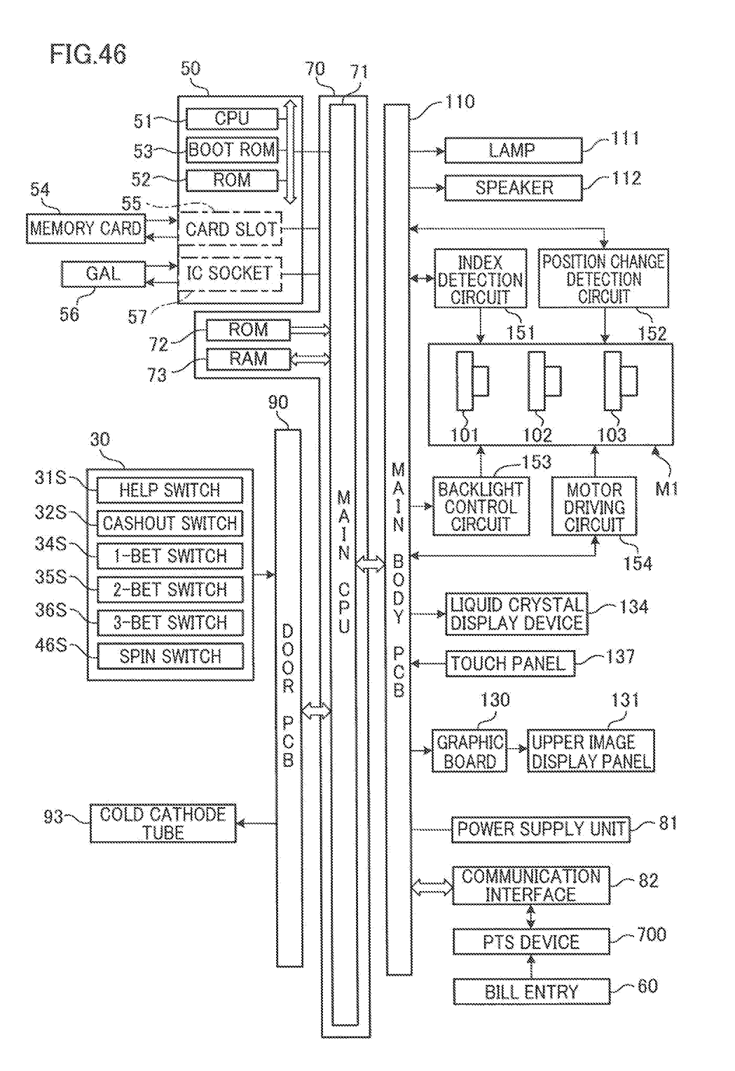

Now, referring to FIG. 46, the configuration of a circuit in the slot machine 1 will be described. FIG. 46 is a block diagram showing an internal structure of the slot machine of the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to a storage device.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the main CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations when these programs are executed. Examples of the areas include: an area that stores counter which manages the number of game play, a bet amount, the credit amount, a payout value of each progressive payout, and the like; and an area that stores symbols (code numbers) randomly determined.

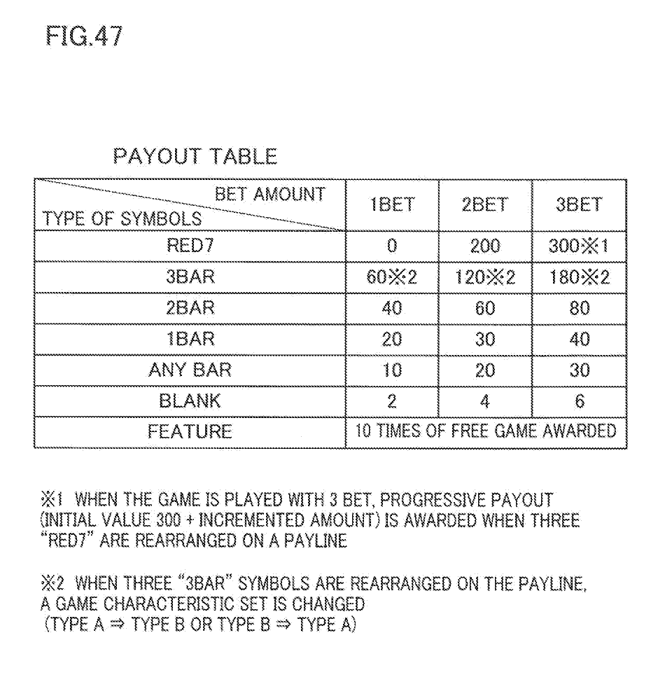

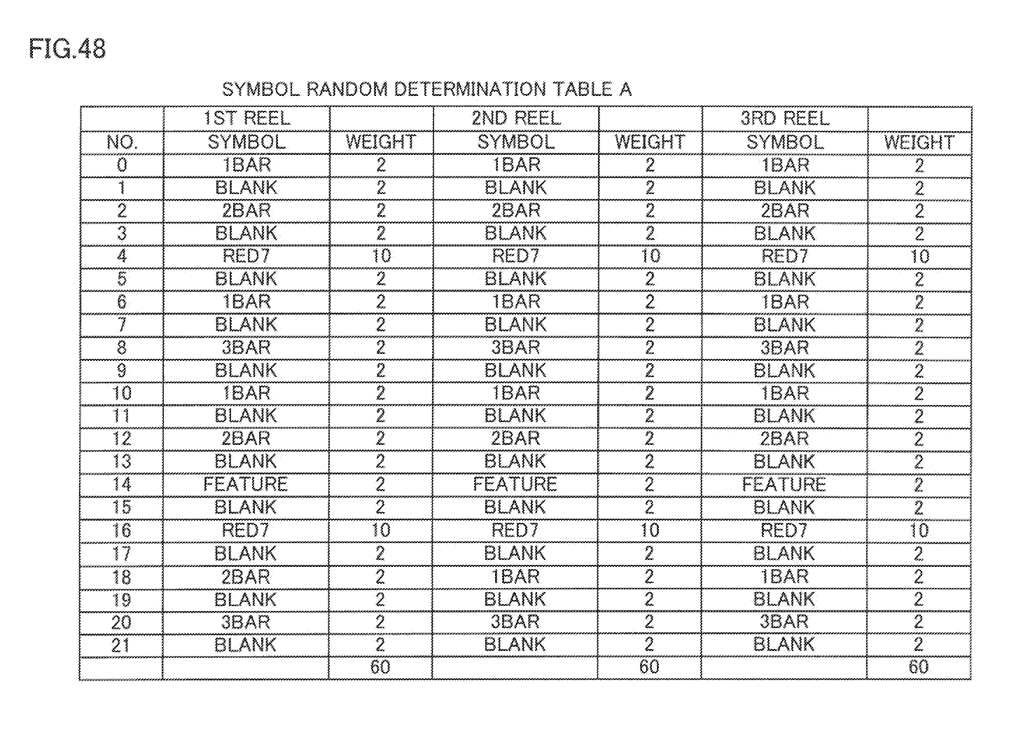

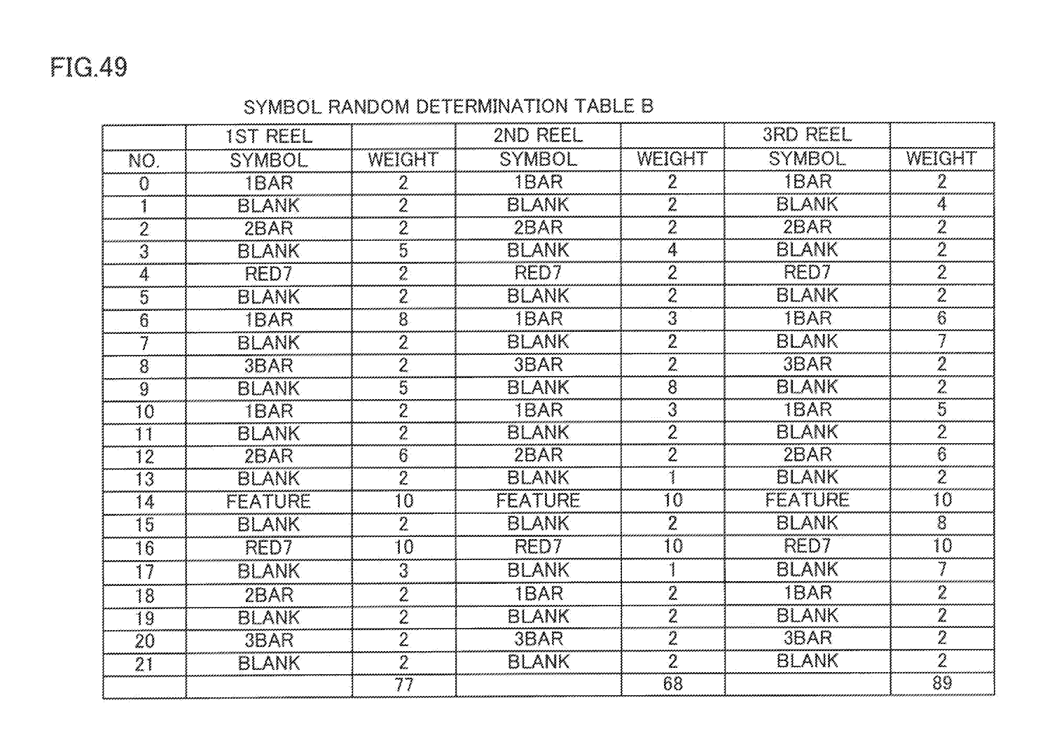

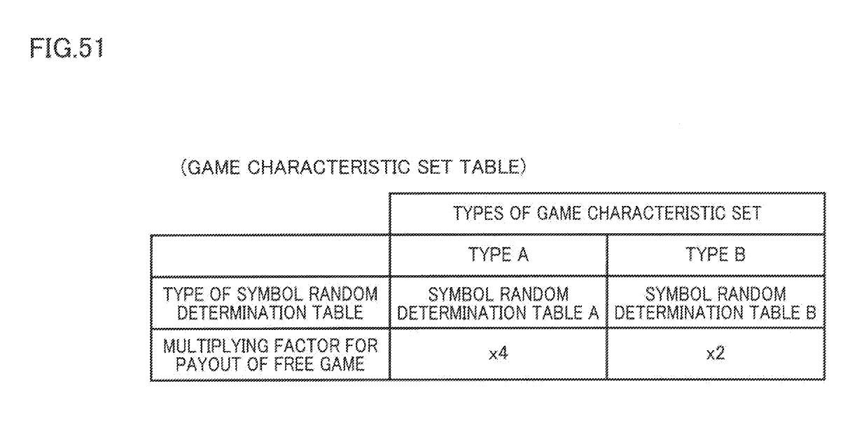

In addition to the above, the RAM 73 stores tables such as a symbol combination table (see FIG. 47), a symbol random determination table A (see FIG. 48), a symbol random determination table B (see FIG. 49), and a game characteristic set table (see FIG. 51).

The communication interface 82 is for communicating with the PTS device 700 and the external controller 200. The PTS device 700, upon reception of an input signal from the bill entry 60, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a HELP switch 31S, a CASHOUT switch 32S, a 1-BET switch 34S, a 2-BET switch 35S, a 3-BET switch 36S, and a spin switch 46S, correspondingly to the above-described buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The body PCB 110 is connected with a lamp 111, a speaker 112, a graphic board 130, the liquid crystal display device 134, a touch panel 137, an index detection circuit 151, a position change detection circuit 152, a backlight control circuit 153, and a motor driving circuit 154. The index detection circuit 151, the position change detection circuit 152, a backlight control circuit 153, and a motor driving circuit 154 are connected with the reel unit M1.

The lamp 111 turns on based on a control signal outputted from the main CPU 71. The speaker 112 outputs BGM sound or the like in accordance with a control signal output from the main CPU 71.

The graphic board 130 controls displaying of images on the upper image display panel 131 based on a control signal output from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 134 displays an image based on a control signal output from the main CPU 71. The touch panel 137 detects a position on the liquid crystal display device 134 touched by a finger or the like of the player, and outputs a signal corresponding to the detected position to the main CPU 71.

The motor driving circuit 154 is connected to a stepper motor configured to rotate the reels 101, 102, and 103. Further, the motor driving circuit 154 includes an FPGA (Field Programmable Gate Array) and a driver. The FPGA is an electronic circuit such as a programmable LSI, and functions as a control circuit of the stepper motor. The driver functions as an amplifying circuit for pulses to be input to the stepping motor.

The index detection circuit 151 detects the positions of the rotating reels 101, 102, and 103 and is able to detect the step out of the reels 101, 102, and 103.

The position change detection circuit 152 is configured to detect a change in the stop position of the reels 101, 102, and 103 after the rotation of the reels 101, 102, and 103 is stopped. The position change detection circuit 152 detects a change in the stop positions of the reels 101, 102, and 103 when, for example, a stop position is changed to achieve a winning combination of the symbols 501 by an illicit way when no winning combination of the symbols 501 is achieved. The position change detection circuit 152 is configured to detect a change in the stop position of the reels 101, 102, and 103, for example, by detecting not-shown fins (not illustrated) which is arranged on the inner sides of the reels 101, 102, and 103 at predetermined intervals.

It should be noted that the method of exciting the stepping motor is not particularly limited, and 1-2 phase excitation system or a 2 phase excitation system are adoptable. Further, a DC motor may be adopted in place of the stepping motor. In cases of adopting a DC motor, the main body PCB 110 is connected to an error counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the deviation counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumferential surfaces of the reels 101, 102, and 103 are able to individually illuminate nine symbols 501 having stopped on the display window 150 by means of the backlight control circuit 153.

(Payout Table: Symbol Combination Table)

Now, payout tables (symbol combination tables) will be described with reference to FIG. 47. FIG. 47 shows a payout table in the slot machine of the embodiment of the present invention.

The payout table (symbol combination table) defines payouts for bet amounts and symbol combinations achieving winning (WIN). In the slot machine 1, the rotational scroll of the reels 101, 102, and 103 is stopped, and when a combination of three symbols displayed (rearranged) on a payline corresponds to a symbol combination defined in the symbol combination table, winning is achieved. In accordance with the type of winning, a benefit will be given to the player in the form of awarding payout and the like. It is noted that winning is not established (i.e. the game is lost) when the combination of symbols displayed (rearranged) on the payline does not match with any of the combinations of symbols specified by the symbol combination table.

Basically, winning is achieved when three symbols of the following types are displayed on a payline: “RED7”, “3BAR”, “2BAR”, “1BAR”, “BLANK”, and “FEATURE”. Winning as “ANYBAR” is also achieved when a symbol combination including “3BAR”, “2BAR”, and “1BAR” is established. When the game is played with one bet, no payout is awarded for “RED7”. When the game is played with three bets, progressive payout (initial value 300+incremented amount) is awarded when three “RED7” are rearranged on a payline. When three “FEATURE” are rearranged on the payline, right to execute the free game ten times is awarded. When three “3BAR” symbols are rearranged on the payline, a payout is awarded and the type of the later-described game characteristic set is changed.

(Symbol Random Determination Table A: First Random Determination Table)

Now, the symbol random determination table A will be described with reference to FIG. 48. In the present embodiment, the symbol random determination table A is a table which is referred to in the symbol random determination process in the later-described main control process.

In the symbol random determination table A, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the symbol random determination table A shown in FIG. 48, “1BAR” of the first reel 101 corresponding to the code number “0” is rearranged in the middle stage of the display window 150 (on the payline) at a probability of 2/60. “BLANK” of the second reel 102 corresponding to the code number “1” is rearranged in the middle stage of the display window 150 (on the payline) at a probability of 2/60. “RED7” of the third reel 103 corresponding to the code number “4” is rearranged in the middle stage of the display window 150 (on the payline) at a probability of 10/60. Similarly, “FEATURE” of the first reel 101 corresponding to the code number “14” is rearranged in the middle stage of the display window 150 (on the payline) at a probability of 2/60. “FEATURE” of the second reel 102 corresponding to the code number “14” is rearranged in the middle stage of the display window 150 (on the payline) at a probability of 2/60. “FEATURE” of the third reel 103 corresponding to the code number “14” is rearranged in the middle stage of the display window 150 (on the payline) at a probability of 2/60.

(Symbol Random Determination Table B: Second Random Determination Table)

Now, the symbol random determination table B will be described with reference to FIG. 49. In the present embodiment, the symbol random determination table B is a table which is referred to in the symbol random determination process in the later-described main control process.

In the symbol random determination table B, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the symbol random determination table B shown in FIG. 49, “1BAR” of the first reel 101 corresponding to the code number “0” is rearranged in the middle stage of the display window 150 (on the payline) at a probability of 2/77. “BLANK” of the second reel 102 corresponding to the code number “1” is rearranged in the middle stage of the display window 150 (on the payline) at a probability of 2/68. “RED7” of the third reel 103 corresponding to the code number “4” is rearranged in the middle stage of the display window 150 (on the payline) at a probability of 2/89. Similarly, “FEATURE” of the first reel 101 corresponding to the code number “14” is rearranged in the middle stage of the display window 150 (on the payline) at a probability of 10/77. “FEATURE” of the second reel 102 corresponding to the code number “14” is rearranged in the middle stage of the display window 150 (on the payline) at a probability of 10/68. “FEATURE” of the third reel 103 corresponding to the code number “14” is rearranged in the middle stage of the display window 150 (on the payline) at a probability of 10/89.

(Free Game Symbol Random Determination Table)

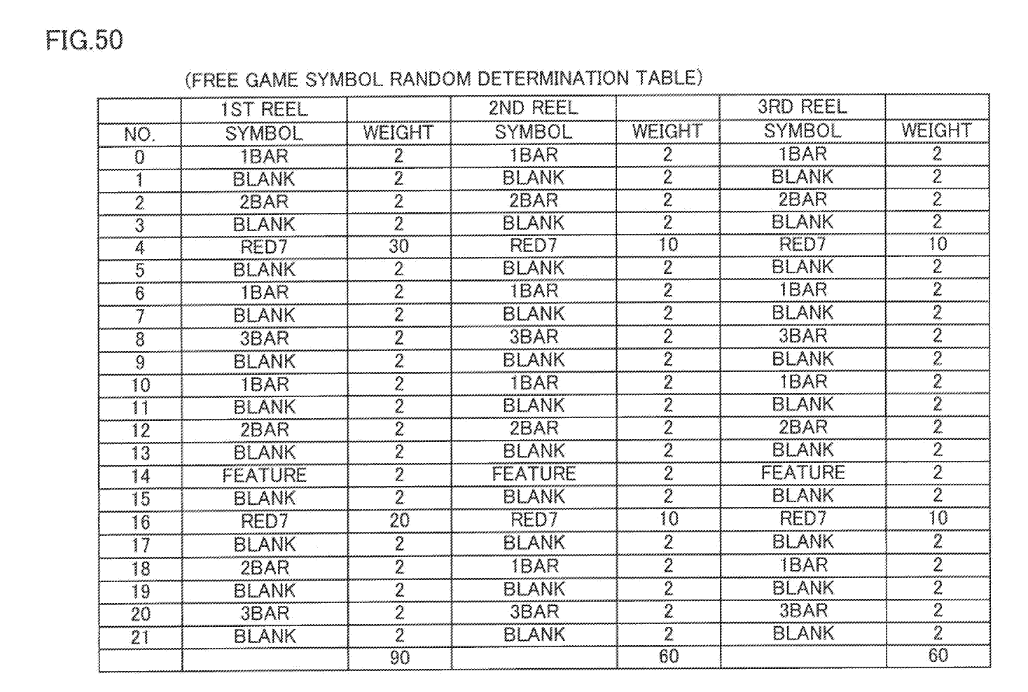

Now, the symbol random determination table for free games will be described with reference to FIG. 50. In the present embodiment, the free game symbol random determination table B is a table which is referred to in the symbol random determination process in the later-described free game process.

In the free game symbol random determination table, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the free game symbol random determination table shown in FIG. 50, “1BAR” of the first reel 101 corresponding to the code number “0” is rearranged in the middle stage of the display window 150 (on the payline) at a probability of 2/90. “BLANK” of the second reel 102 corresponding to the code number “1” is rearranged in the middle stage of the display window 150 (on the payline) at a probability of 2/60. “RED7” of the third reel 103 corresponding to the code number “4” is rearranged in the middle stage of the display window 150 (on the payline) at a probability of 10/60.

(Game Characteristic Set Table)

Now, the game property set table will be described with reference to FIG. 51. The game characteristic set table is referred to at the time of switching the later-described game characteristic set.

In the game characteristic set table of the present embodiment, the two types of game characteristic sets, i.e., type A and type B, are associated with the type of the symbol random determination table and the multiplying factor for the payout of the free game. Specifically, the game characteristic set type A is associated with a symbol random determination table A (see FIG. 48) as the type of the symbol random determination table, and with ×4 as a multiplying factor for the payout of the free game. On the other hand, the game characteristic set type B is associated with a symbol random determination table B (see FIG. 49) as the type of the symbol random determination table, and with ×2 as a multiplying factor for the payout of the free game. It should be noted that, in the present embodiment, the level of the expectation value for the payout to be awarded for the result of the free game is adjusted by the multiplying factor for the payout of the free game.

In the symbol random determination table B (FIG. 49), the probability of three “FEATURE” symbols being rearranged on the payline is higher than the symbol random determination table A (FIG. 48). That is, in the symbol random determination table B (FIG. 49) corresponding to the game characteristic set type B, the probability of the free game being awarded is higher than that in the symbol random determination table A (FIG. 48) corresponding to the game characteristic set type A. On the other hand, the multiplying factor of ×4 for the payout of the free game, which corresponds to the game characteristic set type A is higher than the multiplying factor of ×2 for the payout of the free game corresponding to the game characteristic set type B.

In the above structure, if the type A of the game characteristic set is currently referred to, the free game is hardly awarded as compared to a case of referring to the type B of the game characteristic set. However, during the free game, a higher free game payout is awarded by a multiplying factor higher than that of the game characteristic set type B. In the above structure, if the type B of the game characteristic set is currently referred to, the free game is more easily awarded as compared to a case of referring to the type A of the game characteristic set.

However, during the free game, the payout of the free game is restrained by a multiplying factor lower than that of the game characteristic set type A.

(Contents of Program)

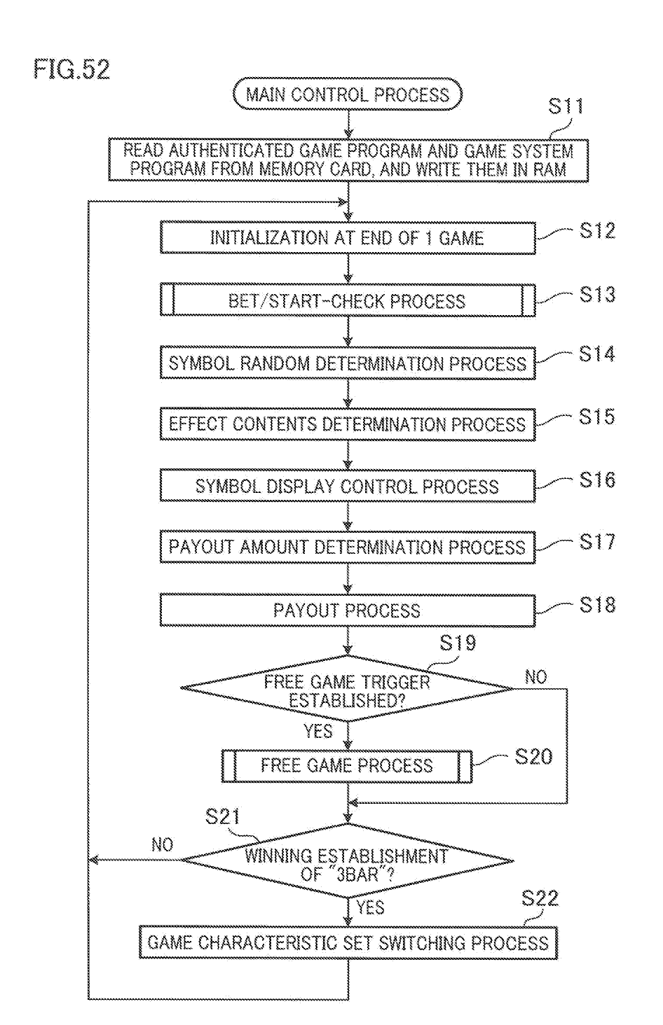

Now, the program to be executed by the slot machine 1 is described with reference to FIG. 52 to FIG. 54.

(Main Control Process)

Referring to FIG. 52, a main control process will be described. In the main control process, a normal game is executed.

First, when the slot machine 1 is powered on, the main CPU 71 reads an authenticated game program and a game system program from a memory card 54 via a gaming board 50, and then write them in the RAM 73 (S11).

Subsequently, the main CPU 71 executes an initializing process at the end of each play of the game, in order to start the normal game (S12). This process clears data in a working area of the RAM 73, which becomes unnecessary at the end of each play of the normal game, e.g., the bet amount, symbols randomly determined, and the like.

The main CPU 71 then executes a later-described bet/start-check process (S13). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S14). In this symbol random determination process, three to-be-stopped symbols to be rearranged in the middle stage (on the payline) of the display window 150 (on the first reel 101, the second reel 102, and the third reel 103) are randomly determined based on the probabilities defined in the symbol random determination table corresponding to the current game characteristic set, referring to the game characteristic set area of the RAM 73. It should be noted that the game characteristic set currently referred to is set to the game characteristic set of the type A, and is due to be changed in the later-described game characteristic set switching process.

For example, three to-be-stopped symbols to be rearranged in the middle stage (on the payline) of the display window 150 (on the first reel 101, the second reel 102, and the third reel 103) are randomly determined based on the probabilities defined in the symbol random determination table (FIG. 48) corresponding to the game characteristic set of the type A (see FIG. 51), which is currently referred to, based on the game characteristic set area of the RAM 73. When the code number “16” is selected at the random determination probability of 10/60 for the first reel 101, “RED7” corresponding to the code number “16” of the first reel 101 is selected as a to-be-stopped symbol to be rearranged in the middle stage of the display window 150 (on the payline) When the code number “16” is selected at the random determination probability of 10/60 for the second reel 102, “RED7” corresponding to the code number “16” of the second reel 102 is selected as a to-be-stopped symbol to be rearranged in the middle stage of the display window 150 (on the PAY LINE). When the code number “16” is selected at the random determination probability of 10/60 for the third reel 103, “RED7” corresponding to the code number “16” of the third reel 103 is selected as a to-be-stopped symbol to be rearranged in the middle stage of the display window 150 (on the PAY LINE).

The main CPU 71 stores the determined to-be-stopped symbols on the reels 101 to 103 in a symbol storing area in the RAM 73.

Subsequently, the main CPU 71 executes an effect contents determination process (S15). The main CPU 71 extracts an effect-use random number and randomly selects one of a plurality of predetermined effect contents.

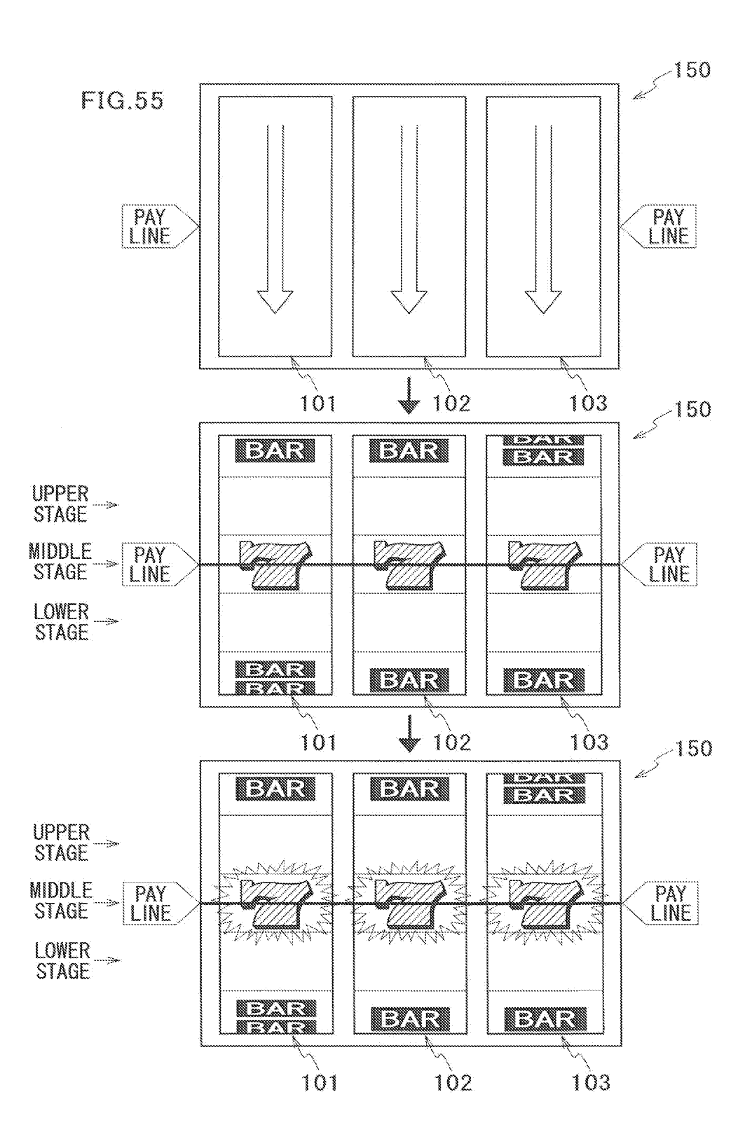

Then, the main CPU 71 executes a symbol display control process (S16). In this symbol display control process, as shown in FIG. 55, the scroll of the reels 101 to 103 starts, and after a predetermined time elapses, the to-be-stopped symbols corresponding to the reels 101 to 103 selected in the symbol random determination process in S14 stop one by one in the middle stage of the display window 150 (on the PAY LINE). That is, nine symbols including the to-be-stopped symbols are displayed in the display window 150 (in the upper stage, the middle stage, and the lower stage). For example, when the to-be-stopped symbol on the first reel 101 is “RED7”, the to-be-stopped symbol on the second reel 102 is “RED7”, and the to-be-stopped symbol on the third reel 103 is “RED7”, “RED7”, “RED7”, and “RED7” are rearranged in the middle stage of the display window 150 (on the payline) as shown in FIG. 55.

The main CPU 71 then executes a payout amount determination process (S17). In this process, payout is determined based on a symbol combination displayed on the payline with reference to the symbol combination table (see FIG. 47) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “3BAR”, “180” credits are determined as the payout with reference to the symbol combination table and stored in the payout amount storage area in the RAM 73.

When the value of the bet counter is “3” (MAXBET) and the symbol combination displayed on the payline is three “RED7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 300 in each game play. When the progressive payout is won, the value of the progressive payout counter is stored in the payout amount storage area of the RAM 73. Furthermore, when the progressive payout is won, a message which notifies that the progressive payout has been awarded is displayed. To be more specific, messages “CONGRATULATIONS!”, “PROGRESSIVE WIN”, “XXXXXXXX CREDITS” are displayed on the upper image display panel 131.

Then a payout process is executed (S18). The main CPU 71 adds the value stored in the payout amount storage area to the value of the credit counter in the RAM 73.

Then the main CPU 71 determines whether a free game trigger is established for nine symbols rearranged in the display window 150 (S19). To be more specific, whether three “FEATURE” are rearranged on the payline is determined (see FIG. 47). When the free game trigger is established (S19: YES), a later-described free game process is executed (S20).

On the other hand, when the free game trigger is not established (S19: No), or after the free game process, the main CPU 71 determines whether or not “3BAR” winning is established (S21). Specifically, there is determined whether a combination of symbols on the payline is a combination of “3BAR” symbols. If the “3BAR” winning is not established (S21: NO), the process proceeds to S12.

On the other hand, if the “3BAR” winning is established (S21: Yes), the main CPU 71 executes a game characteristic set switching process (S22). In this game feature set the switching process, the game characteristic set area of the RAM 73 is referred to. If the current game characteristic set of type A, the type A is switched to Type B, and the type B is stored in the game characteristics set region as the current game characteristics set. Further, referring to the area of the RAM 73, if the current game characteristic set of type B, the type B is switched to Type A, and the type A is stored in the game characteristics set region as the current game characteristics set.

In the above structure, for example, the probability of transition from the result to the bonus game and the expectation value for the payout awarded for the result of the bonus game may be set to be changed when the normal game results in the “3BAR” winning (predetermined result). This attract the attention of the player, and induces the player to continue or start participating the game.

It should be noted that, in the present embodiment, the game characteristic set switching process, the type of the game characteristic set is switched automatically. However, the present invention is not limited to this, and switching of the type of the game characteristic set may randomly take place when a random determination results in a winning, and the game characteristic set is maintained when the random determination results in losing.

Then, after S22, the routine proceeds to S12.

In the above structure, establishment of “3BAR” winning leads to changing of the game characteristic set, thus changing the probability of a free game being awarded, as well as the multiplying factor for the payout of the free game. Since the type of the symbol random determination table and the multiplying factor for the payout of the free game are associated with the type A and the type B of the game characteristic set, it is possible to set the probability of the free game being awarded and the multiplying factor for the payout of the free game, in association with each other. This way, when the “3BAR” winning is satisfied, it is possible to change the entire balance of payout for the normal game and the free game, thereby relieving the monotony of the game.

Further, for example, if the type A of the game characteristic set is currently referred to, the free game is hardly awarded as compared to a case of referring to the type B of the game characteristic set, in the above structure. However, during the free game, a higher free game payout is awarded by a multiplying factor higher than that of the game characteristic set type B. Then, when “3BAR” winning is established and the game characteristic set referred to is switched to the game characteristic set of type B, it will be more likely that the free game is awarded. However, during the free game, a lower multiplying factor makes the payout of the free game low. Thus, when the game characteristic set is switched, it gives a player an impression as if the player is given a higher chance for transition to the free game, and for winning a high free game payout, consequently relieving the monotony of the game.

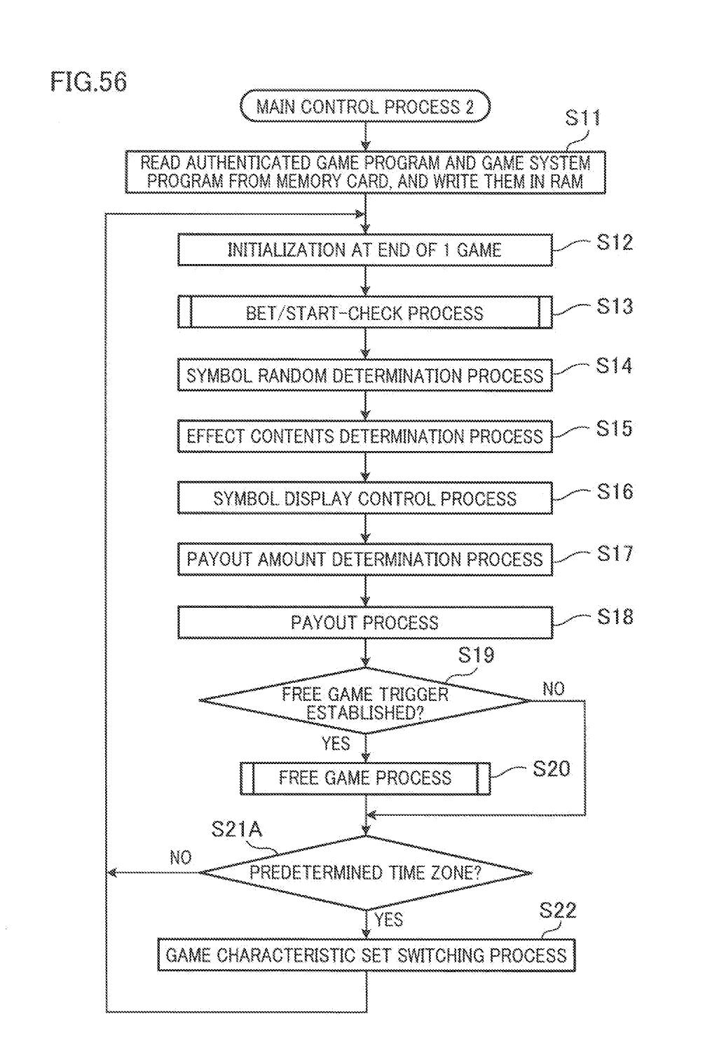

It should be noted that in the above embodiment, the game characteristic set switching process is executed when “3BAR” winning is established in the normal game. However, the present invention is not limited to this and the game characteristic set may be switched at a predetermined time. To be more specific, the main control process 2 shown in FIG. 56 is executed.

In the main control process 2 shown in FIG. 56, the normal game is run as in the case of the main control process (see FIG. 52). The processes S11 to S20 are the same as those in the main control process of FIG. 52.

When the free game trigger is not established (S19: No), or after the free game process (S20), the main CPU 71 determines whether or not the time is anywhere between 23:00 (11:00 PM) and 7:00 (7:00 AM) (corresponding to the predetermined time; S21A). If the current time is not anywhere between 23:00 (11:00 PM) and 7:00 (7:00 AM) (S21A: NO), the process proceeds to S12.

On the other hand, if the current time is anywhere between 23:00 (11:00 PM) and 7:00 (7:00 AM) (S21A: YES), the main CPU executes the game characteristic set switching process (S22). In this game feature set the switching process, the game characteristic set area of the RAM 73 is referred to. If the current game characteristic set of type A, the type A is switched to Type B, and the type B is stored in the game characteristics set region as the current game characteristics set. Further, referring to the area of the RAM 73, if the current game characteristic set of type B, the type B is switched to Type A, and the type A is stored in the game characteristics set region as the current game characteristics set. Then, after S22, the routine proceeds to S12.

In the above structure, the probability of transition from the normal game to the bonus game and the expectation value for the payout awarded for the result of the bonus game may be set to be changed at the late night or the early morning, where there are not too many players (23:00 (11:00 PM) to 7:00 (7:00 AM)). This attract the attention of the player, and increases the opportunity for the player to participate the game.

(Bet/Start-Check Process)

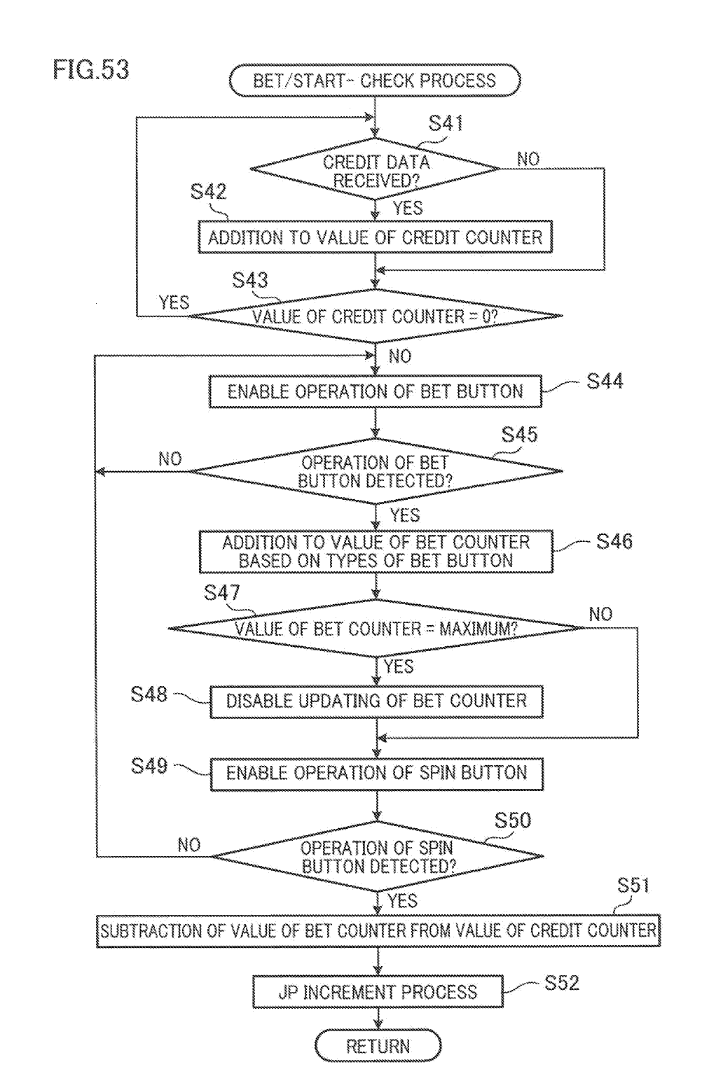

Now the bet/start-check process will be described with reference to FIG. 53.

To begin with, the main CPU 71 determines whether credit data has been received from the PTS device 700 (S41). The credit data is sent from the PTS device 700 to the main CPU 71, for example, when the IC card is inserted into the card insertion slot and when the bill entry 60 receives a genuine bill.

When the credit data is received (S41: YES), the main CPU 71 adds the amount indicated by the received credit data to the value of the credit counter (S42).

After the step S42 or when determining in S41 that no credit data is received (S41: NO), the main CPU 71 determines whether or not the value stored in the credit counter is 0 (S43). When determining that the value of the credit counter is 0 (S43: YES), the main CPU 71 goes back to S41.

When the main CPU 71 determines that the value of the credit counter is not 0 (S43: NO), the main CPU 71 permits operation acceptance of the BET buttons (1-BET button 34, 2-BET button 35, and 3-BET button 36) (S44).

Then the main CPU 71 determines whether an operation of the BET button is detected (S45). When an operation of the bet button by a player is detected by the bet switch (1-BET switch 34S, 2-BET switch 35S, or 3-BET switch 36S), the main CPU 71 performs addition to the value of the bet counter in the RAM 73, based on the type of the BET button (S46).

Subsequently, the main CPU 71 determines whether the value of the bet counter is at the maximum (S47). When determining that the value of the bet counter is at the maximum (S47: YES), the main CPU 71 prohibits the update of the value of the bet counter (S48). After S48, when determining in S47 that the value of the bet counter is not at the maximum (S47: NO), the main CPU 71 enables operation of the spin button 46 (S49).

After S49, the main CPU 71 determines whether an operation of the spin button 46 is detected (S50). When the main CPU 71 determines that an operation of the spin button 46 is not detected (S50: NO), the routine proceeds to S41.

In the meanwhile, when the main CPU 71 determines that operation of the spin button 46 is detected (S50: YES), the main CPU 71 subtracts the value of the bet counter calculated in S46 from the value of the credit counter (S51).

The main CPU 71 then executes a JP increment process (S52). In the JP increment process, as the resource of the progressive payout, the value of the progressive payout counter in the RAM 73 is incremented by a value calculated by multiplying the value of the bet counter calculated in S46 by an increment rate (0.01 but may be optionally set) set in the present embodiment. For example, when the value of the bet counter calculated in S46 is “3”, 3×0.01=0.03 credit is added to the value of the progressive payout counter. In the present embodiment, the initial value of the progressive payout counter is 300 credits. Therefore, in the progressive payout counter, a value calculated by multiplying the value of the bet counter by the increment rate (0.01) is accumulatively added to the initial value of 300 in each game play.

Then the bet/start-check process is terminated.

(Free Game Process)

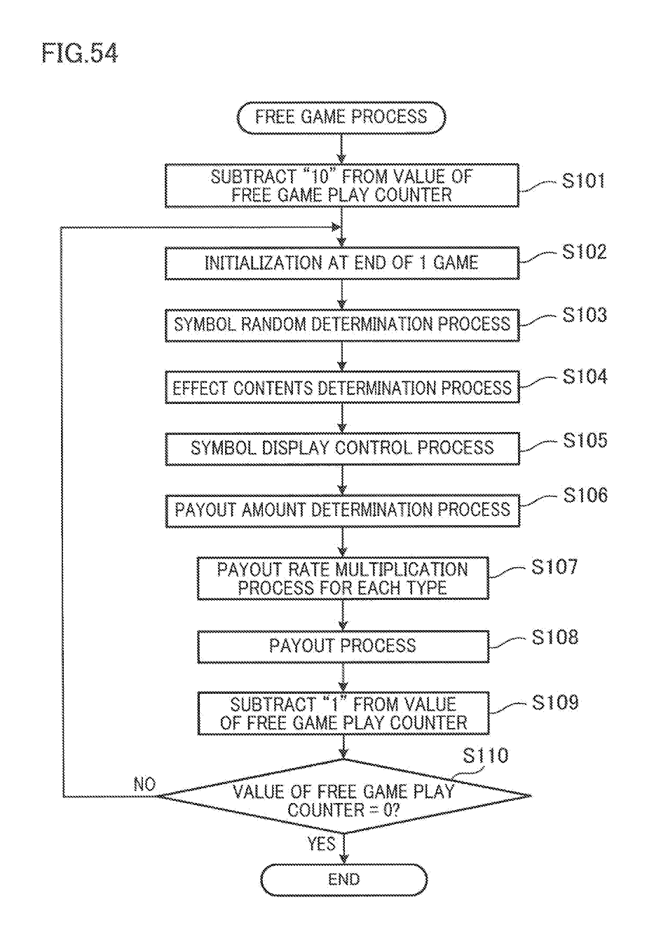

The following describes a free game process with reference to FIG. 54. FIG. 54 is a flowchart of a free game process of the slot machine related to the embodiment of the present invention.

To begin with, the main CPU 71 adds “10” to the free game play counter (stored in the RAM 73) and stores the resultant number (S101). This allows the player to play the slot game ten times without newly placing a bet.

Then the main CPU 71 executes an initializing process at the end of each round of the game in the same manner as in S12 (S102). This process clears data in a working area of the RAM 73, which becomes unnecessary at the end of each play of the free game, e.g., the bet amount, symbols randomly determined, and the like. This process clears data in a working area of the RAM 73, which becomes unnecessary at the end of each play of the free game, e.g., the bet amount, symbols randomly determined, and the like.

Subsequently, the main CPU 71 executes the symbol random determination process as in S14 (S103). In this symbol random determination process, three to-be-stopped symbols (on the first reel 101, the second reel 102, and the third reel 103) to be rearranged in the middle stage of the display window 150 (on the payline) are randomly determined based on the probabilities defined in the free game symbol random determination table in RAM 73 (see FIG. 50).

Subsequently, the main CPU 71 executes an effect contents determination process as in S15 (S104).

The main CPU 71 then executes the symbol display control process as in S16 (S105). In this symbol display control process, as shown in FIG. 55, the scroll of the reels 101 to 103 starts, and after a predetermined time elapses, the to-be-stopped symbols corresponding to the reels 101 to 103 selected in the symbol random determination process in S14 stop one by one in the middle stage of the display window 150 (on the PAY LINE). That is, nine symbols including the to-be-stopped symbols are displayed in the display window 150 (in the upper stage, the middle stage, and the lower stage).

The main CPU 71 then executes a payout amount calculation process (S106). In this process, payout is calculated based on a symbol combination displayed on the payline with reference to the symbol combination table (see FIG. 47) stored in the RAM 73 and the value (1BET, 2BET, or 3BET) of the bet counter. For example, when the value of the bet counter is “3” and the symbol combination displayed on the payline is three “2BAR”, “80” credits are determined as the payout with reference to the symbol combination table. It should be noted that the in bet amount in the free game is the bet amount placed in the normal game having triggered that free game.

Subsequently, the main CPU executes multiplying factor multiplication process for the currently active type (S107). In this multiplying factor multiplication process for the currently active type, the game characteristic set area of the RAM 73 is referred to, and the payout calculated in the payout amount calculation process of S106 is multiplied by the multiplying factor for the payout of the free game, which corresponds to the current type of the game characteristic set. The resulting value is stored in the payout amount storage area of the RAM 73 as the payout to be awarded for the free game. For example, referring to the game characteristic set area of the RAM 73, if the current type is the game characteristic set type A (see FIG. 51), the payout calculated in the payout amount calculation process of S106 (i.e., 80) is multiplied by the multiplying factor of type A (quadruple) for the payout of the free game. The resulting value of credits (i.e., 80×4=320) is stored in the payout amount storage area of the RAM 73 as the payout to be awarded for the free game.

Then a payout process is executed (S108). The main CPU 71 adds the value stored in the payout amount storage area to the value of the credit counter in the RAM 73.

The main CPU 71 then subtracts “1” from the value of the free game play counter (S109).

Subsequently, the main CPU 71 determines whether the value of the free game play counter is “0” (S110). When determining that the value of the free game play counter is not “0” (S110: NO), the main CPU 71 proceeds to S102.

In the meanwhile, when the value on the free game play counter is “0” (S110: YES), the free game process is terminated.

### Another Embodiment 3: P15-0261

The descriptions below may use the same reference numerals as in the embodiment above, but the embodiment below will describe arrangements different from those in the embodiment above.

As a typical gaming machine, a slot machine is arranged such that, as a player presses a button on a control panel, reels on which symbols are provided are scrolled and then stopped, with the result that the symbols are rearranged. In such a slot machine, a benefit such as a payout is awarded to a player based on a combination of rearranged symbols.

In some cases, such a slot machine has a random determination table which specifies for each reel the probability of each symbol being rearranged (see the publication of Japanese Laid-Open Patent Application, Tokukai 2013-153875). For example, there is a slot machine with three reels, which uses, for a first reel, a first reel random determination table whereby an A symbol is rearranged at a probability of 1/10 and a B symbol is rearranged at a probability of 1/5; uses, for a second reel, a second reel random determination table whereby the A symbol is rearranged at a probability of 1/22 and the B symbol is rearranged at a probability of 1/4; and uses, for a third reel, a third reel random determination table whereby the A symbol is rearranged at a probability of 1/40 and the B symbol is rearranged at a probability of 1/3. Then, a random determination is executed to determine symbols to be rearranged for all three reels.

In such a slot machine, the process of randomly determining the symbols to be rearranged is executed for each reel, that is, the number of times the random determination process is executed is the number of reels. This could lead to a problem of a large number of processes.

In view of the problem, it is an object of the present invention to provide a gaming machine with a reduced number of processes.

An aspect of the present invention is a gaming machine, comprising:

a display device configured to display symbols by rearranging reels on which symbols are arrayed;
a storage device configured to store a symbol rearrangement table in which a plurality of symbols and a plurality of numbers are associated respectively for each reel; and
a controller configured to execute the processes of:
(1A) with the start of the game, randomly selecting one number out of the plurality of numbers as a random number;
(1B) for all of the reels, determining in a bundle a symbol of each reel associated with the random number selected in the process of (1A) in the symbol rearrangement table, as the symbol to be rearranged on the reel; and
(1C) rearranging the symbols determined in the process of (1B) to display them on the display device.

In the above structure, all the symbols to be rearranged on the display device are determined based on a single random number. This reduces the number of processes as compared to a case of extracting a random number to determine the symbol to be rearranged on the display device, for each reel. Further, a single number is associated with a symbol of each of the reels, which makes it easy to adjust the probability of the predetermined symbol (a combination involving the predetermined symbol) occurring.

Further, an aspect of the present invention is a gaming machine, comprising: a display device configured to display symbols by rearranging an N number of reels on which symbols are arrayed;

a storage device storing a symbol rearrangement table in which a plurality of symbols and a plurality of numbers are associated with each other for each of the reels, wherein the numbers include numbers each of which is common to an N number of symbols constituting a winning yielding a benefit, and numbers each of which is common to an N−1 number of symbols which is one symbol less than the N number of symbols structuring the winning;

a controller configured to execute the processes of:

(2A) with the start of the game, randomly selecting one number out of the plurality of numbers as a random number;
(2B) for all of the N number of reels, determining in a bundle a symbol of each reel associated with the random number selected in the process of (1A) in the symbol rearrangement table, as the symbol to be rearranged on the reel; and
(2C) rearranging the N number of the reels to display symbols determined in the process of (2B) on the display device.

In the above structure, the N number of symbols constituting the winning yielding a predetermined benefit, or an N−1 number of symbols which is one symbol less than the N number of symbols constituting the winning are rearranged on the display device, with a single random number. This realizes a group of symbols corresponding to a single number, which is one symbol less than the N number of symbols constituting the winning.

In the present invention, the above-described gaming machine is arranged such that the plurality of numbers include more numbers each corresponding to the N−1 number of symbols which is one symbol less than the N number of symbols constituting the predetermined winning, than the numbers each corresponding to the N number of symbols constituting the predetermined winning.

In the above structure, there are more chances of rearranging, on the display device, the N−1 number of symbols which is one symbol less than the N number of symbols constituting the predetermined winning. This increases the player's expectation for the winning, while reducing the processes.

A gaming machine with a reduced number of processes is provided.

(Outline of Present Invention)

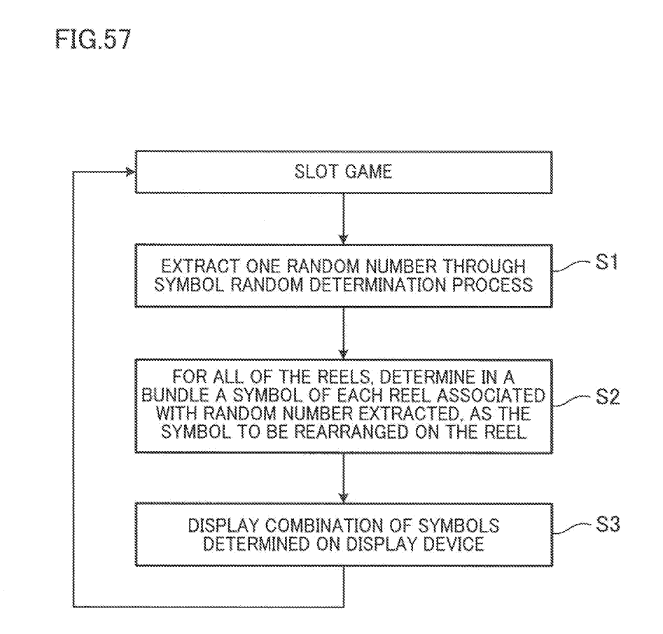

The following will describe an embodiment of the present invention with reference to the drawings. FIG. 57 shows the outline of a game flow of a slot machine according to the embodiment of the present invention. As shown in FIG. 57, the slot machine of the embodiment of the present invention executes a slot game as a game.

The slot games are of a line type (Left to Right). The slot games employ mechanical reels. The reels are formed of three reels. That is to say, the reels are formed of a first reel, a second reel, and a third reel. Furthermore, a single pay line is set.

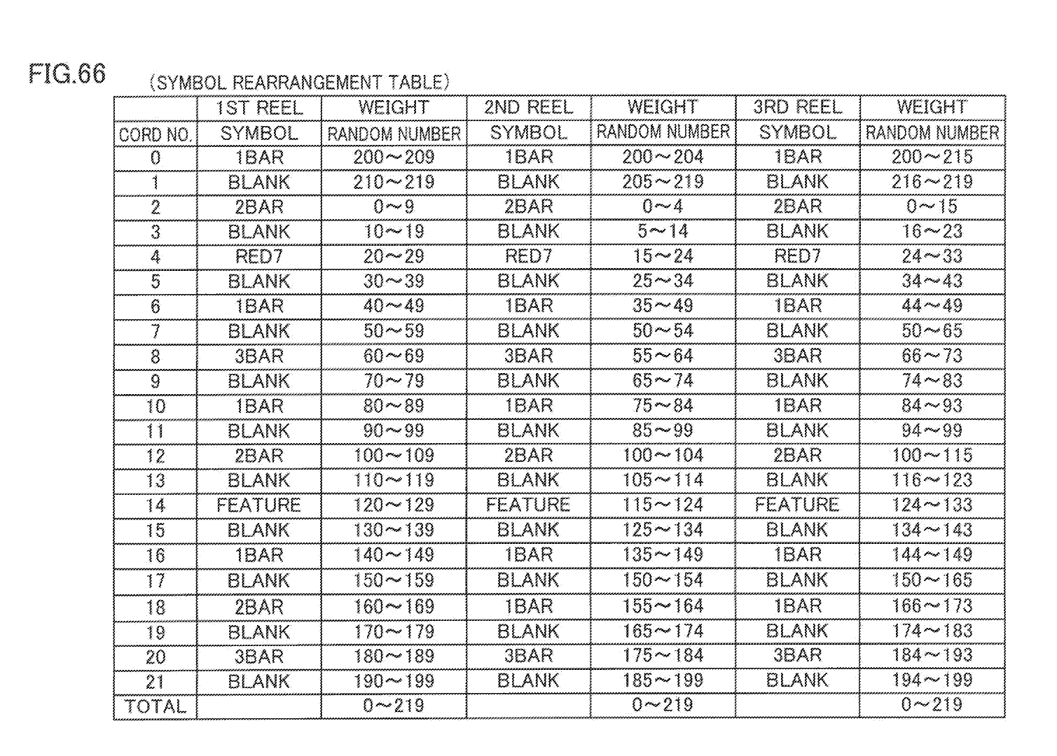

The slot game of the present invention uses a symbol rearrangement table (see FIG. 66) in which a plurality of symbols and a plurality of numbers (random numbers) are associated with each other for each reel.

With the start of the game, one number (random number) is selected out of the plurality of numbers (S1) through a process of random determination. Then, the number (random number) selected through the random determination and the symbol rearrangement table are referred to, to determine in a bundle three symbols, each corresponding to the random number, for a first reel, a second reel, and a third reel, as the three symbols to be rearranged on the first reel, the second reel, and the third reel, respectively (S2). Then, the three symbols determined as to be rearranged on the first reel, the second reel, and the third reel, respectively are rearranged and displayed on the display device (S3).

### Definition

While in the present embodiment the slot machine 1 is an example of the gaming machine, the slot machine 1 may be a device which independently executes a game.

The game in the present embodiment is run by the slot machines 1, in the present embodiment. The game is a slot game of rearranging symbols. The rearrangement of symbols in the slot game is carried out by a mechanical reel unit (equivalent to a display device). In the game, on condition that a gaming value is bet, symbols are rearranged in the display window by the mechanical reel unit, and a payout is awarded according to the rearranged symbols.

A free game employed in the present embodiment is a slot game of rearranging symbols without requiring betting of a gaming value. This free game is an example of the bonus game, and the bonus game may be any types of games as long as the game is more advantageous for the player than the normal game. For example, the free game includes a game in which a payout amount and a payout rate are higher than those in the normal game, a mini game different from the normal game, and a game in which a predetermined condition is more probable to be established as compared to the normal game.

The symbols collectively mean “RED7”, “3BAR”, “2BAR”, “1BAR”, “BLANK”, and “FEATURE”.

The gaming value is electrically valuable information such as electronic money and the like. It is to be noted that the gaming value in the present invention is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Function Flow)

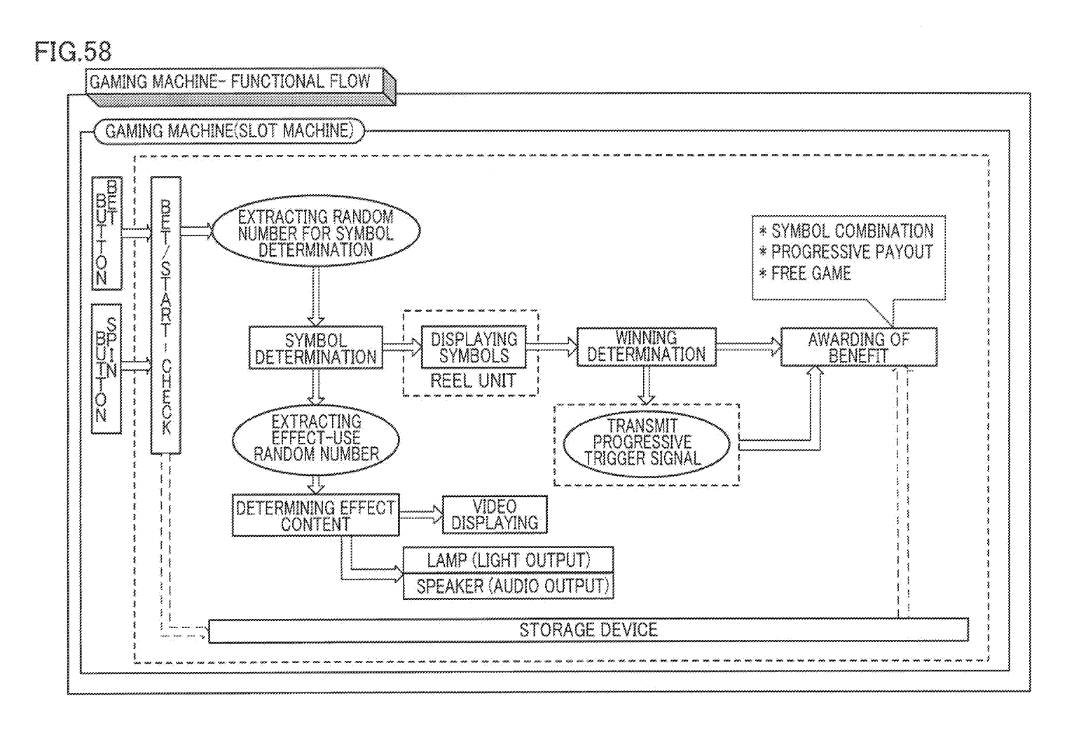

The following describes basic functions of the slot machine related to the embodiment of the present invention, with reference to FIG. 58. FIG. 58 shows the functional flow of the slot machine of the embodiment of the present invention.

<Bet/Start-Check>

First, the slot machine checks whether or not a BET button has been pressed by a player, and subsequently checks whether or not a spin button has been pressed by the player.

<Symbol Determination>

Next, when the player presses the spin button, the slot machine randomly selects a single number (random number) out of a plurality of numbers, through a process of random determination. Next, for all of the reels, a symbol of each reel associated with the number (random number) thus selected through the random determination, which symbols are in the symbol rearrangement table, as the symbol to be rearranged on the reel.

<Reel Control>

Thereafter, the slot machine starts the rotation of each reel and stops the rotation of each reel so that the determined symbols are displayed for the player (symbol display).

<Winning Determination>

Subsequently, as the rotation of each reel is stopped, the slot machine determines whether the combination of the symbols displayed for the player is a combination related to winning.

<Awarding Benefit>

When the combination of the symbols displayed for the player is a combination related to winning, the slot machine offers, to the player, benefit according to the type of the combination. For example, when a combination of symbols related to awarding of a credit is displayed, the slot machine awards credits to the player, the amount of which corresponds to the combination of the symbols.

When a combination of a predetermined symbol is established, transition to the free game occurs. In the free game, the slot game is run without requiring betting from the player. When the combination of the symbols displayed for the player is a combination related to winning as a result of the free game, a benefit according to the combination is awarded to the player.

In addition to the above, the slot machine may accumulatively add a part of a bet amount to progressive payout stored in the storage device, each time the unit game is executed. When progressive payout is employed, the slot machine awards the progressive payout accumulatively stored in the storage device to the player, when a progressive trigger condition is established. The progressive (jackpot) is a function of accumulating at least one of coins betted by a player at a slot machine (or slot machines) in the progressive payout and awarding the accumulated progressive payout to a slot machine in which a progressive trigger is established. When the progressive payout is accumulated by plural slot machines, an amount (accumulative amount) accumulated to the progressive payout is calculated and transmitted to an external controller each time the game is executed. The external controller adds the accumulative amount sent from each slot machine to the progressive payout.

The slot machine may have other benefits such as a mystery bonus and insurance. In the mystery bonus, a predetermined number of coins are paid out when a win is achieved in dedicated random determination. When a spin button is pressed, the slot machine samples a random number for the mystery bonus, and whether a mystery bonus trigger is established is randomly determined.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine samples an effect-use random number and determines the content of an effect based on randomly determined symbols or the like.

(Overall Structure of Game System)

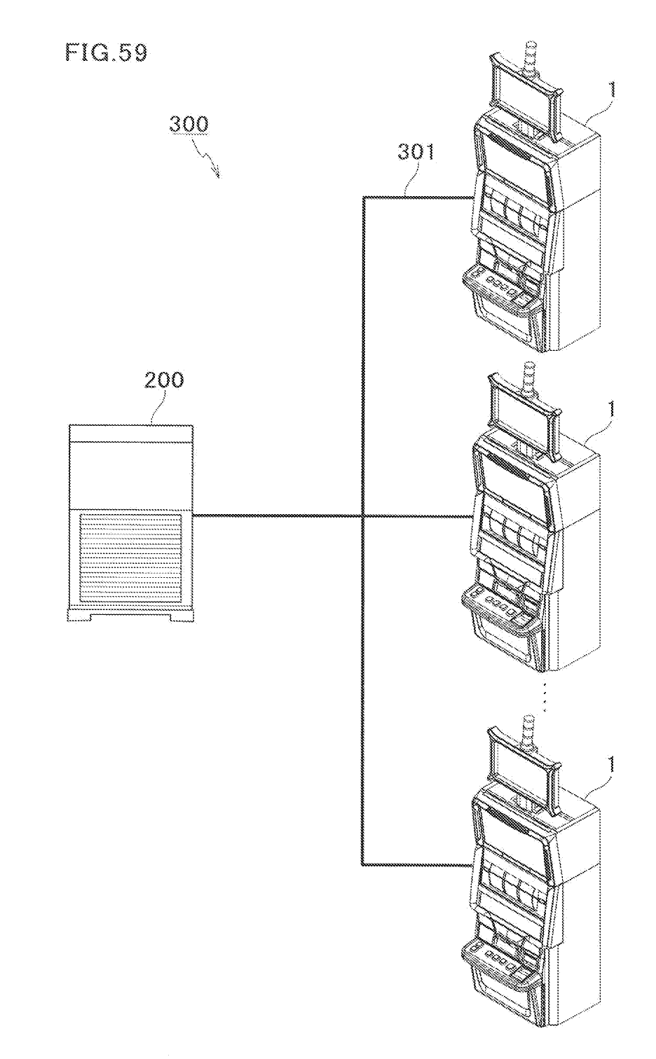

This concludes the description for the basic functions of the slot machine. Now, referring to FIG. 59, a game system including the slot machines will be described. FIG. 59 shows the game system including the slot machines of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

It is to be noted that the game system 300 may be constructed within a single gaming facility where various games can be performed, such as a casino, or may be constructed among a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

(Overall Structure of Slot Machine)

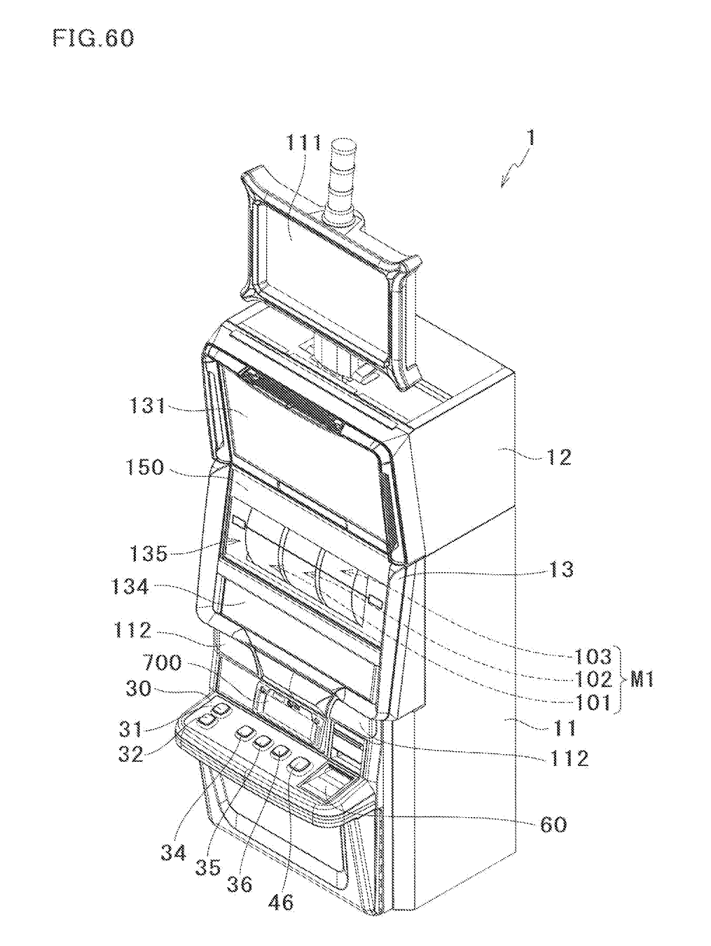

Now, referring to FIG. 60, the overall structure of the slot machine 1 will be described. FIG. 60 shows the overall structure of the slot machine of the embodiment of the present invention.

Electrically valuable information such as electronic money is used as a gaming value in the slot machine 1. It is to be noted that the gaming value is not limited to these, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

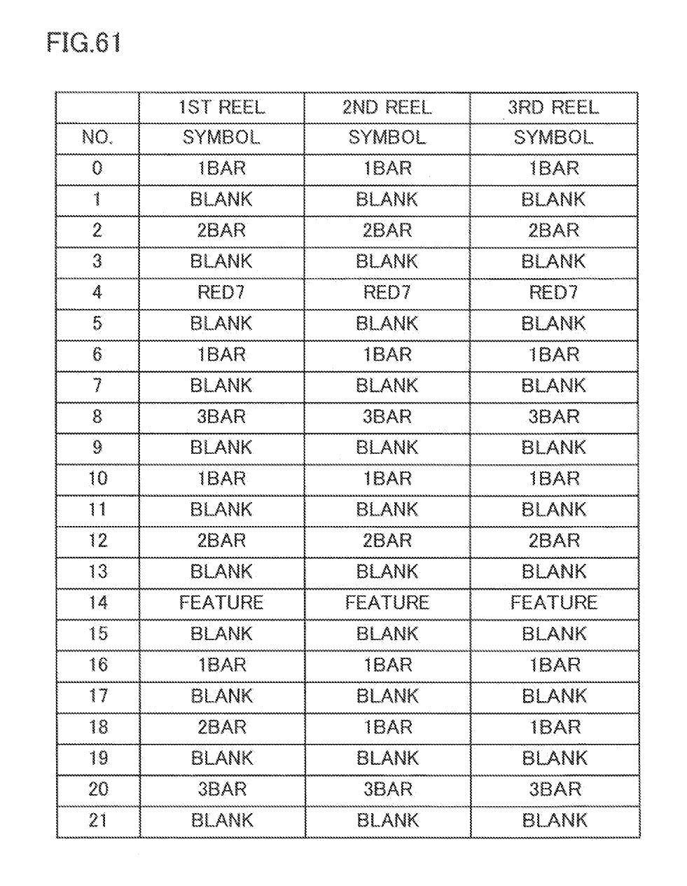

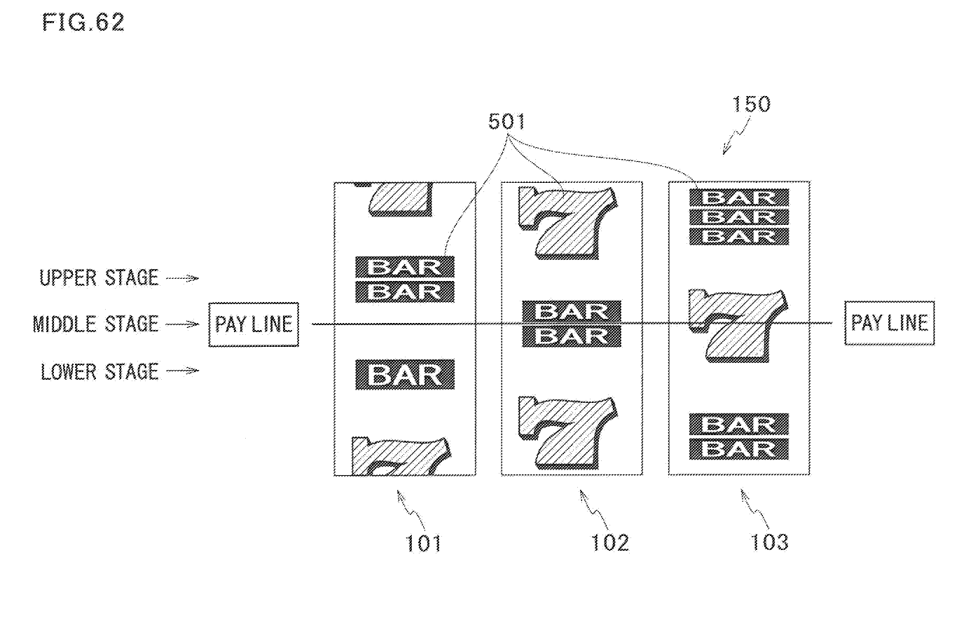

The main door 13 is provided with a reel unit M1 (corresponding to a symbol display device) constituted by three reels 101, 102, and 103. A reel cover 135 is provided in front of the reel device M1. On the front surface of the reel cover 135, a liquid crystal display device 134 by which a gaming status is reported to the player and a transparent panel are provided. This liquid crystal display device 134 is provided with a touch panel 137. The reel cover 135 has the display window 150 at its central portion. In the display window 150, one symbol 501 is provided in each of the upper stage, the middle stage, and the lower stage of each of the reels 101, 102, and 103 (see FIG. 62). To put it differently, 9 symbols 501 forming a three-by-three matrix are visibly displayed in the display window 150. On the outer circumferential surface of each of the reels 101, 102, and 103, 22 symbols are depicted (see FIG. 61). These 22 symbols 501 are lined up along the rotational direction of the reels 101, 102, and 103 to form a symbol array. Each of the symbol arrays is a combination of “RED7”, “3BAR”, “2BAR”, “1BAR”, “BLANK”, and “FEATURE”. To the main door 13 is provided a speaker 112.

As shown in FIG. 62, a payline for result determination of symbols 501 rearranged in the display window 150 is set in the slot machine 1. In the present embodiment, one payline is formed at the middle stage of the display window 150 as shown in FIG. 62. Alternatively, plural paylines may be provided and each payline may be activated upon selection by a player.

As shown in FIG. 62, the reel unit M1 rearranges the symbols 501 on the display window 150 by drivingly rotating the reels 101, 102, and 103 each having the symbols 501 on the outer circumferential surface. In the descriptions below, the reels may be referred to as a first reel 101, a second reel 102, and a third reel 103 from the left end in front elevation.

On the inner circumferential side of each of the reels 101, 102, and 103 arranged as above, a backlight unit (not illustrated) is provided. The backlight unit emits illumination light from the inner circumferential side of the reels 101, 102, and 103 to the outer circumferential surface of the reels and is arranged so that the illumination light passing through the outer circumferential surface of the reels is seen from the outside of the display window 150. The backlight unit is configured to be able to change the amount of illumination light in multiple stages. The degree of freedom in the effects using illumination light is therefore high. Furthermore, each backlight unit is able to emit light in multiple colors, and to illuminate the symbols individually with the illumination light.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

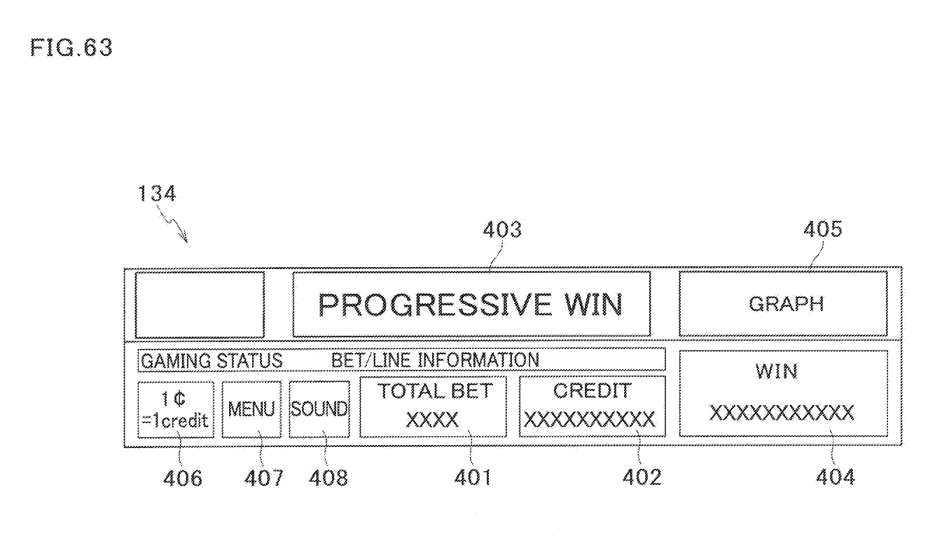

As shown in FIG. 63, on the liquid crystal display device 134 is displayed meters indicating the conditions of the game. For example, a total bet meter 401 displays “Total Bets”. The numerical value is re-calculated at every game play. The credit meter 402 indicates the total credit amount at the time. The default value is 0. The numerical value is increased or decreased according to the gaming value input, the bet, and the game result. A game message area 403 indicates a message explaining the current gaming status. The win meter 404 indicates the total credit amount of the payout having been won.

The liquid crystal display device 134 is provided with a graph touch area 405, a denomination indicator 406, a menu touch area 407, and a sound volume switching touch area 408. When touched by the player, the graph touch area 405 displays, in the form of graphs, the change of the obtained payout amount, the number of game play executed until the transition to the free game, and the total obtained credit amount at the time of the free game, on the upper image display panel 131. As the graph touch area 405 is touched, three types of graph images, i.e., line-graph, bar-graph, and block-graph are displayed in order. The denomination indicator 406 displays current denomination. When the menu touch area 407 is touched by the player, the upper image display panel 131 displays the first page of the HELP screen. The sound volume switching touch area 408 is used for switching the game sound volume in three stages. Each time the sound volume switching touch area 408 is touched by the player, the game sound volume is switched such that, for example, from low to middle to high to small to middle.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the reel unit M1 are provided a control panel 30 having various buttons, a PTS device 700, and a bill entry 60.

The bill entry 60 validates bills and receives genuine bills into the cabinet 11. The bill entry 60 is electrically connected to the PTS device 700, and when a legitimate bill is received, transmits to the PTS device 700 an input signal based on the value of the bill. The input signal represents information of credit data and the like related to the bill received.

The PTS device 700 is a unit in which an LCD (liquid crystal display), a human detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Control Panel 30)

On the control panel 30, a HELP button 31 and a CASHOUT button 32 are arranged in the left side area, a 1-BET button 34, a 2-BET button 35, and a 3-BET button 36 are arranged in the middle area, and a spin button 46 is arranged in the lower stage on the left side area.

The HELP button 31 is pressed when, for example, it is unclear how to play a game. As the HELP button 31 is pressed, various help information is displayed on the upper image display panel 131. The CASHOUT button 32 is an operation button used when checking out credits reserved in the slot machine 1 is discharged.

Each time the 1-BET button 34 is pressed, one of the credits currently owned by the player is betted. The 2-bet button 35 is used to start a game with two bets. The 3-bet button 36 is used to start a game with three bets. A gaming value corresponding to one bet can be optionally changed by setting the denomination.

The spin button 46 is used to start the rotation of the reels 101, 102, and 103.

(Symbol Array)

Now, with reference to FIG. 61, the arrays of the symbols 501 on the first reel 101, the second reel 102, and the third reel 103 of the slot machine 1 will be described.

A symbol table shown in FIG. 61 shows arrays of the symbols 501 displayed on the outer circumferential surfaces of the first reel 101, the second reel 102, and the third reel 103. To each of the first reel 101, the second reel 102, and the third reel 103 is assigned a symbol array including 22 symbols 501 respectively corresponding to code numbers 0 to 21.

As shown in FIG. 61, the types of the symbols include “RED7”, “3BAR”, “2BAR”, “1 BAR”, “BLANK”, and “FEATURE”.

[Structures of Circuits Provided to Slot Machine]

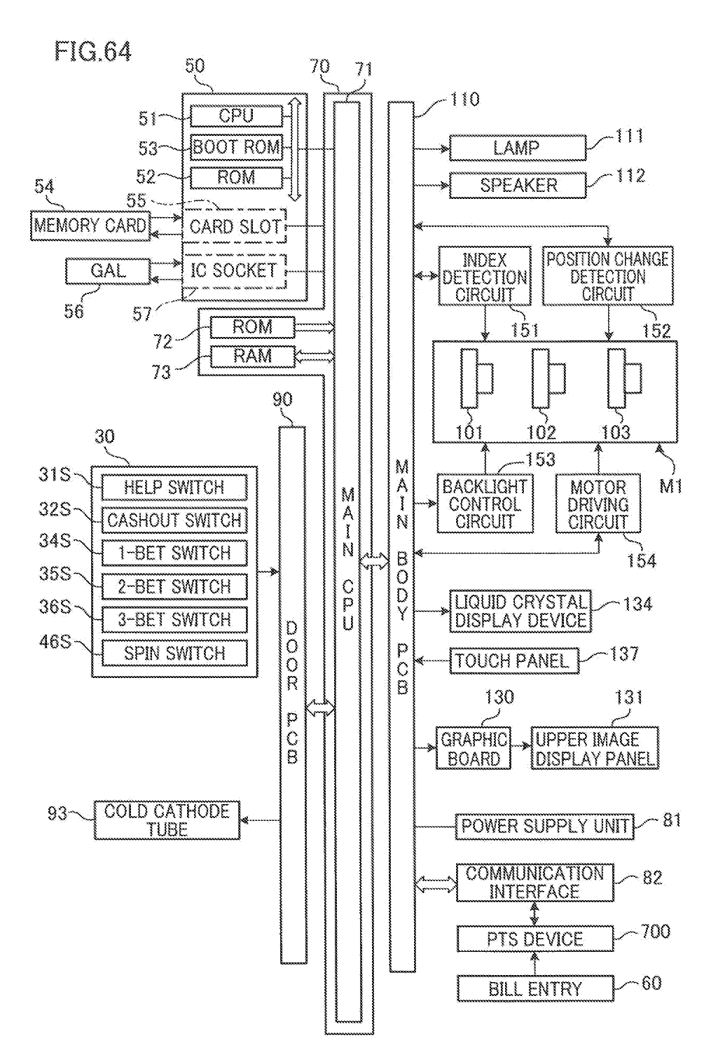

Now, referring to FIG. 64, the configuration of a circuit in the slot machine 1 will be described. FIG. 64 is a block diagram showing an internal structure of the slot machine of the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to a storage device.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the main CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations when these programs are executed. Examples of the areas include: an area that stores counter which manages the number of game play, a bet amount, the credit amount, a payout value of each progressive payout, and the like; and an area that stores symbols (code numbers) randomly determined.

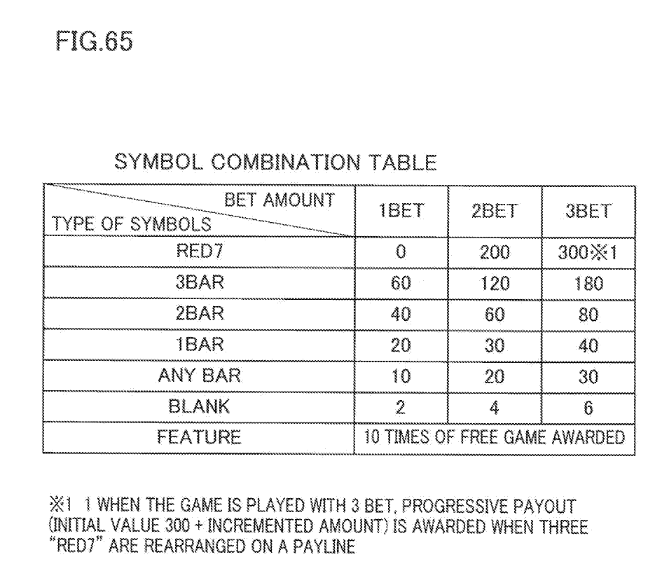

Further, the RAM 73 stores various tables such as the symbol combination table (see FIG. 65) and the symbol rearrangement table (see FIG. 66).

The communication interface 82 is for communicating with the PTS device 700 and the external controller 200. The PTS device 700, upon reception of an input signal from the bill entry 60, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a HELP switch 31S, a CASHOUT switch 32S, a 1-BET switch 34S, a 2-BET switch 35S, a 3-BET switch 36S, and a spin switch 46S, correspondingly to the above-described buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The body PCB 110 is connected with a lamp 111, a speaker 112, a graphic board 130, the liquid crystal display device 134, a touch panel 137, an index detection circuit 151, a position change detection circuit 152, a backlight control circuit 153, and a motor driving circuit 154. The index detection circuit 151, the position change detection circuit 152, a backlight control circuit 153, and a motor driving circuit 154 are connected with the reel unit M1.

The lamp 111 turns on based on a control signal outputted from the main CPU 71. The speaker 112 outputs BGM sound or the like in accordance with a control signal output from the main CPU 71.

The graphic board 130 controls displaying of images on the upper image display panel 131 based on a control signal output from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 134 displays an image based on a control signal output from the main CPU 71. The touch panel 137 detects a position on the liquid crystal display device 134 touched by a finger or the like of the player, and outputs a signal corresponding to the detected position to the main CPU 71.

The motor driving circuit 154 is connected to a stepper motor configured to rotate the reels 101, 102, and 103. Further, the motor driving circuit 154 includes an FPGA (Field Programmable Gate Array) and a driver. The FPGA is an electronic circuit such as a programmable LSI, and functions as a control circuit of the stepper motor. The driver functions as an amplifying circuit for pulses to be input to the stepping motor.

The index detection circuit 151 detects the positions of the rotating reels 101, 102, and 103 and is able to detect the step out of the reels 101, 102, and 103.

The position change detection circuit 152 is configured to detect a change in the stop position of the reels 101, 102, and 103 after the rotation of the reels 101, 102, and 103 is stopped. The position change detection circuit 152 detects a change in the stop positions of the reels 101, 102, and 103 when, for example, a stop position is changed to achieve a winning combination of the symbols 501 by an illicit way when no winning combination of the symbols 501 is achieved. The position change detection circuit 152 is configured to detect a change in the stop position of the reels 101, 102, and 103, for example, by detecting not-shown fins (not illustrated) which is arranged on the inner sides of the reels 101, 102, and 103 at predetermined intervals.

It should be noted that the method of exciting the stepping motor is not particularly limited, and 1-2 phase excitation system or a 2 phase excitation system are adoptable. Further, a DC motor may be adopted in place of the stepping motor. In cases of adopting a DC motor, the main body PCB 110 is connected to an error counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the deviation counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumferential surfaces of the reels 101, 102, and 103 are able to individually illuminate nine symbols 501 having stopped on the display window 150 by means of the backlight control circuit 153.

(Symbol Combination Table)

Now, symbol combination tables will be described with reference to FIG. 65. FIG. 65 shows a symbol combination table in the slot machine of the embodiment of the present invention.

The symbol combination table defines payouts for bet amounts and symbol combinations achieving winning (WIN). In the slot machine 1, the rotational scroll of the reels 101, 102, and 103 is stopped, and when a combination of three symbols displayed (rearranged) on a payline corresponds to a symbol combination defined in the symbol combination table, winning is achieved. In accordance with the type of winning, a benefit will be given to the player in the form of awarding payout and the like. It is noted that winning is not established (i.e. the game is lost) when the combination of symbols displayed (rearranged) on the payline does not match with any of the combinations of symbols specified by the symbol combination table.

Basically, winning is achieved when three symbols of the following types are displayed on a payline: “RED7”, “3BAR”, “2BAR”, “1BAR”, “BLANK”, and “FEATURE”. Winning as “ANYBAR” is also achieved when a symbol combination including “3BAR”, “2BAR”, and “1BAR” is established. When the game is played with one bet, no payout is awarded for “RED7”. When the game is played with three bets, progressive payout (initial value 300+incremented amount) is awarded when three “RED7” are rearranged on a payline. When three “FEATURE” are rearranged on the payline, right to execute the free game ten times is awarded.

(Symbol Rearrangement Table)

Now, the symbol rearrangement table will be described with reference to FIG. 66. In the present embodiment, the symbol rearrangement table is a table which is referred to in a later-described symbol random determination process in the main control process and a later-described symbol random determination process in the free game process.

The symbol rearrangement table defines, in relation to the first reel 101 to the third reel 103, 22 symbols of code numbers “0” to “21” each of which is associated with a predetermined range of random numbers from 0 to 219 (WEIGHT). When a code number is selected out of the numbers 0 to 219 through the random determination process, three symbols 501 corresponding to the random number are determined as the to-be-stopped symbols which are to be rearranged on in the middle stage (payline) of the display window 150, on the first reel 101 to the third reel 103.

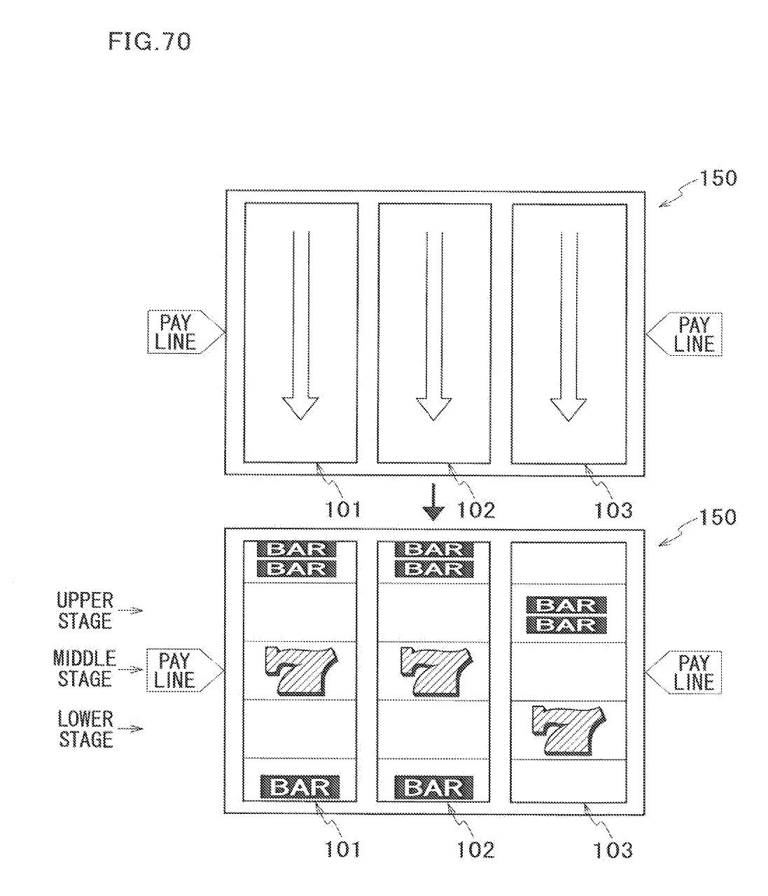

In cases of the symbol rearrangement table shown in FIG. 66, for example, if any of the random numbers “20” to “23” is extracted through a random determination, “RED7” corresponding to a code number “4” is determined as the to-be-stopped symbol which is to be rearranged in the middle stage (pay line) of the display window 150, for the first reel 101; “RED7” corresponding to a code number “4” is determined as the to-be-stopped symbol which is to be rearranged in the middle stage (pay line) of the display window 150, for the second reel 102; and “BLANK” corresponding to a code number “3” is determined as the to-be-stopped symbol which is to be rearranged in the middle stage (pay line) of the display window 150, for the third reel 103. That is, “RED7”, “RED7”, and “BLANK” are determined as the to-be-stopped symbols which will be stopped in the middle stage (payline) of the display window 150. It should be noted that, if any of the random numbers “20” to “23” is extracted through a random determination, “RED7” will be rearranged in the lower stage of the display window 150, for the third reel 103. That is, the display window 150 will have three “RED7” symbols arranged (see FIG. 70).

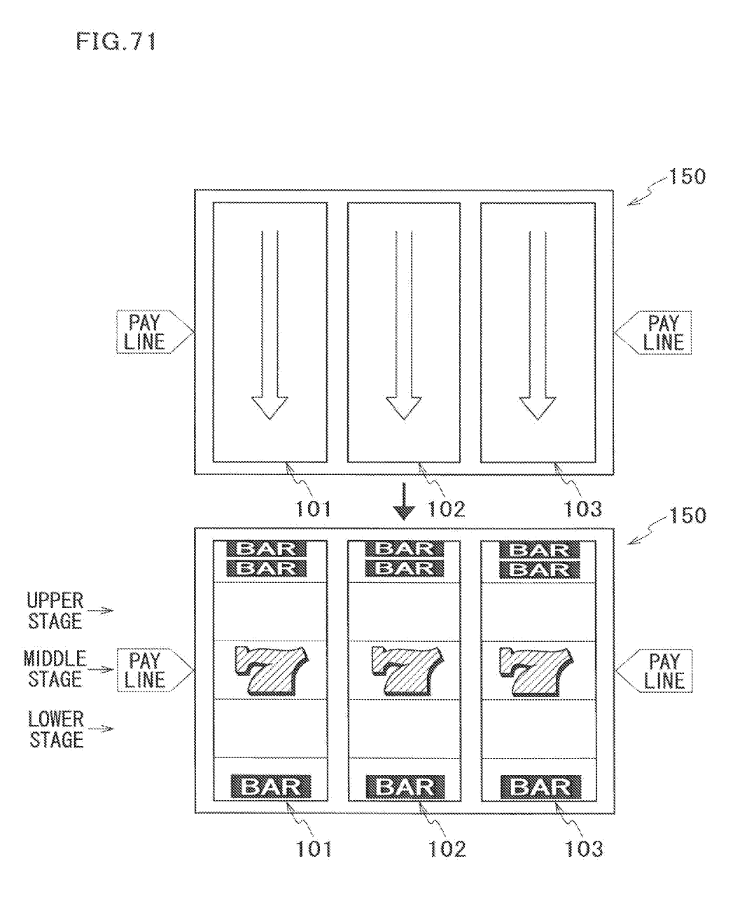

Further, if a random number of “24” is extracted through a random determination, “RED7” corresponding to a code number “4” is determined as the to-be-stopped symbol which is to be rearranged in the middle stage (pay line) of the display window 150, for the first reel 101; “RED7” corresponding to a code number “4” is determined as the to-be-stopped symbol which is to be rearranged in the middle stage (pay line) of the display window 150, for the second reel 102; and “RED7” corresponding to a code number “4” is determined as the to-be-stopped symbol which is to be rearranged in the middle stage (pay line) of the display window 150, for the third reel 103. That is, “RED7”, “RED7”, and “RED7” are determined as the to-be-stopped symbols which will be stopped in the middle stage (payline) of the display window 150 (see FIG. 71).

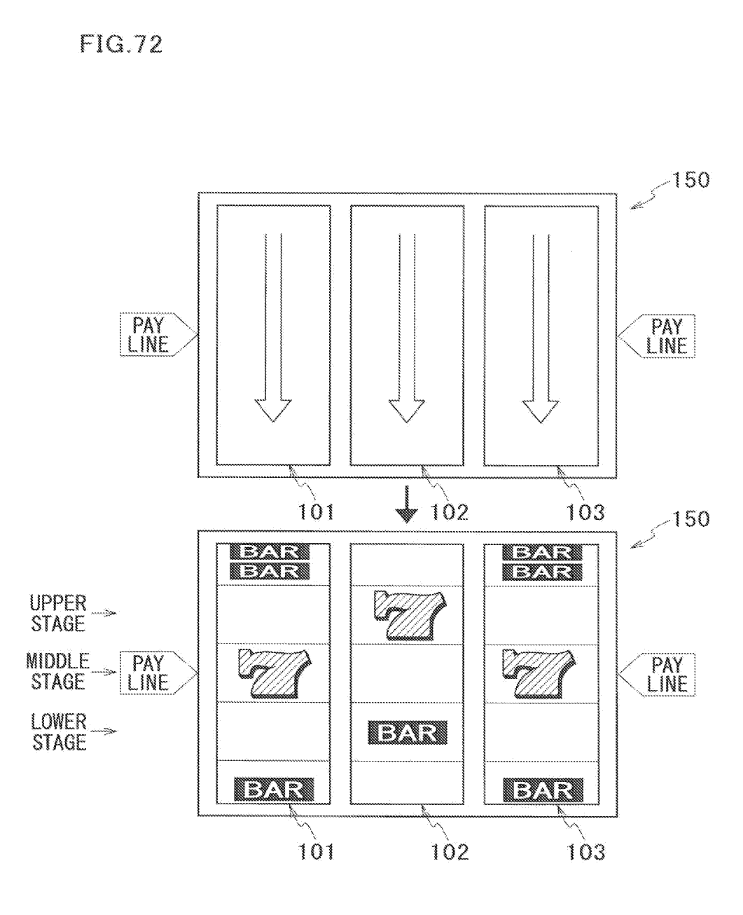

Further, if any of the random numbers “25” to “29” is extracted through a random determination, “RED7” corresponding to a code number “4” is determined as the to-be-stopped symbol which is to be rearranged in the middle stage (pay line) of the display window 150, for the first reel 101; “BLANK” corresponding to a code number “5” is determined as the to-be-stopped symbol which is to be rearranged in the middle stage (pay line) of the display window 150, for the second reel 102; and “RED7” corresponding to a code number “4” is determined as the to-be-stopped symbol which is to be rearranged in the middle stage (pay line) of the display window 150, for the third reel 103. That is, “RED7”, “BLANK”, and “RED7” are determined as the to-be-stopped symbols which will be stopped in the middle stage (payline) of the display window 150. It should be noted that, if any of the random numbers “25” to “29” is extracted through a random determination, “RED7” will be rearranged in the upper stage of the display window 150, for the second reel 102. That is, the display window 150 will have three “RED7” rearranged (see FIG. 72).

As described hereinabove, the symbol rearrangement table used is such that the random numbers “0” to “219” therein include the random number of “24” which correspond to a set of three “RED7” symbols leading to a winning, and a range of the random numbers “20” to “23” and a range of random numbers “25” to “29” each of which ranges corresponding to two “RED7” symbols, i.e., a state which lacks one symbol to achieve the three “RED7” symbols leading to the winning. This allows rearrangement of three “RED7” symbols leading to a winning or two “RED7” symbols which lacks one “RED7” symbol for achieving the winning-leading three “RED7” symbols in the middle stage (payline) of the display window 150, through a single random number random determination process. Therefore, a state in which a set of symbols corresponding to a single random number lacks one symbol to achieve the three “RED7” leading to a “RED7” winning is intentionally created.

Further, the random numbers “0” to “219” of the symbol rearrangement table include a larger number of random numbers (i.e., a total of nine numbers from “20” to “23” and “25” to “29”) corresponding to a set of symbols including two “RED7” symbols and lacking one symbol to achieve the three “RED7” symbols leading to the “RED7” winning, as compared to the number of random numbers (i.e., a single random number of “24”) corresponding to a set of three “RED7” symbols leading to the “RED7” winning. This raises the chances of the “RED7” symbol constituting the “RED7” winning being rearranged in the display window 150, which causes a higher expectation for the “RED7” winning, while reducing the number of processes.

Further, suppose any of the random numbers “20” to “29” is extracted, using the symbol rearrangement table shown in FIG. 66. Suppose further that, as the result of this process, a “RED7” symbol corresponding to “4” is determined as the to-be-stopped symbol to be rearranged in the middle stage (payline) of the display window 150, in relation to the first reel 101. In this case, the “RED7” symbol will also be rearranged on the display window 150, in relation to the second reel 102 and the third reel 103. This raises the chances of the “RED7” symbol constituting the “RED7” winning being rearranged in the display window 150, which causes a higher expectation for the “RED7” winning.

(Contents of Program)

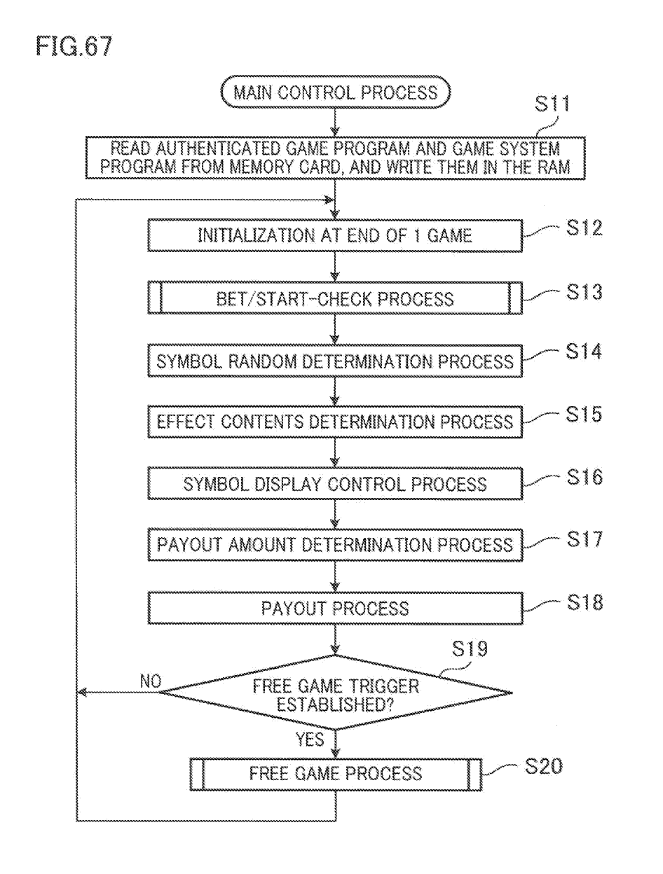

Now, the program to be executed by the slot machine 1 is described with reference to FIG. 67 to FIG. 69.

(Main Control Process)

Referring to FIG. 67, a main control process will be described. In the main control process, a slot game is executed.

First, when the slot machine 1 is powered on, the main CPU 71 reads an authenticated game program and a game system program from a memory card 54 via a gaming board 50, and then write them in the RAM 73 (S11).

Subsequently, the main CPU 71 executes an initializing process at the end of each play of the game, in order to start the slot game (S12). This process clears data in a working area of the RAM 73, which becomes unnecessary at the end of each play of the slot games, e.g., the bet amount, symbols randomly determined, and the like.

The main CPU 71 then executes a later-described bet/start-check process (S13). In this process, an input check or the like is executed for switches such as the 1-BET switch 34S, the 2-BET switch 35S, the 3-BET switch 36S, and the spin switch 46S.

Subsequently, the main CPU 71 executes the symbol random determination process (S14). This symbol random determination process randomly extracts one random number out of the random numbers ranging from “0” to “219”. Then, referring to the random number extracted and the symbol rearrangement table stored in the RAM 73, three symbols 501 corresponding to the extracted random number are determined as the to-be-stopped symbols which will be rearranged in the middle stage (payline) on the display window 150 for the first reel 101 to the third reel 103.

For example, when any of the random numbers “20” to “23” is extracted, referring to the symbol rearrangement table of FIG. 66, “RED7” corresponding to a code number “4” is determined as the to-be-stopped symbol which is to be rearranged in the middle stage (pay line) of the display window 150, for the first reel 101; “RED7” corresponding to a code number “4” is determined as the to-be-stopped symbol which is to be rearranged in the middle stage (pay line) of the display window 150, for the second reel 102; and “BLANK” corresponding to a code number “3” is determined as the to-be-stopped symbol which is to be rearranged in the middle stage (pay line) of the display window 150, for the third reel 103. That is, “RED7”, “RED7”, and “BLANK” are determined as the to-be-stopped symbols which will be stopped in the middle stage (payline) of the display window 150.

Further, if a random number of “24” is extracted through a random determination, “RED7” corresponding to a code number “4” is determined as the to-be-stopped symbol which is to be rearranged in the middle stage (pay line) of the display window 150, for the first reel 101; “RED7” corresponding to a code number “4” is determined as the to-be-stopped symbol which is to be rearranged in the middle stage (pay line) of the display window 150, for the second reel 102; and “RED7” corresponding to a code number “4” is determined as the to-be-stopped symbol which is to be rearranged in the middle stage (pay line) of the display window 150, for the third reel 103. That is, “RED7”, “RED7”, and “RED7” are determined as the to-be-stopped symbols which will be stopped in the middle stage (payline) of the display window 150.

Further, if any of the random numbers “25” to “29” is extracted through a random determination, “RED7” corresponding to a code number “4” is determined as the to-be-stopped symbol which is to be rearranged in the middle stage (pay line) of the display window 150, for the first reel 101; “BLANK” corresponding to a code number “5” is determined as the to-be-stopped symbol which is to be rearranged in the middle stage (pay line) of the display window 150, for the second reel 102; and “RED7” corresponding to a code number “4” is determined as the to-be-stopped symbol which is to be rearranged in the middle stage (pay line) of the display window 150, for the third reel 103. That is, “RED7”, “BLANK”, and “RED7” are determined as the to-be-stopped symbols which will be stopped in the middle stage (payline) of the display window 150.

In the above structure, all the three symbols to be rearranged on the display window 150 are determined based on a single random number random determination. This reduces the number of processes as compared to a case of extracting a random number to determine the symbol to be rearranged on the display window 150, for each reel (i.e. as compared to a case of performing three times of random number random determination for each of the first reel 101 to the third reel 103). Further, the symbols corresponding to a common random number are related with each other in each of the reels 101 to 103. Therefore, the chances of the “RED7” symbol occurring can be set high or low.

The main CPU 71 stores the determined to-be-stopped symbols on the reels 101 to 103 in a symbol storing area in the RAM 73.

Subsequently, the main CPU 71 executes an effect contents determination process (S15). The main CPU 71 extracts an effect-use random number and randomly selects one of a plurality of predetermined effect contents.

Then, the main CPU 71 executes a symbol display control process (S16). In this symbol display control process, as shown in FIG. 70, the scroll of the reels 101 to 103 starts, and after a predetermined time elapses, the to-be-stopped symbols corresponding to the reels 101 to 103 selected in the symbol random determination process in S14 stop one by one in the middle stage of the display window 150 (on the PAY LINE). That is, nine symbols including the to-be-stopped symbols are displayed in the display window 150 (in the upper stage, the middle stage, and the lower stage).

For example, when the to-be-stopped symbol on the first reel 101 is “RED7”, the to-be-stopped symbol on the second reel 102 is “RED7”, and the to-be-stopped symbol on the third reel 103 is “BLANK”, as the result of having any of random numbers “20” to “23” extracted through the random number random determination in the symbol random determination process of S14, “RED7”, “RED7”, and “BLANK” are rearranged in the middle stage of the display window 150 (on the payline) as shown in FIG. 70.

For example, when the to-be-stopped symbol on the first reel 101 is “RED7”, the to-be-stopped symbol on the second reel 102 is “RED7”, and the to-be-stopped symbol on the third reel 103 is “RED7”, as the result of having any of random number “24” extracted through the random number random determination in the symbol random determination process of S14, “RED7”, “RED7”, and “RED7” are rearranged in the middle stage of the display window 150 (on the payline) as shown in FIG. 71.

For example, when the to-be-stopped symbol on the first reel 101 is “RED7”, the to-be-stopped symbol on the second reel 102 is “BLANK”, and the to-be-stopped symbol on the third reel 103 is “RED7”, as the result of having any of random numbers “25” to “29” extracted through the random number random determination in the symbol random determination process of S14, “RED7”, “BLANK”, and “RED7” are rearranged in the middle stage of the display window 150 (on the payline) as shown in FIG. 72.

Further, suppose any of the random numbers “20” to “29” is extracted, using the symbol rearrangement tables of the present embodiment. Suppose further that, as the result of this process, a “RED7” symbol corresponding to “4” is determined as the to-be-stopped symbol to be rearranged in the middle stage (payline) of the display window 150, in relation to the first reel 101. In this case, the “RED7” symbol will also be rearranged on the display window 150, in relation to the second reel 102 and the third reel 103 (FIG. 70 to FIG. 72). This raises the chances of the “RED7” symbol constituting the “RED7” winning being rearranged in the display window 150, which causes a higher expectation for the “RED7” winning.

The main CPU 71 then executes a payout amount determination process (S17). In this process, payout is determined based on a symbol combination displayed on the payline with reference to the symbol combination table (see FIG. 65) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “3BAR”, “180” credits are determined as the payout with reference to the symbol combination table and stored in the payout amount storage area in the RAM 73.

When the value of the bet counter is “3” (MAXBET) and the symbol combination displayed on the payline is three “RED7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 300 in each game play. When the progressive payout is won, the value of the progressive payout counter is stored in the payout amount storage area of the RAM 73. Furthermore, when the progressive payout is won, a message which notifies that the progressive payout has been awarded is displayed. To be more specific, messages “CONGRATULATIONS!”, “PROGRESSIVE WIN”, and “XXXXXXXX CREDITS” are displayed on the upper image display panel 131.

Then a payout process is executed (S18). The main CPU 71 adds the value stored in the payout amount storage area to the value of the credit counter in the RAM 73.

Then the main CPU 71 determines whether a free game trigger is established for nine symbols rearranged in the display window 150 (S19). To be more specific, whether three “FEATURE” are rearranged on the payline is determined (see FIG. 65). When the free game trigger is established (S19: YES), a later-described free game process is executed (S20).

In the meanwhile, when the free game trigger is not established (S19: NO) or after the free game process (S20), the routine proceeds to S12.

(Bet/Start-Check Process)

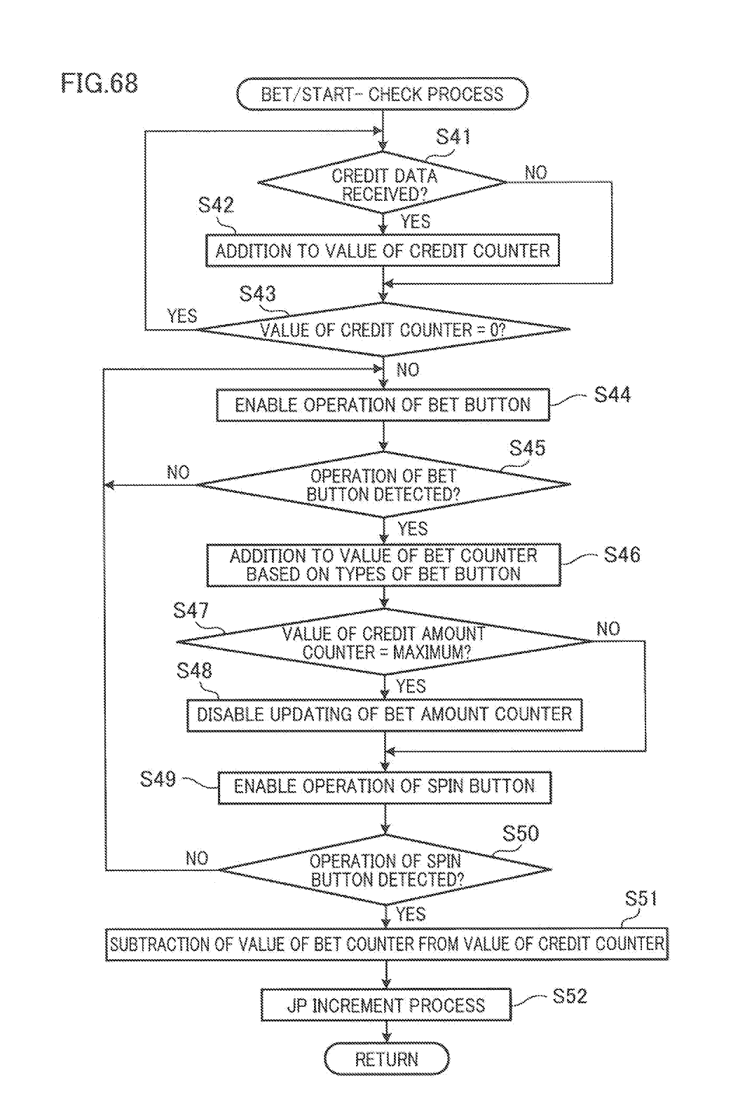

Now the bet/start-check process will be described with reference to FIG. 68.

To begin with, the main CPU 71 determines whether credit data has been received from the PTS device 700 (S41). The credit data is sent from the PTS device 700 to the main CPU 71, for example, when the IC card is inserted into the card insertion slot and when the bill entry 60 receives a genuine bill.

When the credit data is received (S41: YES), the main CPU 71 adds the amount indicated by the received credit data to the value of the credit counter (S42).

After the step S42 or when determining in S41 that no credit data is received (S41: NO), the main CPU 71 determines whether or not the value stored in the credit counter is 0 (S43). When determining that the value of the credit counter is 0 (S43: YES), the main CPU 71 goes back to S41.

When the main CPU 71 determines that the value of the credit counter is not 0 (S43: NO), the main CPU 71 permits operation acceptance of the BET buttons (1-BET button 34, 2-BET button 35, and 3-BET button 36) (S44).

Then the main CPU 71 determines whether an operation of the BET button is detected (S45). When an operation of the bet button by a player is detected by the bet switch (1-BET switch 34S, 2-BET switch 35S, or 3-BET switch 36S), the main CPU 71 performs addition to the value of the bet counter in the RAM 73, based on the type of the BET button (S46).

Subsequently, the main CPU 71 determines whether the value of the bet counter is at the maximum (S47). When determining that the value of the bet counter is at the maximum (S47: YES), the main CPU 71 prohibits the update of the value of the bet counter (S48). After S48, when determining in S47 that the value of the bet counter is not at the maximum (S47: NO), the main CPU 71 enables operation of the spin button 46 (S49).

After S49, the main CPU 71 determines whether an operation of the spin button 46 is detected (S50). When the main CPU 71 determines that an operation of the spin button 46 is not detected (S50: NO), the routine proceeds to S41.

In the meanwhile, when the main CPU 71 determines that operation of the spin button 46 is detected (S50: YES), the main CPU 71 subtracts the value of the bet counter calculated in S46 from the value of the credit counter (S51).

The main CPU 71 then executes a JP increment process (S52). In the JP increment process, as the resource of the progressive payout, the value of the progressive payout counter in the RAM 73 is incremented by a value calculated by multiplying the value of the bet counter calculated in S46 by an increment rate (0.01 but may be optionally set) set in the present embodiment. For example, when the value of the bet counter calculated in S46 is “3”, 3×0.01=0.03 credit is added to the value of the progressive payout counter. In the present embodiment, the initial value of the progressive payout counter is 300 credits. Therefore, in the progressive payout counter, a value calculated by multiplying the value of the bet counter by the increment rate (0.01) is accumulatively added to the initial value of 300 in each game play.

Then the bet/start-check process is terminated.

(Free Game Process)

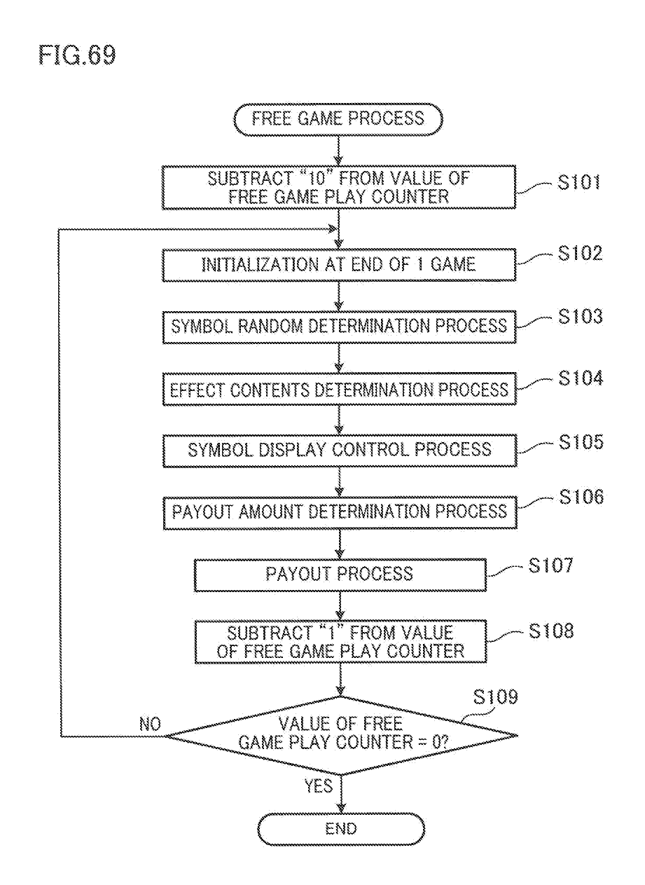

The following describes a free game process with reference to FIG. 69. FIG. 69 is a flowchart of a free game process of the slot machine related to the embodiment of the present invention.

To begin with, the main CPU 71 adds “10” to the free game play counter (stored in the RAM 73) and stores the resultant number (S101). This allows the player to play the slot game ten times without newly placing a bet.

Then the main CPU 71 executes an initializing process at the end of each round of the game in the same manner as in S12 (S102). This process clears data in a working area of the RAM 73, which becomes unnecessary at the end of each play of the free game, e.g., the bet amount, symbols randomly determined, and the like. This process clears data in a working area of the RAM 73, which becomes unnecessary at the end of each play of the free game, e.g., the bet amount, symbols randomly determined, and the like.

Subsequently, the main CPU 71 executes the symbol random determination process as in S14 (S103). This symbol random determination process randomly extracts one random number out of the random numbers ranging from “0” to “219”. Then, referring to the random number extracted and the symbol rearrangement table stored in the RAM 73, three symbols 501 corresponding to the extracted random number are determined as the to-be-stopped symbols which will be rearranged in the middle stage (payline) on the display window 150 for the first reel 101 to the third reel 103.

Subsequently, the main CPU 71 executes an effect contents determination process as in S15 (S104). The main CPU 71 extracts an effect-use random number and randomly selects one of a plurality of predetermined effect contents.

The main CPU 71 then executes the symbol display control process as in S16 (S105). In this symbol display control process, as shown in FIG. 70, the scroll of the reels 101 to 103 starts, and after a predetermined time elapses, the to-be-stopped symbols corresponding to the reels 101 to 103 selected in the symbol random determination process in S103 stop one by one in the middle stage of the display window 150 (on the PAY LINE). That is, nine symbols including the to-be-stopped symbols are displayed in the display window 150 (in the upper stage, the middle stage, and the lower stage).

The main CPU 71 then executes the payout amount determination process as in S17 (S106). In this process, payout is determined based on a symbol combination displayed on the payline with reference to the symbol combination table (see FIG. 65) stored in the RAM 73 and the value (1BET, 2BET, or 3BET) of the bet counter, and the payout is stored in the payout amount storage area provided in the RAM 73.

Subsequently, the main CPU 71 executes the payout process (S107). The main CPU 71 adds the value stored in the payout amount storage area to the value of the credit counter in the RAM 73.

The main CPU 71 then subtracts “1” from the value of the free game play counter (S108).

Subsequently, the main CPU 71 determines whether the value of the free game play counter is “0” (S109). When determining that the value of the free game play counter is not “0” (S109: NO), the main CPU 71 proceeds to S102.

In the meanwhile, when the value on the free game play counter is “0” (S109: YES), the free game process is terminated.

<<Others>>

In addition to the above embodiment, the slot game run in the above main control process (normal mode) may transit to the slot game of a high-probability mode in which the predetermined symbol (“RED7”) is more likely to occur than the normal mode. For example, when a combination of to-be-stopped symbols determined in the symbol random determination process is the “RED7” winning, or when three “RED7” symbols are displayed on the display window 150, the game mode may be switched from the slot game of the normal mode to the high-probability mode.

In the high-probability mode, a slot game is run as in the case of the main control process. The symbol rearrangement table for the high-probability mode, which is referred to in the symbol random determination process of the high-probability mode only uses five symbols corresponding to code numbers “2” to “6” (“2BAR”, “BLANK”, “RED7”, “BLANK”, “1BAR”) of the symbol rearrangement table of FIG. 66 which is used in the normal mode, in relation to the first reel 101 to the third reel 103. Of these five symbols, one code number is randomly selected. To be more specific, each of the five symbols is associated with a predetermined range of random numbers (WEIGHT) out of random numbers 0 to 49. That is, “a range of random numbers “0” to “9” is associated with “2BAR”, a range of random numbers “10” to “19” is associated with the “BLANK” symbol, a range of random numbers “20” to “29” is associated with the “RED7” symbol, a range of random numbers “30” to “39” is associated with the “BLANK” symbol, and a range of random numbers “40” to “49” is associated with the “1BAR” symbol. Then by randomly selecting a code number out of the numbers 0 to 49 through, three symbols 501 corresponding to the random number are determined as the to-be-stopped symbols which are to be rearranged on in the middle stage (payline) of the display window 150, on the first reel 101 to the third reel 103.

As described, in the high-probability mode, the probability of having the “RED7” being rearranged is made high, by limiting the range of code numbers (ran of random numbers) in the symbol rearrangement table used in the normal mode (i.e., limiting code numbers to five starting from 22; narrowing the range of random numbers from the range of “0” to “219” to a range of “49”). In other words, the probability “RED7” winning is made higher in the high-probability mode, while using the same symbol rearrangement table as the one used in the normal mode.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

### REFERENCE SIGNS LIST

1 Slot Machine
30 Control Panel
M1. Reel Unit
71 Main CPU
72 ROM
73 RAM
101 to 103 Reels
131 Upper Image Display Panel
150 Display Window

What is claimed is:

1. A gaming machine, comprising: a display device configured to display a game result by rearranging reels on which symbols are arrayed;
a storage device including symbol random determination tables each of which specifies a probability of rearrangement for each of the symbols arrayed on the reels, in such a manner that the probability of rearrangement for a predetermined symbol is different amongst the symbol random determination tables; and
a controller configured to execute the processes of:
(1A) at start of game play, randomly determining symbols for an normal mode, which will be rearranged on the display device based on a predetermined symbol random determination table;
(1B) displaying the symbols determined in the process (1A) on the display device by rearranging the reels;
(1C) in cases where the symbols rearranged on the display device form a specific symbol combination, randomly determining symbols for a high-probability mode, which will be rearranged on the display device based on a symbol random determination table which specifies a higher probability of rearrangement for the predetermined symbol than that specified in the symbol random determination table used in a previous game;
(1D) displaying the symbols determined in the process (1C) on the display device by rearranging the reels; and
(1E) repeating the processes of (1C) and (1D).

2. The gaming machine according to claim 1, wherein,
the controller is configured to further execute the processes of:
returning to the process of (1A) in cases where the symbols rearranged on the display device do not form a specific symbol combination in the processes of (1B) and (1D).

3. The gaming machine according to claim 1, wherein,
in the process of (1E), the symbol random determination table used, when the processes of (1C) and (1D) are repeated a predetermined number of times, is a symbol random determination table which defines a highest probability of having the predetermined symbol combination rearranged.

4. A gaming machine, comprising: a display device configured to display a game result by rearranging reels on which symbols are arrayed in a matrix of display areas;
a storage device including symbol random determination tables each of which specifies a probability of rearrangement for each of the symbols arrayed on the reels in the display areas, in such a manner that the probability of rearrangement for a predetermined symbol in any of the display areas is different amongst the symbol random determination tables; and
a controller configured to execute the processes of:
(2A) at start of game play, randomly determining symbols for an normal mode, which will be rearranged in the display areas on the display device based on a predetermined symbol random determination table;
(2B) displaying, in the display areas, the symbols determined in the process (2A) on the display device by rearranging the reels;
(2C) in cases where the symbols rearranged in the display areas on the display device form a specific symbol combination, randomly determining symbols, which will be rearranged in the display areas on the display device based on a symbol random determination table which specifies a higher probability of rearrangement for the predetermined symbol in a specific display area; and
(2D) displaying, in the display areas, the symbols determined in the process (2C) on the display device by rearranging the reels.

5. A gaming machine, comprising: a display device configured to display a game result according to an arrangement pattern of symbols formed by rearranging reels on which symbols are arrayed in a matrix of display areas;
a storage device including symbol random determination tables each of which specifies a probability of rearrangement for each of the symbols arrayed on the reels in the display areas, in such a manner that an arrangement pattern of symbols rearranged in the display areas is different amongst the symbol random determination tables; and
a controller configured to execute the processes of:
(3A) at start of game play, randomly determining an arrangement pattern of symbols for an normal mode, which will be rearranged in the display areas on the display device based on a predetermined symbol random determination table;
(3B) displaying, in the display areas, the arrangement pattern determined in the process (3A) on the display device by rearranging the reels;
(3C) in cases where the arrangement pattern of symbols rearranged in the display areas on the display device forms a specific symbol combination, randomly determining symbols, which will be rearranged in the display areas on the display device based on a symbol random determination table which specifies a higher probability for the arrangement pattern in which the specific symbol is rearranged in a predetermined display area; and
(3D) displaying, in the display areas, the arrangement pattern determined in the process (3C) on the display device by rearranging the reels.
